(19) United States
(12) Patent Application Publication
(10) Pub. No.: US 2006/0136139 A1
(43) Pub. Date: Jun. 22, 2006

(54) Rapid computational identification of targets

(76) Inventors: Adrian H. Elcock, Iowa City, IA (US); William M. Rockey, Coralville, IA (US)

Correspondence Address: NEEDLE & ROSENBERG, P.C., SUITE 1000, 999 PEACHTREE STREET, ATLANTA, GA, 30309-3915, US

(21) Appl. No.: 11/248,956

(22) Filed: Oct. 12, 2005

Related U.S. Application Data
(60) Provisional application No. 60/618,211, filed on Oct. 12, 2004.
(60) Provisional application No. 60/676,500, filed on Apr. 29, 2005.

(51) Int. Cl. G06F 19/00

(52) U.S. Cl. 702/19; 702/22

(57) ABSTRACT

Disclosed are compositions and methods for rapid computational identification of targets.

### CROSS REFERENCE TO RELATED PATENT APPLICATIONS

This application claims priority to U.S. Provisional Application No. 60/618,211 filed Oct. 12, 2004 and U.S. Provisional Application No. 60/676,500 filed Apr. 29, 2005, both of which are herein incorporated by reference in their entireties.

### I. BACKGROUND

The vast majority of drugs show a high correlation of structure and specificity to produce pharmacological effects. Experimental evidence indicates that drugs interact with receptor sites localized in macromolecules which have protein-like properties and specific three dimensional shapes. Often three points of attachment or interaction of a drug to a receptor site are preferred. In most cases a rather specific chemical structure is required for the receptor site and a complementary drug structure. Slight changes in the molecular structure of the drug can drastically change specificity.

It is desirable to be able to identify new targets for existing drugs. Current experimental approaches to this problem have included ‘protein chips’, on which protein targets are arrayed and assayed (3), and proteomics techniques capable of detecting proteins that bind to drug analogues covalently attached to a column (4). What is needed in the art is a computational method for identifying the protein receptors likely to bind a drug, which can provide accurate predictions of the drug's ability to bind to each homologue of the receptor.

### II. SUMMARY

Disclosed are methods related to the identification of targets for a given molecule. Also disclosed are methods of inhibiting a receptor with a molecule and identifying molecules that interact and modulate receptors. Also disclosed are methods of making a pharmaceutical composition.

### III. BRIEF DESCRIPTION OF THE DRAWINGS

The accompanying drawings, which are incorporated in and constitute a part of this specification, illustrate several embodiments and together with the description illustrate the disclosed compositions and methods.

FIG. 1 shows the dependence of the classification efficiency on the atomic van der Waals radius used in the computations. Results are shown for the seven drugs studied.

FIG. 2 shows the distribution of binding energies obtained from a computational screen of imatinib with 493 human protein kinases. The shaded area indicates the 22 kinases predicted to bind the drug on the basis of their computed binding energies.

FIG. 3 shows a subset of the sidechain rotamers sampled around the drug imatinib. Millions of rotamer combinations of the residues within 5.0 Å of the drug (shown in green) are sampled with Monte Carlo methods in order to compute each drug-receptor binding energy.

FIG. 4 shows phylogenetic trees showing the relationships between ‘sequences’ constructed from the drug-binding residues of each of the ˜20 tested kinases. Results are shown for the five drugs for which the computations appeared successful. Those kinases correctly predicted by the computations to be targets of a given drug are boxed red; those kinases falsely predicted to be targets are boxed blue.

FIG. 5 is similar to FIG. 4, but shows results for the two drugs for which the computations appeared unsuccessful.

FIG. 6 shows the distribution of binding energies obtained from a computational screen of (left) Purvalanol B, and (right) SB 203580 with 493 human protein kinases.

FIG. 7 shows the correlation between computed binding energies and experimental IC50 values for (left) Purvalanol B, and (right) hymenialdisine. TP denotes true positive, FP false positive, TN true negative, and FN false negative.

FIG. 8 shows an illustrative example of the dependence of computed results on the energy function.

FIG. 9 shows the distribution of classification efficiencies of the testing sets for (A) SB 203580, (B) purvalanol B, and (C) imatinib. The computed testing set classification efficiencies computed from the model are shown as dark bars; those obtained from randomized trials are shown by the white bars.

FIG. 10 shows a flow diagram illustrating exemplary steps in a disclosed method.

FIG. 11 shows a flow diagram illustrating exemplary steps in a disclosed method.

FIG. 12 shows a flow diagram illustrating exemplary steps in a disclosed method.

FIG. 13 shows a flow diagram illustrating exemplary steps in a disclosed method.

FIG. 14 shows a distribution of classification efficiencies of the testing sets obtained from SCR calculations.

FIG. 15 shows a distribution of testing set classification efficiencies obtained from AutoDock calculations with the fixed inhibitor assumption.

FIG. 16 shows a superimposed views of SB203580 in a model of the p38 a binding site before and after GROMACS energy minimization.

FIG. 17 shows a comparison of the inhibitor-kinase contacts made by SB203580 and the crystal structures 1PME (mutant Erk2) and 1A9U (p38ALPHA).

FIG. 18 shows a superimposed view of SB203580 in the binding sites of the crystal structures 1PME and 1A9U.

FIG. 19 shows an ordered list of the computed binding energies obtained with SCR for five inhibitors for which the calculations were successful.

FIG. 20 shows an ordered list of the computed binding energies obtained from docking calculations with AutoDock.

FIG. 21 shows an ordered list of inhibitors that have experimental data in the form of percentage activity.

FIG. 22 shows an ordered list of the computed binding energies obtained with SCR (Side Chain Rotamer program) for five inhibitors for which the calculations were successful.

FIG. 23 shows a summary of training/setting results for various screening protocols applied to five inhibitors and their respective kinase panels.

FIG. 24 shows an ordered list of the computed binding energies obtained using AutoDock and the fixed-inhibitor assumption.

FIG. 25 shows an ordered list of the computed binding energies obtained from docking calculations conducted with AutoDock.

FIG. 26 shows an ordered list of the computed binding energies obtained by applying AutoDock's energy function to complexes that were first energy-minimized by GROMACS.

FIG. 27 shows an ordered list of the computed binding energies obtained with SCR (Side Chain Rotamer program).

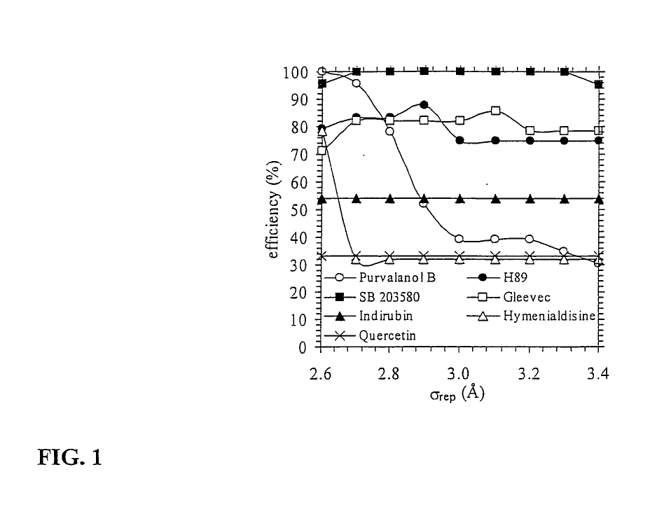

### IV. DETAILED DESCRIPTION

Before the present compounds, compositions, articles, devices, and/or methods are disclosed and described, it is to be understood that they are not limited to specific synthetic methods or specific recombinant biotechnology methods unless otherwise specified, or to particular reagents unless otherwise specified, as such may, of course, vary. It is also to be understood that the terminology used herein is for the purpose of describing particular embodiments only and is not intended to be limiting.

A. Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed then “less than or equal to 10” as well as “greater than or equal to 10” is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

The terms “higher,” “increases,” “elevates,” or “elevation” refer to increases above basal levels, or as compared to a control. The terms “low,” “lower,” “inhibits,” “reduces,” or “reduction” refer to decreases below basal levels, or as compared to a control. For example, basal levels are normal in vivo levels prior to, or in the absence of, addition of an agent that binds a receptor.

As used throughout, “potential target” refers to any molecule capable of interacting with another molecule. Examples of potential targets include, but are not limited to, kinases, nuclear receptors, phosphatases, phosphodiesterases, transferases (such as methyl transferases and glycotransferases), serine proteases, oxidoreductases, hydrolases, esterases, glycosyl hydrolases, ribonucleases, lyases, isomerases, G-coupled protein receptors, and ligases.

As used throughout, “molecule” refers to any compound which is capable of interacting with another molecule. An example of a “molecule” used in this context includes, but is not limited, to proteins and drugs. The terms “protein,” “drug” and “molecule” can be used interchangeably throughout, except where explicitly indicated otherwise.

As used throughout, “known target” refers to any molecule whose interaction with a molecule as described above, is known. Typically a ‘known target’ is a protein. Also typically the interaction between the molecule and the known target is sufficiently strong to produce a therapeutic response.

The term “associated with” means that there has been a link or correlation between the items discussed. For example, a particular receptor might be associated with a disease. This would mean that the receptor has been linked or is correlated with the presence of the disease. It can also mean that the receptor has been shown to be wholly or in part causative of the disease.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

B. Methods

In general the methods disclosed allow for the identification of targets for a molecule. It is understood that a target can be a receptor, protein, or any other type of molecule, but often is an amino acid based molecule, such as a protein. It is understood that the molecule can also be anything that can interact with the target, meaning it could be a small molecule, a nucleic acid, or even, an amino acid based molecule, such as a protein. Often the molecule, can be, for example, a drug. Often the molecule will have some type of activity, such as modulation of a protein activity, such as reduction or activation, such as an antagonist or agonist. In these instances, for example, the molecule could be referred to as an active molecule. While the examples disclosed herein, and the discussion regarding the compositions and methods, may use one or more different descriptions, such as molecule or drug or target or receptor in describing a particular embodiment, it is understood that the general nature of the methods applies to any two compositions regardless of what they are called, provided they function as in the methods as disclosed herein.

Many therapeutic drugs act by binding a protein receptor (target). Drugs that are designed to activate a receptor are known as agonists. Drugs that are designed to inactivate a receptor are known as antagonists, or blockers, and often act by inhibiting the protein-receptor interaction that would have otherwise occurred at that site. Often, a drug known to bind one receptor also binds other receptors in a subject. Generally speaking, the more closely related the receptors are, the higher the probability of the drug binding the related receptor. This degree of relatedness can be measured by comparing homology or sequence similarity between the known target and potential targets.

The binding of related receptors by a drug can either be an advantage or a disadvantage. When advantageous, a drug known to bind one receptor, and therefore treat one condition or disease, can also bind another receptor and therefore treat another condition or disease. This is of enormous advantage because often the drug has already been shown to be safe and has been approved for use by the FDA. The binding of related receptors becomes a disadvantage when the binding does not serve a useful purpose and instead causes unwanted or adverse side effects. Identifying these interactions can also be useful because the structure of the drug can then be modified to minimize the unwanted interactions. Also, since drugs react differently in different subjects, identifying the target of a drug in a subject with unwanted side effects can help establish a population that should not, or on the other hand, should have the drug administered to them.

Therefore, identifying other receptors that would interact with a drug is of enormous importance, both to identify potentially useful new treatments, as well as to identify potentially harmful or unwanted side effects. It is also useful in drug customization and design.

Several chemical forces can result in the binding of the drug to the receptor. Essentially any type of bond can be involved with the drug-receptor interaction. Covalent bonds are very tight and practically irreversible. Most drug-receptor interactions are non-covalent; covalent bond formation is rather rare. Since many drugs contain acid or amine functional groups which are ionized at physiological pH, ionic bonds can be formed by the attraction of opposite charges in the receptor site.

Polar-polar interactions as in hydrogen bonding are a further extension of the attraction of opposite charges. The drug-receptor reaction is essentially an exchange of the hydrogen bond between a drug molecule, surrounding water, and the receptor site.

Finally, hydrophobic bonds can be formed between non-polar hydrocarbon groups on the drug and those in the receptor site. These bonds are not very specific but can make a major contribution to the strength of the drug/receptor interaction.

Repulsive forces which decrease the stability of the drug-receptor interaction include repulsion of like charges and steric hindrance. Steric hindrance refers to certain 3-dimensional features where repulsion occurs between electron clouds, inflexible chemical bonds, or bulky alkyl groups.

1. Identifying Potential Targets

Described herein are methods of identifying potential targets of a molecule. The methods involve some basic similarities. Typically the method first utilizes a 3-dimensional structure of the known target with the molecule, such as a drug. This known structure can have been determined using any known means, such as crystallography or solution NMR spectroscopy. That structure can also be obtained through computer molecular modeling simulation programs, such as AutoDock. The methods typically involve determining the amount of binding, such as determining the binding energy, between a molecule, such as an active molecule, such as a drug, and a potential target for that molecule. An active molecule, is a molecule that has some activity against a target, such as inhibiting a target's activity or enhancing the target's activity. In addition, the potential target is typically a composition, such as a receptor, which has some genetic relationship, such as homology or identity, to a known target for the molecule.

Typically, the percentage identity of the sequences of the known target and potential target can be viewed in number of ways. For example, one can look at the identity between the entire known target and the potential target. One can also look at the identity between the potential target and the know target only in the domain where the drug or molecule binds, for example, a kinase domain. One can also look at the identity between the potential target molecule and the known target at the level of a sub-domain, such as only those residues in the potential target which are within 7 Å, 6 Å, 5 Å, 4 Å, 3 Å, or 2 Å of a residue which is in contact with the molecule in the known target. Generally, the more specific the sub-domain the higher the identity will be between the amino acids of the potential target and the known target. For example, in one embodiment there may be 30% (could be 35%, 40%, 45%, 50%, 55%, 60%, 65%, 70%, 75%, 80%, 85%, 90%, 95%) or greater identity between the known target and potential target as a whole, 50% (could be 55%, 60%, 65%, 70%, 75%, 80%, 85%, 90%, 95%) or greater identity between the drug binding domain of the known target and the potential target, and 70% (could be 75%, 80%, 85%, 90%, 95%) or greater identity between the residues of the potential target that correspond to the residues of the known target which are with in 5 Å of a residue which interacts with the drug. Another sub-domain is a sub-domain of residues which actually contact the drug. In this case the identity is typically greater than 50%, 55%, 60%, 65%, 70%, 75%, 80%, 85%, 90%, 95% or higher.

Typically, the potential target exists in a family of potential targets, i.e. a set of potential targets, all of which have some genetic relationship, such as homology or identity, to the known target for the molecule. A family consisting of any number of members may be screened. The maximum number of members in the family is only limited by the amount of computer power available to screen each member in a desired amount of time. The methods involve at least one template structure of the molecule and a target, often this would be with a known target. It is not required that this structure be existent, as it can be generated, in some cases during the disclosed methods, using standard structure determination techniques. It is preferred that a real structure exist at the time the methods are employed.

“High resolution” means a resolution of perhaps 3.0 Å or smaller in a crystal structure. Structures of any resolution, such as, 6.0 Å, 5.0 Å, 4.0 Å, 3.0 Å, 2.0 Å or smaller can be employed in the disclosed methods. For example, structures of resolutions of 1.75 Å (1OPJ), 2.0 Å (1PME), 2.05 Å (1CKP), 2.10 Å (1DM2), and 2.30 Å have all been successfully used.

It is also typical that the methods involve modeling the structure of the potential target, using information from the structure of the known target. This modeling can be performed in any way, and as described herein.

Often, the backbone of the region which has the genetic relationship and which is in the region of the known target that interacts with the molecule, is held constant in the potential target, relative to the backbone of the known target, when the potential target is modeled using the structure information of the known target. The structure of the entire backbone of the potential receptor is not required: all that is required is a structure for the backbone for residues that are within 7 Å, 6 Å, 5 Å, 4 Å, 3 Å, or 2 Å of an atom of the drug. For example the backbone residues in the immediate vicinity of the drug in the high resolution structure of the drug in complex with a known target. “Immediate vicinity” means any receptor residue that has an atom within 5 Å of an atom of the drug.

The sidechains of the amino acids can be added initially to the fixed backbone using a simple sidechain-adding program such as SCWRL3.0 (A. A. Canutescu, A. A. Shelenkov, and R. L. Dunbrack, Jr. A graph theory algorithm for protein side-chain prediction. Protein Science 12, 2001-2014 (2003). A program such as SCWRL can be used to build an initial model of the target receptor. Once this has been constructed, one can decide which sidechains should be allowed to move during the binding energy calculations.

One parameter that is decided at some point during the disclosed methods is the parameter called side chain movement. In the disclosed methods, certain side chains are held fixed and certain side chains are allowed to move, such as to be sampled. Thus, one way of determining if a side chain is a fixed side chain is by determining the distance the side chain is away from an atom of the drug. For example, sidechains that have all atoms more than 7 Å, 6 Å, 5 Å, 4 Å, or 3 Å from any atom of the drug can be side chains that are fixed. Another example, sidechains that have an atom within 7 Å, 6 Å, 5 Å, 4 Å, or 3 Å of any atom of the drug can be allowed to move, and sidechains that do not meet this criterion are held fixed.

In other embodiments, the methods involve holding fixed the side chains of the amino acids of the potential and known targets that are not directly involved in binding the drug. Sidechains that have at least one atom within 7 Å, 6 Å, 5 Å, 4 Å, or 3 Å of any atom of the drug in the initial model constructed as discussed herein, are side chains which can be considered involved in drug binding. Side chains which do not meet the criteria for an involved side chain are considered side chains not involved in drug binding.

Side chains determined to be involved in binding can be allowed to move and can sample different conformational positions from rotamer libraries, by for example, a Monte Carlo sampling procedure. Side chains determined to not to be involved in drug binding can be held fixed.

The conformation and position of the drug can be held fixed during the calculations; that is, it may be assumed that the drug binds in exactly the same orientation to the potential target as it does to a known target. For flexible drug molecules, rotamer libraries similar to those used for describing receptor sidechain flexibility can be used to model alternative drug conformations.

Then, a binding energy can be determined between the molecule and the potential target, and if the binding energy meets certain criteria, then the potential target can be designated as an actual target, i.e. one that is likely to be biologically modulated by a molecule-actual target interaction. The criterion can be that the computed binding energy of the molecule with the potential target is similar to, or more favorable than, the computed binding energy of the same molecule with a known target. For example, an actual target can be a target where the computed binding energy as discussed herein is, for example, at least 60%, 65%, 70%, 75%, 80%, 85%, 86%, 87%, 88%, 89%, 90%, 91%, 92%, 93%, 94%, 95%, 96%, 97%, 98%, 99%, 100%, 101%, 102%, 103%, 104%, 105%, 106%, 107%, 108%, 109%, 110%, 120%, 130%, 140%, 150%, 200%, 250%, 300%, 350%, 400%, 450%, 500%, 600%, 700%, 800%, 900%, 1000%, or greater than that of the known target binding energy. An actual target can also be a target which after ordering all potential targets in terms of the strength of their binding energies, are the targets which are in the top 20%, 19%, 18%, 17%, 16%, 15%, 14%, 13%, 12%, 11%, 10%, 9%, 8%, 7%, 6%, 5%, 4%, 3%, 2%, 1% of computed binding strengths, of for example, a set of potential targets where the set is at least 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 125, 150, 175, 200, 225, 250, 275, 300, 350, 400, 500, 700, or a 1000 potential targets.

It is also understood that once a potential target is identified, as disclosed herein, traditional testing and analysis can be performed, such as performing a biological assay using the molecule and the actual target to further define the ability of the molecule to modulate the actual target. The disclosed methods can include the step of assaying the biological activity of the molecule and potential target, as well as performing, for example, combinatorial chemistry studies using libraries based on the molecule, for example.

Energy calculations can be based on molecular or quantum mechanics. Molecular mechanics approximates the energy of a system by summing a series of empirical functions representing components of the total energy like bond stretching, van der Waals forces, or electrostatic interactions. Quantum mechanics methods use various degrees of approximation to solve the Schroedinger equation. These methods deal with electronic structure, allowing for the characterization of chemical reactions.

Potential targets of the molecule can be identified. This can occur by selecting potential targets with a given similarity to the known target. For example, sequence information can be used to compare relative homologies or similarities. Homologous, or similar, sequences can be identified, for example, using SWISS-PROT, PIR (1-3), GenBank and NRL-3D. SWISS-PROT. The sequences can be compared using, for example, http://www.bioinfo.biocenter.helsinki.fi:8080/dali/index.html, or http://us.expasy.org/spdbv/. Alternatively, targets in the same family as the known target can be selected. For example, if a known molecule-target interaction occurs wherein the target is a kinase, other members of the kinase family can be selected as well as potential targets.

To prepare each drug structure for calculation, atoms can be built in that were unresolved or absent from the crystal structures of the drug. This can be done, for example, using the PRODRG webserver http://www.davapc1.bioch.dundee.ac.uk./programs/prodrg, or standard molecular modeling programs such as InsightII or Quanta (both at www.accelrys.com), or any other molecular modeling system capable of preparing the drug structure.

An accurate structural model of the potential target can then be elucidated. Typically, the potential targets to be tested are modeled with the backbone in an identical conformation to that of the known target-molecule crystal structure or solution structure. Typically the next step is to construct structural models using, for example, sequence alignment. For certain families of receptors, sequence alignments can be taken directly from a sequence database dedicated to that particular family. For example, the Kinase Sequence Database (KSD) contains a curated alignment of the ATP-catalytic domains of over 7000 kinases. Other such databases exist for other families of receptors. Examples of these databases include but are not limited to the Cytochrome P450 Homepage (http://drnelson.utmem.edu/CytochromeP450.html) for cytochrome P450s; The EF-Hand Calcium Binding Proteins Data Library (http://structbio.vanderbilt.edu/cabp_database/cabp.html) for calcium-binding proteins; The Glucocorticoid Receptor Resource (http://nrr.georgetown.edu/GRR/GRR.HTML) for the glucocorticoid receptor; The Kinesin Homepage (http://www.proweb.org/kinesin/) for kinesins; Alignments of RecA Genes and Proteins (http://www.tigr.org/˜jeisen/RecA/RecA.Alignment.html) for the RecA protein; and the GPCRDB (http://www.gpcr.org/7tm/) for G protein coupled receptors. If a pre-existing sequence alignment is not available, or if the sequence of the potential or known targets are not present in the preexisting sequence alignment, a sequence alignment of the potential and known target sequences can be constructed using standard multiple sequence alignment programs such as CLUSTALW (J. D. Thompson et al. CLUSTAL-W—Improving the sensitivity of progressive multiple sequence alignment through sequence weighting, position specific gap penalties and weight matrix choice. Nucleic Acids Res. 22, 4673-4680 (1994)) or any similar method known to those skilled in the art such as MAFFT (K. Katoh et al. MAFFT: a novel method for rapid multiple sequence alignment based on fast Fourier transform. Nucleic Acids Res. 30, 3059-3066 (2002)) or DCA (J. Stoye. Multiple sequence alignment with the Divide-and-Conquer method. Gene 211, GC45-GC56 (1998)). With the sequence of the potential target aligned with that of the known, structurally-characterized target, a structure file for each potential target to be tested can be created.

To complete preparation of the structure of the potential target, sidechains can be added. This can be done, for example, by using the rotamer-modeling program SCWRL 3.0 (A. A. Canutescu, A. A. Shelenkov, and R. L. Dunbrack, Jr. A graph theory algorithm for protein side-chain prediction. Protein Science 12, 2001-2014 (2003), or any similar method known to those skilled in the art, for example, the method of Liang & Grishin (S. D. Liang, and N. V. Grishin. Side-chain modeling with an optimized scoring function. Protein Science 11, 322-331 (2004) or the SCAP method of Xiang & Honig (Z. X. Xiang, and B. Honig. Extending the accuracy limits of prediction for side-chain conformations. J. Mol. Biol. 311, 421-430 (2001)). Fast and accurate side-chain conformation prediction is important for homology modeling, ab initio protein structure prediction, and protein design applications. The SCWRL program is an example of one method, and is widely used because of its speed, accuracy, and ease of use, and any program performing functions such as those performed by SCWRL can be used. Some of the functions performed by SCWRL are, for example, SCWRL uses results from graph theory to solve the combinatorial problem encountered in the side-chain prediction problem. In this method, side chains are represented as vertices in an undirected graph. Any two residues that have rotamers with nonzero interaction energies are considered to have an edge in the graph. The resulting graph can be partitioned into connected subgraphs with no edges between them. These subgraphs can in turn be broken into biconnected components, which are graphs that cannot be disconnected by removal of a single vertex. The combinatorial problem is reduced to finding the minimum energy of these small biconnected components and combining the results to identify the global minimum energy conformation. This algorithm is able to complete predictions on a set of 180 proteins with 34342 side chains in <7 min of computer time. The total chi(1) and chi(1+2) dihedral angle accuracies are 82.6% and 73.7% using a simple energy function based on the backbone-dependent rotamer library and a linear repulsive steric energy. The new algorithm allows for use of SCWRL in sequence design and ab initio structure prediction, as well addition of complex energy function and conformational flexibility.

Hydrogens can also be added using methods such as the hydrogen bond optimization module (HBOND) of the modeling program WHATIF or corresponding modules in any standard molecular modeling program known to those skilled in the art such as InsightII (Accelrys) or Sybyl (Tripos, Inc.). When WHATIF determines if a hydrogen bond can be formed between the hydrogen of the donor atom and the lone pair of the acceptor atom, it uses four parameters. These are: 1) Distance between the donor and acceptor atom. 2) Distance between the (calculated) hydrogen position, and the acceptor atom. 3) Angle from donor atom over the hydrogen to the acceptor atom. And 4) Angle from the hydrogen over the acceptor to a ‘virtual’ atom. If the acceptor is only covalently bound to one atom, this atom is the so-called virtual atom. If the acceptor is covalently bound to two atoms, the virtual atom is on the bisector of those two.

Hydrogen bonds can be placed according to the following algorithm: If the geometry fixes the hydrogen position, this position is used, whereby the donor hydrogen distance is set to 1.0 Angstrom. If the hydrogen has a degree of rotational freedom, then the cone on which the hydrogen can potentially be found is calculated. This cone has a top angle of one hundred twenty degrees. The hydrogen is now placed on the two points that this cone has in common with the plane through the donor, a point on the rotation axis of the cone and the acceptor. WHAT IF only uses hydrogens that can be involved in hydrogen bonds. The cysteine side chain is not considered for hydrogen bond calculations.

Any constellation that creates a donor/hydrogen/acceptor triplet that falls within the four values described above can be accepted as a hydrogen bond. This program, as well as the accompanying manual, can be found at http://www.cmbi.kun.nl/whatif/ (WHATIF: A molecular modeling and drug design program.G. Vriend, J. Mol. Graph. (1990) 8, 52-56.)

The binding affinity of the potential target and molecule can then be calculated. There are numerous means for carrying this out. For example, the sampling of sidechain positions and the computation of the binding thermodynamics can be accomplished using an empirical function that models the energy of the potential target-molecule as a sum of electrostatic and van der Waals interactions between all pairs of atoms within the model. Any other computationally fast method for scoring the binding affinity of the drug with the potential target molecule can be used (H. Gohlke, & G. Klebe. Approaches to the description and prediction of the binding affinity of small-molecule ligands to macromolecular receptors. Angew. Chem. Int. Ed. 41, 2644-4676 (2002)). Examples of such scoring methods include, but are not limited to, those implemented in programs such as AutoDock (G. M. Morris et al. Automated docking using a Lamarckian genetic algorithm and an empirical binding free energy function. J. Comput. Chem. 19, 1639-1662 (1998)), Gold (G. Jones et al. Molecular recognition of receptor sites using a genetic algorithm with a description of desolvation. J. Mol. Biol. 245, 43-53 (1995)), Chem-Score (M. D. Eldridge et al. J. Comput.-Aided Mol. Des. 11, 425-445 (1997)) and Drug-Score (H. Gohlke et al. Knowledge-based scoring function to predict protein-ligand interactions. J. Mol. Biol. 295, 337-356 (2000)).

Flexibility can be incorporated into the sidechains of residues of the potential target that are close to the molecule through the use of rotamer libraries that are sampled by Monte Carlo (MC) methods or can be incorporated by sampling sidechain conformations with molecular dynamics (MD) simulations. In the case of using MC methods to sample sidechain rotamers, a typical simulation step can comprise (a) selecting one of the residues close to the drug at random, (b) selecting a new rotamer (conformation) for the sidechain of the selected residue at random, (c) evaluating the energy of the drug-receptor complex with the new conformation of the receptor using one of the methods listed above, and (d) applying a Metropolis test, known to those skilled in the art, to determine whether or not to accept the newly generated sidechain conformation based on the difference in energy between the newly generated conformation and the conformation generated in the previous simulation step. An entire simulation can comprise millions of such simulation steps, with the calculated energy being some average of the individual energies computed at each step of the simulation. The computed binding energy of the drug with the potential target can then be the difference between the average energy of the drug-target complex and the average energy of the target alone.

Rotamer libraries are known to those of skill in the art and can be obtained from a variety of sources, including the internet. Rotamers are low energy side-chain conformations. The use of a library of rotamers allows for the modeling of a structure to try the most likely side-chain conformations, saving time and producing a structure that is more likely to be correct. The use of a library of rotamers can be restricted to those residues that are within a given region of the potential target, for example, at the drug binding site, or within a specified distance of the drug. The latter distance can be set at any desired length, for example, the potential target can be 2, 3, 4, 5, 6, 7, 8, or 9 Å from any atom of the molecule.

Electrostatic interactions between every pair of atoms can be calculated, for example, using a Coulombic model with the formula:

E_{elec}=332.08q₁q₂/εΓ. where q₁ and q₂ are partial atomic charges, r is the distance between them, and E is the dielectric constant.

Partial atomic charges can be taken from existing parameter sets that have been developed to describe charge distributions in proteins. Example parameter sets include, but are not limited to, PARSE (D. A. Sitkoff et al. Accurate calculation of hydration free-energies using macroscopic solvent models. J. Phys. Chem. 98, 1978-1988 (1994)), CHARMM (MacKerell et al. All-atom empirical potential for molecular modeling and dynamics studies of proteins. J. Phys. Chem. B 102, 3586-3616, 1998) and AMBER (W. D. Cornell et al. A 2^{nd} generation force-field for the simulation of proteins, nucleic-acids, and organic-molecules. J. Am. Chem. Soc. 117. 5179-5195 (1995)). Partial charges for atoms of the drug molecule can be assigned either by analogy with those of similar functional groups found in proteins, or by empirical assignment methods such as that implemented in the PRODRG server (D. M. F. van Aalten et al. PRODRG, a program for generating molecular topologies and unique molecular descriptors from coordinates of small molecules. J. Comput.-Aided Mol. Design 10, 255-262 (1996)), or by the use of standard quantum mechanical calculation methods (for example, C. I. Bayly et al. A well-behaved electrostatic potential based method using charge restraints for deriving atomic charges—the RESP model. J. Phys. Chem. 97, 10269-10280, (1993)).

The electrostatic interaction can also be calculated by more elaborate methodologies that incorporate electrostatic desolvation effects. These can include explicit solvent and implicit solvent models: in the former, water molecules are directly included in the calculations, whereas in the latter, the effects of water are described by a dielectric continuum approach. Specific examples of implicit solvent methods for calculating electrostatic interactions include but are not limited to: Poisson-Boltzmann based methods and Generalized Born methods (M. Feig & C. L. Brooks. Recent advances in the development and application of implicit solvent models in biomolecule simulations. Curr. Opin. Struct. Biol. 14, 217-224 (2004)).

van der Waals and hydrophobic interactions between pairs of atoms (where both atoms are either sulfur or carbon) can be calculated using a simple Lennard-Jones formalism with the following equation:

E_{vdw}=ε{σₐₜₜ¹²/r¹²−σₐₜₜ⁶/r⁶}. where C is an energy, r is the distance between the two atoms and σₐₜₜ is the distance at which the energy of interaction is zero.

van der Waals interactions between pairs of atoms (where one or both atoms are neither sulfur nor carbon) can be calculated using a simple repulsive energy term:

E_{vdw}=ε{σᵣₑₚ¹²/r¹²}. where ε is an energy, r is the distance between the two atoms and σᵣₑₚ determines the distance at which the repulsive interaction is equal to ε.

Hydrophobic interactions between atoms can also be calculated using a variety of other methods known to those skilled in the art. For example, the energetic contribution can be calculated as being proportional to the amount of solvent accessible surface area of the ligand and receptor that is buried when the complex is formed. Such contributions can be expressed in terms of interactions between pairs of atoms, such as in the method proposed by Street & Mayo (A. G. Street & S. L. Mayo. Pairwise calculation of protein solvent-accessible surface areas. Folding & Design 3, 253-258 (1998)). Any other implementation of a formalism for describing hydrophobic or van der Waals or other energetic contributions can be included in the calculations.

Binding energies can be calculated for each potential target-molecule interaction. For example, Monte Carlo sampling of the flexible sidechains in the receptor can be conducted in the presence and absence of the molecule, and the average energy in each simulation calculated. A binding energy for the ligand (molecule) with the receptor can then be calculated as the difference between the two calculated average energies.

The computed binding energy of a potential target with the drug can be compared with the computed binding energy of a known target with the drug to determine if the potential target is likely to be a real target. These results can then be confirmed using experimental data, wherein the actual interaction between the molecule and potential target can be measured. Examples of methods that can be used to determine an actual interaction between the molecule and the potential target include but are not limited to: equilibrium dialysis measurements (wherein binding of a radioactive form of drug to the target is detected), enzyme inhibition assays (wherein the enzymatic activity of a receptor enzyme can be monitored in the presence and absence of the drug), and chemical shift perturbation measurements (wherein binding of the drug to the receptor is monitored by observing changes in NMR chemical shifts of atoms in the receptor).

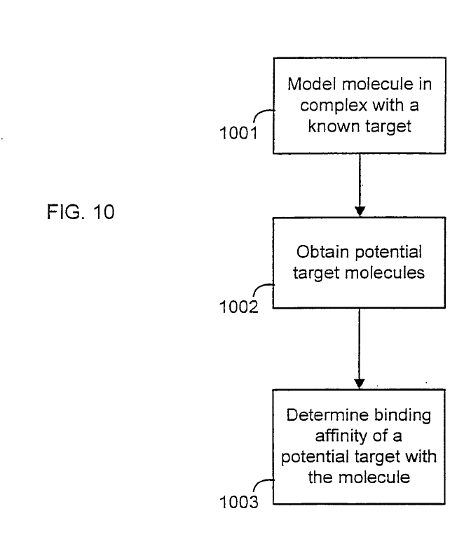

Described herein, and illustrated in FIG. 10, is a method of identifying a target for a molecule comprising the steps: a) modeling the molecule in complex with a known target for the molecule (1001), b) obtaining potential target molecules by selecting potential target molecules with a defined homology to the known target (1002), and c) determining the binding affinity of a potential target with the molecule by modeling the potential target with the molecule, wherein side chain rotamers are sampled during homology modeling (1003).

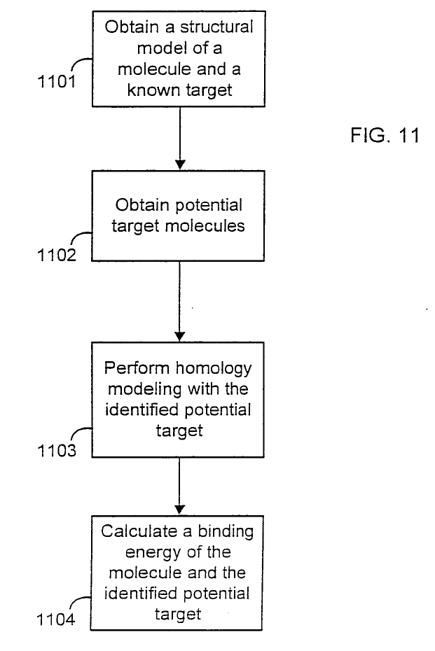

As illustrated in FIG. 11, also disclosed is a method of identifying a target for a molecule comprising the steps: a) obtaining a structural model of the molecule and a known target, wherein the known target comprises a known target-molecule binding domain (1101), b) obtaining a potential target by identifying potential targets having a defined homology with the known target (1102), c) performing homology modeling with the identified potential target, wherein during the homology modeling the backbone conformations are held identical to the known target, wherein the sidechains are sampled from a library of rotamers (1103), and d) calculating a binding energy of the molecule and the identified potential target (1104).

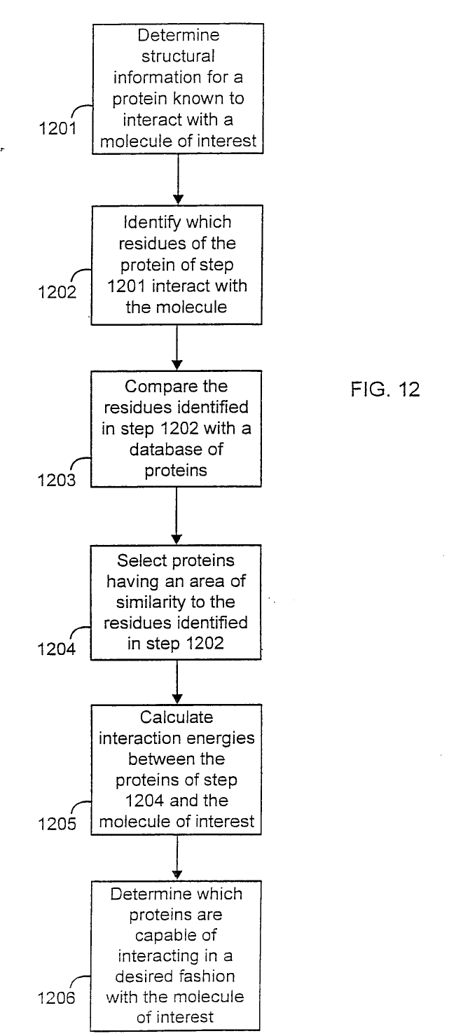

Also disclosed, and illustrated in FIG. 12, is a method of identifying a desired protein-molecule interaction comprising: a) determining structural information for a protein known to interact with the molecule of interest (1201); b) identifying which residues of the protein of step a) interact with the molecule (1202); c) comparing the residues identified in step b) with a database of proteins (1203); d) selecting proteins having an area of similarity to the residues identified in step b) (1204); e) calculating interaction energies between the proteins of step d) and the molecule of interest (1205); and f) determining which proteins are capable of interacting in a desired fashion with the molecule of interest (1206).

2. Methods of Making a Pharmaceutical Composition

a) Compositions Identified by Screening with Disclosed Compositions/Combinatorial Chemistry

(1) Combinatorial Chemistry

The disclosed methods and systems can be used for any combinatorial technique to identify molecules or macromolecular molecules that interact with the disclosed compositions in a desired way. For example, the disclosed methods for identifying targets for molecules, can identify a molecule-target pair, and this molecule-target pair interaction or activity can be modified, such as enhanced, by using the disclosed combinatorial techniques with a library related to the molecule to identify variants of the molecule that have even better or more desirable activity between the original molecule and target. Once the target is identified, the disclosed methods can also be used to identify molecules, such as a functional nucleic acid, which would have characteristics similar or more desirable, for example, than the original molecule and identified target. The nucleic acids, peptides, and related molecules disclosed herein can be used as targets for the combinatorial approaches.

It is understood that when using the disclosed compositions in combinatorial techniques or screening methods, molecules, such as macromolecular molecules, will be identified that have particular desired properties such as inhibition or stimulation or the target molecule's function. The molecules identified and isolated when using the disclosed compositions, such as kinases and other proteins and systems, are also disclosed. Thus, the products produced using the combinatorial or screening approaches that involve the disclosed compositions, such as kinases, are also considered herein disclosed.

Combinatorial chemistry includes but is not limited to all methods for isolating small molecules or macromolecules that are capable of binding either a small molecule or another macromolecule, typically in an iterative process. Proteins, oligonucleotides, and sugars are examples of macromolecules. For example, oligonucleotide molecules with a given function, catalytic or ligand-binding, can be isolated from a complex mixture of random oligonucleotides in what has been referred to as “in vitro genetics” (Szostak, TIBS 19:89, 1992). One synthesizes a large pool of molecules bearing random and defined sequences and subjects that complex mixture, for example, approximately 10¹⁵ individual sequences in 100 μg of a 100 nucleotide RNA, to some selection and enrichment process. Through repeated cycles of affinity chromatography and PCR amplification of the molecules bound to the ligand on the column, Ellington and Szostak (1990) estimated that 1 in 10¹⁰ RNA molecules folded in such a way as to bind a small molecule dyes. DNA molecules with such ligand-binding behavior have been isolated as well (Ellington and Szostak, 1992; Bock et al, 1992). Techniques aimed at similar goals exist for small organic molecules, proteins, antibodies and other macromolecules known to those of skill in the art. Screening sets of molecules for a desired activity whether based on small organic libraries, oligonucleotides, or antibodies is broadly referred to as combinatorial chemistry. Combinatorial techniques are particularly suited for defining binding interactions between molecules and for isolating molecules that have a specific binding activity, often called aptamers when the macromolecules are nucleic acids.

There are a number of methods for isolating proteins which either have de novo activity or a modified activity. For example, phage display libraries have been used to isolate numerous peptides that interact with a specific target. (See for example, U.S. Pat. No. 6,031,071; 5,824,520; 5,596,079; and 5,565,332 which are herein incorporated by reference at least for their material related to phage display and methods relate to combinatorial chemistry)

A preferred method for isolating proteins that have a given function is described by Roberts and Szostak (Roberts R. W. and Szostak J. W. Proc. Natl. Acad. Sci. USA, 94(23)12997-302 (1997). This combinatorial chemistry method couples the functional power of proteins and the genetic power of nucleic acids. An RNA molecule is generated in which a puromycin molecule is covalently attached to the 3′-end of the RNA molecule. An in vitro translation of this modified RNA molecule causes the correct protein, encoded by the RNA to be translated. In addition, because of the attachment of the puromycin, a peptdyl acceptor which cannot be extended, the growing peptide chain is attached to the puromycin which is attached to the RNA. Thus, the protein molecule is attached to the genetic material that encodes it. Normal in vitro selection procedures can now be done to isolate functional peptides. Once the selection procedure for peptide function is complete traditional nucleic acid manipulation procedures are performed to amplify the nucleic acid that codes for the selected functional peptides. After amplification of the genetic material, new RNA is transcribed with puromycin at the 3′-end, new peptide is translated and another functional round of selection is performed. Thus, protein selection can be performed in an iterative manner just like nucleic acid selection techniques. The peptide which is translated is controlled by the sequence of the RNA attached to the puromycin. This sequence can be anything from a random sequence engineered for optimum translation (i.e. no stop codons etc.) or it can be a degenerate sequence of a known RNA molecule to look for improved or altered function of a known peptide. The conditions for nucleic acid amplification and in vitro translation are well known to those of ordinary skill in the art and are preferably performed as in Roberts and Szostak (Roberts R. W. and Szostak J. W. Proc. Natl. Acad. Sci. USA, 94(23)12997-302 (1997)).

Another preferred method for combinatorial methods designed to isolate peptides is described in Cohen et al. (Cohen B. A., et al., Proc. Natl. Acad. Sci. USA 95(24):14272-7 (1998)). This method utilizes and modifies two-hybrid technology. Yeast two-hybrid systems are useful for the detection and analysis of protein:protein interactions. The two-hybrid system, initially described in the yeast Saccharomyces cerevisiae, is a powerful molecular genetic technique for identifying new regulatory molecules, specific to the protein of interest (Fields and Song, Nature 340:245-6 (1989)). Cohen et al., modified this technology so that novel interactions between synthetic or engineered peptide sequences could be identified which bind a molecule of choice. The benefit of this type of technology is that the selection is done in an intracellular environment. The method utilizes a library of peptide molecules that attached to an acidic activation domain. A peptide of choice, for example a portion of a kinase is attached to a DNA binding domain of a transcriptional activation protein, such as Gal 4. By performing the Two-hybrid technique on this type of system, molecules that bind the portion of a kinase can be identified.

Using methodology well known to those of skill in the art, in combination with various combinatorial libraries, one can isolate and characterize those small molecules or macromolecules, which bind to or interact with the desired target. The relative binding affinity of these compounds can be compared and optimum compounds identified using competitive binding studies, which are well known to those of skill in the art.

Techniques for making combinatorial libraries and screening combinatorial libraries to isolate molecules which bind a desired target are well known to those of skill in the art. Representative techniques and methods can be found in but are not limited to U.S. Pat. Nos. 5,084,824, 5,288,514, 5,449,754, 5,506,337, 5,539,083, 5,545,568, 5,556,762, 5,565,324, 5,565,332, 5,573,905, 5,618,825, 5,619,680, 5,627,210, 5,646,285, 5,663,046, 5,670,326, 5,677,195, 5,683,899, 5,688,696, 5,688,997, 5,698,685, 5,712,146, 5,721,099, 5,723,598, 5,741,713, 5,792,431, 5,807,683, 5,807,754, 5,821,130, 5,831,014, 5,834,195, 5,834,318, 5,834,588, 5,840,500, 5,847,150, 5,856,107, 5,856,496, 5,859,190, 5,864,010, 5,874,443, 5,877,214, 5,880,972, 5,886,126, 5,886,127, 5,891,737, 5,916,899, 5,919,955, 5,925,527, 5,939,268, 5,942,387, 5,945,070, 5,948,696, 5,958,702, 5,958,792, 5,962,337, 5,965,719, 5,972,719, 5,976,894, 5,980,704, 5,985,356, 5,999,086, 6,001,579, 6,004,617, 6,008,321, 6,017,768, 6,025,371, 6,030,917, 6,040,193, 6,045,671, 6,045,755, 6,060,596, and 6,061,636.

Combinatorial libraries can be made from a wide array of molecules using a number of different synthetic techniques. For example, libraries containing fused 2,4-pyrimidinediones (U.S. Pat. No. 6,025,371) dihydrobenzopyrans (U.S. Pat. Nos. 6,017,768 and 5,821,130), amide alcohols (U.S. Pat. No. 5,976,894), hydroxy-amino acid amides (U.S. Pat. No. 5,972,719) carbohydrates (U.S. Pat. No. 5,965,719), 1,4-benzodiazepin-2,5-diones (U.S. Pat. No. 5,962,337), cyclics (U.S. Pat. No. 5,958,792), biaryl amino acid amides (U.S. Pat. No. 5,948,696), thiophenes (U.S. Pat. No. 5,942,387), tricyclic Tetrahydroquinolines (U.S. Pat. No. 5,925,527), benzofurans (U.S. Pat. No. 5,919,955), isoquinolines (U.S. Pat. No. 5,916,899), hydantoin and thiohydantoin (U.S. Pat. No. 5,859,190), indoles (U.S. Pat. No. 5,856,496), imidazol-pyrido-indole and imidazol-pyrido-benzothiophenes (U.S. Pat. No. 5,856,107) substituted 2-methylene-2,3-dihydrothiazoles (U.S. Pat. No. 5,847,150), quinolines (U.S. Pat. No. 5,840,500), PNA (U.S. Pat. No. 5,831,014), containing tags (U.S. Pat. No. 5,721,099), polyketides (U.S. Pat. No. 5,712,146), morpholino-subunits (U.S. Pat. Nos. 5,698,685 and 5,506,337), sulfamides (U.S. Pat. No. 5,618,825), and benzodiazepines (U.S. Pat. No. 5,288,514).

As used herein combinatorial methods and libraries included traditional screening methods and libraries as well as methods and libraries used in iterative processes.

Also disclosed herein are methods of making a pharmaceutical composition. In the methods described herein, interactions between potential targets and molecules can be found. These interactions can indicate, for example, a drug-target interaction. Once this interaction is established, pharmaceutical compositions can be made that interact with the target. One example of a method of making a pharmaceutical comprises a) modeling the pharmaceutical in complex with a known target for the molecule; b) obtaining potential target molecules by selecting potential target molecules with a defined homology to the known target, c) determining the binding affinity of a potential target with the pharmaceutical by modeling the potential target with the pharmaceutical, wherein a Monte Carlo function is used for sampling of side chain rotamers; d) identifying target molecules of the pharmaceutical; e) synthesizing the pharmaceutical; and f) testing the pharmaceutical for binding to the target molecule.

It is understood that there are numerous ways in which the disclosed methods can be combined with other drug discovery mechanisms. For example, once potential targets are identified for a known molecule, as described herein, other drug discovery and selection techniques can be employed to create a library of molecules related to the known molecule with the identified target to optimize the manipulation of the identified target. These varied molecules can be tested and identified in the disclosed methods, just as the identified targets were identified using the disclosed methods.

For example, once a potential target of a drug has been identified, structures of closely related molecules can also be constructed using methods outlined earlier and tested for their ability to bind to the potential target with more selectivity. This can be done by for example, adding small functional groups (e.g. methyl, hydroxyl, t-butyl) to the original molecule using standard molecular modeling methods known to those skilled in the art. It can be assumed in this process that the positions of those atoms that are common to both the original drug and the modified drug will remain the same. The binding energy of the newly modified molecule with the potential target and other known targets can then be computed in order to identify molecules that bind with greater selectivity for the potential target of interest. Large numbers of possible modifications to an existing molecule can be investigated individually. In this way, a drug can be developed that binds strongly to a desired target without also binding strongly to other, undesired targets.

Once a modified molecule whose computed selectivity for a desired target has been designed computationally, it can be synthesized by standard organic chemistry. The computational nature of the design process will lessen the need for expensive efforts to be directed toward synthesizing modified molecules that ultimately do not have the desired selectivity.

3. Methods of Inhibiting a Receptor

Disclosed herein are methods of inhibiting a specific receptor with a known drug. Using the methods disclosed herein, various drug-target interactions can be elucidated

For example, disclosed are methods of inhibiting a receptor selected from the group consisting of MAK, FLT4, MUSK, CDK3, KDR, PCTAIRE2, CDK2, PCTAIRE1, CDC2, FLT3, CDKL1, Erk3, ICK, CDK7, TRKA, PCTAIRE3, CDC7, Erk4, GCN2, ROR1, NEK3, FLT1, NEK6, PDGFRa, FGFR2, CASK, ROR2, Erk7, NEK7, CCRK, TRKB, CDK5, DYRK1A, TRKC, MPSK1, AurA, MAP3K4, RET, DYRK1B, CDK9, CDKL3, AurB, JAK2, TIE1, AurC, MSK1, PEK, MER, PFTAIRE2, PIM2, SGK, ABL, Wee1, PFTAIRE1, LMR2, CDKL2, Wee1B, PAK5, CLK3, TLK1, TLK2, PAK4, EphA1, EphA7, JAK1, MSK2, DDR1, KIT, CDK11, CDK8, FGFR3, PKCt, DDR2, SRPK2, PDGFRb, FGFR1, DYRK4, EphB3, TIE2, CDK6, Fused, PKACg, NEK9, SRPK1, TYK2, RSK1, RSK3, HCK, RSK2, RSK4, EphA6, PKCz, CHED, GSK3B, DMPK2, JAK3, MRCKb, PYK2, ITK, IRAK1, PKCi, MRCKa, MLK1, MAP2K5, HRI, EphA10, DMPK1, CDKL4, YES, EphB6, and SYK comprising incubating the receptor with the drug purvalanol. Purvalanol is a known selective inhibitor of the human CDK2/cyclin A and Cdc2/cyclin B kinase complex.

Also disclosed are methods of inhibiting a receptor selected from the group consisting of EphA1, EphB3, EphB1, EphB4, RIPK3, EphB2, DDR1, FRK, DDR2, EphA8, PDGFRa, YES, BRK, BLK, MAP2K5, QIK, LYN, QSK, FGR, EphA6, HCK, PDGFRb, LCK, YANK2, EphA3, SIK, EphA4, MOK, p38a, EphA5, SRM, YANK3, YANK1, SRC, FYN, p38b, RiPK2, MLK4, EphA2, EphB6, RSK4 (Domain 2), GAK, RET, RSK3 (Domain 2), TGFbR2, BRAF, CSK, ACK, RAF1, CaMKK1, HER4/ErbB4, BTK, KDR, FLT4, and KIT comprising incubating the receptor with the drug SB 203580. SB 203580 is a pyridinyl imidazole which acts as a specific inhibitor of p38 MAP Kinase. It has the chemical formula C21H16N3FOS, and the chemical name 4-(4-Fluorophenyl)-2-(4-methylsulfinyl phenyl)-5-(4-pyridyl) 1H-imidazole.

Also disclosed are methods of inhibiting a receptor selected from the group consisting of FMS, TEC, MYT1, IKKb, RiPK2, RET, YES, BMX, CSK, HCK, FRK, BLK, FGR, ABL, SRC, LCK, LYN, ACK, PDGFRa, IKKa, PDGFRb, KIT, FGFR2, HER4/ErbB4, FYN, FLT1, SYK, FGFR4, FAK, FLT4, Wnk2, and Wnk3 comprising incubating the receptor with the drug imatinib. Imatinib mesylate is designated chemically as 4-[(4-Methyl-1-piperazinyl)methyl]-N-[4-methyl-3-[[4-(3-pyridinyl)-2-pyrimidinyl]amino]-phenyl]benzamide methanesulfonate.

The above methods of inhibiting a receptor can also comprise the step of identifying the receptor as a target for the drug prior to inhibiting the receptor, identifying a subject in need of modulating the particular receptor, identifying a subject as having a disease where the particular receptor is involved, or diagnosing a need for modulation of the receptor, or indicating an understanding of a need for modulating the receptor or treating the subject for any of the targets or receptors or compositions described herein, alone or in any combination.

Table 9 shows the sequence of a number of kinases identified and discussed herein.

| | | | | | | SEQ ID |
|---|---|---|---|---|---|---|
| | | | | | SEQ ID | NO |
| | Acces- | | | | NO | Kinase |
| Name | sion | Group | Family | Pseudogene? | Protein | Domain |
| ABL | SK006 | TK | Abl | N | 1 | 33 |
| ACK | SK009 | TK | Ack | N | 2 | 34 |
| Wnk2 | SK016 | Other | Wnk | N | 3 | 35 |
| BLK | SK049 | TK | Src | N | 4 | 36 |
| FMS | SK094 | TK | PDGFR | N | 5 | 37 |
| CSK | SK095 | TK | Csk | N | 6 | 38 |
| FAK | SK138 | TK | Fak | N | 7 | 39 |
| FGFR2 | SK144 | TK | FGFR | N | 8 | 40 |
| FGFR4 | SK147 | TK | FGFR | N | 9 | 41 |
| FGR | SK148 | TK | Src | N | 10 | 42 |
| FLT1 | SK150 | TK | VEGFR | N | 11 | 43 |
| FLT4 | SK151 | TK | VEGFR | N | 12 | 44 |
| FYN | SK153 | TK | Src | N | 13 | 45 |
| HCK | SK164 | TK | Src | N | 14 | 46 |
| HER4/ | SK168 | TK | EGFR | N | 15 | 47 |
| ErbB4 | | | | | | |
| IKKa | SK175 | Other | IKK | N | 16 | 48 |
| IKKb | SK176 | Other | IKK | N | 17 | 49 |
| KIT | SK201 | TK | PDGFR | N | 18 | 50 |
| LCK | SK206 | TK | Src | N | 19 | 51 |
| LYN | SK210 | TK | Src | N | 20 | 52 |
| MYT1 | SK248 | Other | WEE | N | 21 | 53 |
| PDGFRa | SK274 | TK | PDGFR | N | 22 | 54 |
| PDGFRb | SK275 | TK | PDGFR | N | 23 | 55 |
| RET | SK326 | TK | Ret | N | 24 | 56 |
| RIPK2 | SK329 | TKL | RIPK | N | 25 | 57 |
| SRC | SK357 | TK | Src | N | 26 | 58 |
| SYK | SK363 | TK | Syk | N | 27 | 59 |
| TEC | SK366 | TK | Tec | N | 28 | 60 |
| YES | SK393 | TK | Src | N | 29 | 61 |
| BMX | SK417 | TK | Tec | N | 30 | 62 |
| FRK | SK419 | TK | Src | N | 31 | 63 |
| Wnk3 | SK641 | Other | Wnk | N | 32 | 64 |

4. Summary of Therapeutic Relevance for Top 50 Imatinib Targets

The targets identified for imatinib are in Table 9. These targets have therapeutic relvance. For example, Table 10 shows a list of targets and their binding energy to imainib as disclosed herein along with a non-limiting list of diseases the target is associated with.

111.

TABLE 10

| Target | | Binding | Commercial | |
|---|---|---|---|---|
| Name | KSD ID | Energy | Availability | Therapeutic Targets |
| RET | 5419753 | −18.64 | Yes | Familial medullarly thyroid carcinoma: |
| | | | | Kameyama K, Okinaga H, Takami H |
| | | | | RET oncogene mutations in 75 cases of familial medullary |
| | | | | thyroid carcinoma in Japan |
| | | | | BIOMEDICINE & PHARMACOTHERAPY 58 (6-7): 345-347 |
| | | | | JUL-AUG 2004: |
| | | | | Human papillary thyroid carcinoma: |
| | | | | Melillo RM, Cirafici AM, De Falco V, et al. |
| | | | | The oncogenic activity of RET point mutants for follicular |
| | | | | thyroid cells may account for the occurrence of papillary |
| | | | | thyroid carcinoma in patients affected by familial medullary |
| | | | | thyroid carcinoma |
| | | | | AMERICAN JOURNAL OF PATHOLOGY 165 (2): 511-521 |
| | | | | AUG 2004 |
| | | | | Multiple endocrine neoplasia type 2: |
| | | | | Arighi E, Popsueva A, Degl'Innocenti D, et al. |
| | | | | Biological effects of the dual phenotypic Janus mutation of |
| | | | | ret cosegregating with both multiple endocrine neoplasia |
| | | | | type 2 and Hirschsprung's disease |
| | | | | MOLECULAR ENDOCRINOLOGY 18 (4): 1004-1017 |
| | | | | APR 1 2004 |
| FMS | Sk094 | −22.20 | Yes | Choriocarcinoma: Chambers SK, Ivins CM, Kacinski BM, |
| | | | | et al. |
| | | | | An unexpected effect of glucocorticoids on stimulation of c- |
| | | | | fms proto-oncogene expression in choriocarcinoma cells |
| | | | | that express little glucocorticoid receptor |
| | | | | AMERICAN JOURNAL OF OBSTETRICS AND |
| | | | | GYNECOLOGY 190 (4): 974-983 APR 2004 |
| | | | | Preeclampsia: |
| | | | | Chang E, Robinson C, Johnson D, et al. |
| | | | | Soluble FMS-like tyrosine kinase 1 levels are elevated in |
| | | | | preeclampisa and correlate with disease severity |
| | | | | AMERICAN JOURNAL OF OBSTETRICS AND |
| | | | | GYNECOLOGY 189 (6): S95-S95 110 Suppl. S DEC 2003 |
| | | | | Breast cancer: |
| | | | | Flick MB, Sapi E, Kacinski BM |
| | | | | Hormonal regulation of the c-fms proto-oncogene in breast |
| | | | | cancer cells is mediated by a composite glucocorticoid |
| | | | | response element |
| | | | | JOURNAL OF CELLULAR BIOCHEMISTRY 85 (1): 10-23 |
| | | | | 2002 |
| | | | | Kawasaki disease: |
| | | | | Yasukawa K, Terai M, Shulman ST, et al. |
| | | | | Systemic production of vascular endothelial growth factor |
| | | | | and fms-like tyrosine kinase-1 receptor in acute Kawasaki |
| | | | | disease |
| | | | | CIRCULATION 105 (6): 766-769 FEB 12 2002 |
| | | | | Colon carcinoma: |
| | | | | Cui J, Yang DH, Bi XJ, et al. |
| | | | | Methylation status of c-fms oncogene in HCC and its |
| | | | | relationship with clinical pathology |
| | | | | WORLD JOURNAL OF GASTROENTEROLOGY 7 (1): |
| | | | | 136-139 FEB 2001 |
| | | | | Pathological bone resorption: |
| | | | | Al-Saffar N, Revell PA |
| | | | | Differential expression of transforming growth factor-alpha |
| | | | | and macrophage colony-stimulating factor/colony- |
| | | | | stimulating factor-1R (c-fms) by multinucleated giant cells |
| | | | | involved in pathological bone resorption at the site of |
| | | | | orthopaedic implants |
| | | | | JOURNAL OF ORTHOPAEDIC RESEARCH 18 (5): 800-807 |
| | | | | SEP 2000 |
| | | | | Myeloid malignancy: |
| | | | | NCBI entry: Mutations in this gene have been associated with |
| | | | | a predisposition to myeloid malignancy. |
| | | | | http://www.ncbi.nlm.nih.gov/entrez/viewer.fcgi?27262659:N |
| | | | | CBI:5994077 |
| TEC | 4507429 | −20.31 | No | Cancer: |
| | | | | Maltais A, Filion C, Labelle Y |
| | | | | The AF2 domain of the orphan nuclear receptor TEC is |
| | | | | essential for the transcriptional activity of the oncogenic |
| | | | | fusion protein EWS/TEC |
| | | | | CANCER LETTERS 183 (1): 87-94 SEP 8 2002 |
| | | | | Myelodysplastic syndrome: |
| | | | | OMIM entry: |
| | | | | Interestingly, high expression of TEC was seen in |
| | | | | each of 3 patients examined with myelodysplastic |
| | | | | syndrome. |
| | | | | http://www.ncbi.nlm.nih.gov/entrez/dispomim.cgi?id=600583 |
| MYT1 | 2460023 | −19.56 | No | Cervical cancer (Patent 6,391,894) |
| IKKb | 3213217 | 019.52 | Yes | Inflammation; |
| | | | | Scheidereit C |
| | | | | Mechanims of gene activation by pathogenic and |
| | | | | inflammatory stimuli through IKK and NF-kB pathways |
| | | | | SHOCK 21: 45-45 177 Suppl. 1 2004 |
| | | | | Breast cancer: |
| | | | | Monks NR, Pardee AB, Baile SR, et al. |
| | | | | Specific inhibition of NF-kB activation by dominant |
| | | | | negative IKK-beta and siRNA in ER-negative human breast |
| | | | | cancer cells. |
| | | | | CLINICAL CANCER RESEARCH 9 (16): 6102S-6103S |
| | | | | Part 2 Suppl. S DEC 1 2003 |
| | | | | Prostate cancer: |
| | | | | Gasparian AV, Yao YJ, Lu JX, et al. |
| | | | | Selenium compounds inhibit I kappa B kinase (IKK) and |
| | | | | nuclear factor-kappa B (NF-kappa B) in prostate cancer |
| | | | | cells |
| | | | | MOLECULAR CANCER THERAPEUTICS 1 (12): 1079-1087 |
| | | | | OCT 2002 |
| RIPk2 | 4505637 | −18.66 | No | Crohn's disease; arthrocutaneouveal granulomatosis |
| | | | | (Blau syndrome); granulomatous synovitis with uveitis |
| | | | | and cranial neuropathies (Blau syndrome) |
| | | | | http://genecards.bcgsc.ca/cgi- |
| | | | | bin/carddisp?CARD15&snpcount=25 |
| | | | | Christian Stehlik, Hideki Hayashi, Frederick Pio, Adam |
| | | | | Godzik and John C. Reed |
| | | | | CARD6 Is a Modulator of NF-B Activation by Nod1- and |
| | | | | Cardiak-mediated Pathways |
| | | | | J. Biol. Chem., Vol. 278, Issue 34, 31941-31949, Aug. 22, |
| | | | | 2003 |
| YES | 125870 | −18.38 | Yes | Parkinson's disease: |
| | | | | Nakaso K, Yoshimoto Y, Nakano T, et al. |
| | | | | Transcriptional activation of p62/A170/ZIP during the |
| | | | | formation of the aggregates: possible mechanisms and the |
| | | | | role in Lewy body formation in Parkinson's disease |
| | | | | BRAIN RESEARCH 1012 (1-2): 42-51 JUN 25 2004 |
| | | | | Prostate cancer: |
| | | | | Kitamura H, Torigoe T, Asanuma H, et al. |
| | | | | Cytosolic overexpression of p62 sequestosome 1 is a novel |
| | | | | characteristic of neoplastic prostate tissue. Differential |
| | | | | immunohistochemical pattern of p62 expression in selected |
| | | | | pathologic entities of the prostate gland |
| | | | | JOURNAL OF UROLOGY 171 (4): 106-106 Suppl. S APR |
| | | | | 2004 |
| | | | | Breast cancer: |
| | | | | Thompson HGR, Harris JW, Wold BJ, et al. |
| | | | | p62 overexpression in breast tumors and regulation by |
| | | | | prostate-derived Ets factor in breast cancer cells |
| | | | | ONCOGENE 22 (15): 2322-2333 APR 17 2003 |
| | | | | Paget's disease of the bone: |
| | | | | Ciani B, Layfield R, Cavey JR, et al. |
| | | | | Structure of the ubiquitin-associated domain of p62 |
| | | | | (SQSTM1) and implications for mutations that cause |
| | | | | Paget's disease of bone |
| | | | | JOURNAL OF BIOLOGICAL CHEMISTRY 278 (39): |
| | | | | 37409-37412 SEP 26 2003 |
| | | | | Frontotemporal dementia: |
| | | | | Arai T, Nonaka T, Hasegawa M, et al. |
| | | | | Neuronal and glial inclusions in frontotemporal dementia |
| | | | | with or without motor neuron disease are immunopositive |
| | | | | for p62 |
| | | | | NEUROSCIENCE LETTERS 342 (1-2): 41-44 MAY 15 |
| | | | | 2003 |
| | | | | Mixed connective tissue disease: |
| | | | | Kraemer DM, Kraus MR, Kneitz C, et al. |
| | | | | Nucleoporin p62 antibodies in a case of mixed connective |
| | | | | tissue disease |
| | | | | CLINICAL AND DIAGNOSTIC LABORATORY |
| | | | | IMMUNOLOGY 10 (2): 329-331 MAR 2003 |
| | | | | Inflammation: |
| | | | | Moscat J, Diaz-Meco MT |
| | | | | The atypical PKC scaffold protein P62 is a novel target for |
| | | | | anti-inflammatory and anti-cancer therapies |
| | | | | ADVANCES IN ENZYME REGULATION 42: 173-179 |
| | | | | 2002 |
| | | | | Alzheimer's disease: |
| | | | | Kuusisto E, Salminen A, Alafuzoff I |
| | | | | Early accumulation of p62 in neurofibrillary tangles in |
| | | | | Alzheimer's disease: possible role in tangle formation |
| | | | | NEUROPATHOLOGY AND APPLIED |
| | | | | NEUROBIOLOGY 28 (3): 228-237 JUN 2002 |
| BMX | 4502435 | −18.35 | Yes | Breast cancer: |
| | | | | Chen XY, Huang LM, Kung HJ, et al. |
| | | | | The role of tyrosine kinase Etk/Bmx in EGF-induced |
| | | | | apoptosis of MDA-MB-468 breast cancer cells |
| | | | | ONCOGENE 23 (10): 1854-1862 MAR 11 2004 |
| | | | | Prostate cancer: |
| | | | | Lee LF, Guan JL, Qiu Y, et al. |
| | | | | Neuropeptide-induced androgen independence in prostate |
| | | | | cancer cells: Roles of nonreceptor tyrosine kinases |
| | | | | Etk/Bmx, Src, and focal adhesion kinase |
| | | | | MOLECULAR AND CELLULAR BIOLOGY 21 (24): |
| | | | | 8385-8397 DEC 2001 |
| CSK | 729887 | −18.32 | Yes | Colon cancer: |
| | | | | Rengifo-Cam W, Konishi A, Morishita N, et al. |
| | | | | Csk defines the ability of integrin-mediated cell adhesion |
| | | | | and migration in human colon cancer cells: implication for a |
| | | | | potential role in cancer metastasis |
| | | | | ONCOGENE 23 (1): 289-297 JAN 8 2004 |
| | | | | Breast cancer: |
| | | | | McShan GD, Zagozdzon R, Park SY, et al. |
| | | | | Csk homologous kinase associates with RAFTK/Pyk2 in |
| | | | | breast cancer cells and negatively regulates its activation |
| | | | | and breast cancer cell migration |
| | | | | INTERNATIONAL JOURNAL OF ONCOLOGY 21 (1): |
| | | | | 197-205 JUL 2002 |
| HCK | 2194103 | −18.14 | Yes | HIV: |
| | | | | Hanna Z, Weng XD, Kay DG, et al. |
| | | | | The pathogenicity of human immunodeficiency virus (HIV) |
| | | | | type 1 Nef in CD4C/HIV transgenic mice is abolished by |
| | | | | mutation of its SH3-binding domain, and disease |
| | | | | development is delayed in the absence of Hck |
| | | | | JOURNAL OF VIROLOGY 75 (19): 9378-9392 OCT 2001 |
| | | | | Encephalomyocarditis virus-induced diabetes: |
| | | | | Choi KS, Jun HS, Kim HN, et al. |
| | | | | Role of Hck in the pathogenesis of encephalomyocarditis |
| | | | | virus-induced diabetes in mice |
| | | | | JOURNAL OF VIROLOGY 75 (4): 1949-1957 FEB 2001 |
| | | | | Cancer: |
| | | | | Howlett CJ, Bisson SA, Resek ME, et al. |
| | | | | The proto-oncogene p120(Cbl) is a downstream substrate of |
| | | | | the Hck protein-tyrosine kinase |
| | | | | BIOCHEMICAL AND BIOPHYSICAL RESEARCH |
| | | | | COMMUNICATIONS 257 (1): 129-138 APR 2 1999 |
| FRK | 4503787 | −18.10 | No | OMIM entry: |
| | | | | PCR analysis detected highest expression of FRK in |
| | | | | breast and lung cancer cell lines, with minimal |
| | | | | expression in hemopoietic cell lines. Expression in |
| | | | | lung tumors was variable. |
| | | | | Anneren et al. (2000) showed that expression of Gtk, |
| | | | | the rodent homolog of FRK, in a rat |
| | | | | pheochromocytoma cell line used as a model for |
| | | | | neuronal cell differentiation induced nerve growth |
| | | | | factor (see 162030)-independent neurite outgrowth |
| | | | | and Rap1 (179520) activation, probably through |
| | | | | activation of the CrkII (164762)-C3G (GRF2; |
| | | | | 600303) pathway. |
| | | | | http://www.ncbi.nlm.nih.gov/entrez/dispomim.cgi?id=606573 |
| BLK | 914204 | −18.03 | Yes | OMIM entry: |
| | | | | Expression of BLK in immature T cells suggested |
| | | | | that it may play an important role in thymopoiesis. |
| | | | | Appel et al. (2002) constructed a physical and |
| | | | | transcription map of the critical region for keratolytic |
| | | | | winter erythema (KWE; 148370), an autosomal |
| | | | | dominant skin disorder mapped to chromosome |
| | | | | 8p23-p22. The BLK gene was identified in the BAC |
| | | | | contig between microsatellite markers D8S1695 and |
| | | | | D8S1759. The gene is comprised of 13 exons |
| | | | | spanning about 70 kb. In contrast to the results of |
| | | | | Drebin et al. (1995), Appel et al. (2002) detected |
| | | | | transcription of BLK in lymphoblastoid cell lines, |
| | | | | spleen, liver, leukocytes, ovary, muscle, and testis. |
| | | | | Mutation screening of each exon by direct |
| | | | | sequencing of genomic DNA from KWE patients did |
| | | | | not reveal any pathogenic mutation. Because BLK is |
| | | | | a member of the SRC family, which is thought to |
| | | | | play an important role in the signaling pathways |
| | | | | controlling cell proliferation and differentiation, the |
| | | | | authors considered the gene to be a good positional |
| | | | | candidate for the cancers mapping to this region. |
| | | | | htp://www.ncbi.nlm.nih.gov/entrez/dispomim.cgi?id=191305 |
| FGR | 125358 | −17.95 | Yes | Small cell lung cancer: |
| | | | | Zarn JA, Zimmermann SM, Pass MK, et al. |
| | | | | Association of CD24 with the kinase c-fgr in a small cell |
| | | | | lung cancer cell line and with the kinase lyn in an |
| | | | | erythroleukemia cell line |
| | | | | BIOCHEMICAL AND BIOPHYSICAL RESEARCH |
| | | | | COMMUNICATIONS 225 (2): 384-391 AUG 14 1996 |
| | | | | Epstein-Barr Virus: |
| | | | | CHEAH MSC, PARMLEY RT, SUMAYA CV, et al. |
| | | | | C-FGR ONCOGENE EXPRESSION IN HEMOPHILIA |
| | | | | WITH ELEVATED EPSTEIN-BARR-VIRUS (EBV) |
| | | | | SEROLOGY AND AIDS-LYMPHOMAS |
| | | | | PEDIATRIC RESEARCH 27 (4): A140-A140 Part 2 APR |
| | | | | 1990 |
| | | | | AIDS: |
| | | | | CHEAH MSC, PARMLEY RT, SUMAYA CV, et al. |
| | | | | C-FGR ONCOGENE EXPRESSION IN HEMOPHILIA |
| | | | | WITH ELEVATED EPSTEIN-BARR-VIRUS (EBV) |
| | | | | SEROLOGY AND AIDS-LYMPHOMAS |
| | | | | PEDIATRIC RESEARCH 27 (4): A140-A140 Part 2 APR |
| | | | | 1990 |
| | | | | Burkitt's lymphoma: |
| | | | | SHARP NA, LUSCOMBE MJ, CLEMENS MJ |
| | | | | REGULATION OF C-FGR PROTO-ONCOGENE |
| | | | | EXPRESSION IN BURKITTS-LYMPHOMA CELLS - |
| | | | | EFFECT OF INTERFERON TREATMENT AND |
| | | | | RELATIONSHIP TO EBV STATUS AND C-MYC |
| | | | | MESSENGER-RNA LEVELS |
| | | | | ONCOGENE 4 (8): 1043-1046 AUG 1989 |
| ABL | 625609 | −17.91 | Yes | Chronic myelogenous leukemia: |
| | | | | Tsukahara F, Maru Y |
| | | | | Mechanism of stability and degradation of the chronic |
| | | | | myelogenous leukemia oncoprotein, BCR-ABL |
| | | | | JOURNAL OF PHARMACOLOGICAL SCIENCES 94: |
| | | | | 105P-105P Suppl. 1 2004 |
| SRC | 125711 | −17.90 | Yes | Breast cancer: |
| | | | | Rossi AM, Capiati DA, Picotto G, et al. |
| | | | | MAPK inhibition by 1 alpha,25(OH)(2)-vitamin D-3 in breast |
| | | | | cancer cells. Evidence on the participation of the VDR and |
| | | | | Src |
| | | | | JOURNAL OF STEROID BIOCHEMISTRY AND |
| | | | | MOLECULAR BIOLOGY 89-90 (1-5): 287-290 Sp. Iss. SI |
| | | | | MAY 2004 |
| | | | | Medullary thyroid cancer: |
| | | | | Liu ZJ, Falola J, Zhu XD, et al. |
| | | | | Antiproliferative effects of Src inhibition on medullary thyroid |
| | | | | cancer |
| | | | | JOURNAL OF CLINICAL ENDOCRINOLOGY AND |
| | | | | METABOLISM 89 (7): 3503-3509 JUL 2004 |
| | | | | Colon cancer: |
| | | | | Thamilselvan V, Patel A, van Zyp JV, et al. |
| | | | | Colon cancer cell adhesion in response to Src kinase |
| | | | | activation and actin-cytoskeleton by non-laminar shear stress |
| | | | | JOURNAL OF CELLULAR BIOCHEMISTRY 92 (2): 361-371 |
| | | | | MAY 15 2004 |
| | | | | Prostate cancer: |
| | | | | Paronetto MP, Farini D, Sammarco I, et al. |
| | | | | Expression of a truncated form of the c-kit tyrosine kinase |
| | | | | receptor and activation of Src kinase in human prostatic |
| | | | | cancer |
| | | | | AMERICAN JOURNAL OF PATHOLOGY 164 (4): 1243-1251 |
| | | | | APR 2004 |
| LCK | 8569365 | −17.90 | Yes | Coxsackievirus B3-mediated heart disease: |
| | | | | Liu P, Aitken K, Kong YY, et al. |
| | | | | The tyrosine kinase p56(lck) is essential in coxsackievirus B3- |
| | | | | mediated heart disease |
| | | | | NATURE MEDICINE 6 (4): 429-434 APR 2000 |
| | | | | Small cell lung cancer: |
| | | | | Krystal GW, Litz J |
| | | | | Activation of LCK by Kit is necessary for SCF-mediated |
| | | | | growth of small cell lung cancer. |
| | | | | BLOOD 90 (10): 1375-1375 Part 1 Suppl. 1 NOV 15 1997 |
| | | | | Colorectal cancer: |
| | | | | Mayer K, Ballhausen WG |
| | | | | Expression of alternatively spliced lck transcripts from the |
| | | | | proximal promoter in colorectal cancer derived cell lines |
| | | | | ANTICANCER RESEARCH 16 (4A): 1733-1737 JUL-AUG |
| | | | | 1996 |
| LYN | 125480 | −17.90 | Yes | Prostate cancer: |
| | | | | Goldenberg-Furmanov M, Stein I, Pikarsky E, et al. |
| | | | | Lyn is a target gene for prostate cancer: Sequence-based |
| | | | | inhibition induces regression of human tumor xenografts |
| | | | | CANCER RESEARCH 64 (3): 1058-1066 FEB 1 2004 |
| | | | | Erthroleukemia: |
| | | | | Zarn JA, Zimmermann SM, Pass MK, et al. |
| | | | | Association of CD24 with the kinase c-fgr in a small cell lung |
| | | | | cancer cell line and with the kinase lyn in an erythroleukemia |
| | | | | cell line |
| | | | | BIOCHEMICAL AND BIOPHYSICAL RESEARCH |
| | | | | COMMUNICATIONS 225 (2): 384-391 AUG 14 1996 |
| PDGFRα | 5453870 | −17.07 | Yes | Metastatic cancer: |
| | | | | Tsutsumimoto T, Yi B, Williams P, et al. |
| | | | | Paracrine activation of PDGFR tyrosine kinase in |
| | | | | Osteoblasts is critical to osteosclerotic bone Metastases in |
| | | | | breast cancer producing PDGF-BB. |
| | | | | JOURNAL OF BONE AND MINERAL RESEARCH 18: |
| | | | | S198-S198 Suppl. 2 SEP 2003 |
| | | | | Breast cancer: |
| | | | | Kleer CG, Shen R, Wolf J, et al. |
| | | | | Characterization of platelet derived growth factor receptor |
| | | | | (PDGFR) expression in breast cancer identifies |
| | | | | inflammatory breast cancer as a potential target for |
| | | | | treatment with PDGFR inhibitors |
| | | | | MODERN PATHOLOGY 16(1): 153 JAN 2003 |
| | | | | Myeloproliferative disease: |
| | | | | Cools J, Stover EH, Boulton CL, et al. |
| | | | | PKC412 overcomes resistance to imatinib in a murine |
| | | | | model of FIP1L1-PDGFR alpha-induced myeloproliferative |
| | | | | disease |
| | | | | CANCER CELL 3(5): 459-469 MAY 2003 |
| | | | | Medulloblastoma: |
| | | | | MacDonald TJ, Brown KM, LaFleur B, et al. |
| | | | | Expression profiling of medulloblastoma: PDGFRA and the |
| | | | | RAS/MAPK pathway as therapeutic targets for metastatic |
| | | | | disease |
| | | | | NATURE GENETICS 29 (2): 143-152 OCT 2001 |
| IKKa | 4502843 | −17.04 | Yes | Lung cancer: |
| | | | | Sanlioglu S, Luleci G, Thomas KW |
| | | | | Simultaneous inhibition of Rac1 and IKK pathways sensitizes |
| | | | | lung cancer cells to TNF alpha-mediated apoptosis |
| | | | | CANCER GENE THERAPY 8 (11): 897-905 NOV 2001 |
| PDGFRb | 4505683 | −16.97 | YES | Myeloproliferative disease: |
| | | | | Cain JA, Grisolano JL, Laird AD, et al. |
| | | | | Complete remission of TEL-PDGFRB-induced |
| | | | | myeloproliferative disease in mice by receptor tyrosine |
| | | | | kinase inhibitor SU11657 |
| | | | | BLOOD 104 (2): 561-564 JUL 15 2004 |
| | | | | Breast cancer: |
| | | | | Kleer CG, Shen R, Wolf J, et al. |
| | | | | Characterization of platelet derived growth factor receptor |
| | | | | (PDGFR) expression in breast cancer identifies |
| | | | | inflammatory breast cancer as a potential target for |
| | | | | treatment with PDGFR inhibitors |
| | | | | MODERN PATHOLOGY 16 (1): 153 JAN 2003 |
| KIT | 18117734 | −16.78 | No | Small cell lung cancer: |
| | | | | Rohr UP, Rehfeld N, Pflugfelder L, et al. |
| | | | | Expression of the tyrosine kinase C-kit is an independent |
| | | | | prognostic factor in patients with small cell lung cancer |
| | | | | INTERNATIONAL JOURNAL OF CANCER 111 (2): 259-263 |
| | | | | AUG 20 2004 |
| | | | | Systemic mast cell disease associated with eosinophilia: |
| | | | | Cervantes F, Camos M, Boque C, et al. |
| | | | | FIP1L1-PDGFRA and c-kit D816V mutation-based |
| | | | | clonality studies in systemic mast cell disease associated |
| | | | | with eosinophilia |
| | | | | HAEMATOLOGICA 89 (7): 871-873 JUL 2004 |
| | | | | Prostate cancer: |
| | | | | Paronetto MP, Farini D, Sammarco I, et al. |
| | | | | Expression of a truncated form of the c-kit tyrosine kinase |
| | | | | receptor and activation of Src kinase in human prostatic |
| | | | | cancer |
| | | | | AMERICAN JOURNAL OF PATHOLOGY 164(4): 1243-1251 |
| | | | | APR 2004 |
| | | | | Gastrointestinal stromal tumors: |
| | | | | de Silva MV, Reid R |
| | | | | Gastrointestinal stromal tumors (GIST): C-kit mutations, |
| | | | | CD117 expression, differential diagnosis and targeted |
| | | | | cancer therapy with imatinib |
| | | | | PATHOLOGY & ONCOLOGY RESEARCH 9 (1): 13-19 |
| | | | | 2003 |
| FGFR2 | 533220 | −16.66 | No | Breast cancer: |
| | | | | Koziczak M, Holbro T, Hynes NE |
| | | | | Blocking of FGFR signaling inhibits breast cancer cell |
| | | | | proliferation through downregulation of D-type cyclins |
| | | | | ONCOGENE 23 (20): 3501-3508 APR 29 2004 |
| | | | | Uterine cervical cancer: |
| | | | | Kurban G, Ishiwata T, Kudo M, et al. |
| | | | | Expression of keratinocyte growth factor receptor |
| | | | | (KGFR/FGFR2 IIIb) in human uterine cervical cancer |
| | | | | ONCOLOGY REPORTS 11 (5): 987-991 MAY 2004 |
| | | | | Non-small cell lung cancer: |
| | | | | Beau-Faller M, Gaub MP, Schneider A, et al. |
| | | | | Allelic imbalance at loci containing FGFR, FGF, c-Met and |
| | | | | HGF candidate genes in non-small cell lung cancer sub- |
| | | | | types, implication for progression |
| | | | | EUROPEAN JOURNAL OF CANCER 39 (17): 2538-2547 |
| | | | | NOV 2003 |
| | | | | Gastric cancer: |
| | | | | Ferrin LJ, Lee HC |
| | | | | Structure of the fibroblast growth factor receptor 2 (FGFR2) |
| | | | | amplicon in a gastric cancer cell line. |
| | | | | GASTROENTEROLOGY 118 (4): 2818 Part 1 Suppl. 2 |
| | | | | APR 2000 |
| HER4/ | 422854 | −16.10 | Yes | Transitional cell carcinoma of the bladder: |
| ErbB4 | | | | Junttila TT, Laato M, Vahlberg T, et al. |
| | | | | Identification of patients with transitional cell carcinoma of |
| | | | | the bladder overexpressing ErbB2, ErbB3, or specific |
| | | | | ErbB4 isoforms: Real-time reverse transcription-PCR |
| | | | | analysis in estimation of ErbB receptor status from cancer |
| | | | | patients |
| | | | | CLINICAL CANCER RESEARCH 9 (14): 5346-5357 |
| | | | | NOV 1 2003 |
| | | | | Alzheimer's disease: |
| | | | | Chaudhury AR, Gerecke KM, Wyss JM, et al. |
| | | | | Neuregulin-1 and ErbB4 immunoreactivity is associated |
| | | | | with neuritic plaques in Alzheimer disease brain and in a |
| | | | | transgenic model of Alzheimer disease |
| | | | | JOURNAL OF NEUROPATHOLOGY AND |
| | | | | EXPERIMENTAL NEUROLOGY 62 (1): 42-54 JAN 2003 |
| | | | | Anti-glomerular basement membrane disease: |
| | | | | Levidiotis V, Khong TF, Katerelos M, et al. |
| | | | | Increased expression of HB-EGF and its receptor |
| | | | | erbB4/HER4 in accelerated anti-GBM disease |
| | | | | NEPHROLOGY 7 (5): 233-238 OCT 2002 |
| | | | | Breast cancer: |
| | | | | Sartor CI, Zhou H, Kozlowska E, et al. |
| | | | | HER4 mediates ligand-dependent antiproliferative and |
| | | | | differentiation responses in human breast cancer cells |
| | | | | MOLECULAR AND CELLULAR BIOLOGY 21 (13): |
| | | | | 4265-4275 JUL 2001 |
| | | | | Non-melanoma skin cancer: |
| | | | | Krahn G, Leiter U, Kaskel P, et al. |
| | | | | Coexpression patterns of EGFR, HER2, HER3 and HER4 |
| | | | | in non-melanoma skin cancer |
| | | | | EUROPEAN JOURNAL OF CANCER 37 (2): 251-259 |
| | | | | JAN 2001 |
| FYN | 6978863 | −15.96 | Yes | Alzheimer's disease: |
| | | | | Lee G, Thangavel R, Sharma VM, et al. |
| | | | | Phosphorylation of tau by fyn: Implications for Alzheimer's |
| | | | | disease |
| | | | | JOURNAL OF NEUROSCIENCE 24 (9): 2304-2312 MAR |
| | | | | 3 2004 |
| | | | | Oral cancer: |
| | | | | Li XW, Yang YJ, Hu YM, et al. |
| | | | | alpha(nu)beta(6)-Fyn signaling promotes oral cancer |
| | | | | progression |
| | | | | JOURNAL OF BIOLOGICAL CHEMISTRY 278 (43): |
| | | | | 41646-41653 OCT 24 2003: |
| | | | | Fibrosarcoma: |
| | | | | TAKAYAMA T, MOGI Y, KOGAWA K, et al. |
| | | | | A ROLE FOR THE FYN ONCOGENE IN METASTASIS |
| | | | | OF METHYLCHOLANTHRENE-INDUCED |
| | | | | FIBROSARCOMA-A CELLS |
| | | | | INTERNATIONAL JOURNAL OF CANCER 54 (5): 875-879 |
| | | | | JUL 9 1993 |
| FLT1 | 4503749 | −15.92 | Yes | Breast cancer: |
| | | | | Caine GJ, Lip GY, Blann AD |
| | | | | Platelet-derived VEGF, Fit-1, angiopoietin-1 and P-selectin |
| | | | | in breast and prostate cancer: further evidence for a role of |
| | | | | platelets in tumour angiogenesis |
| | | | | ANNALS OF MEDICINE 36 (4): 273-277 2004 |
| | | | | Prostate cancer: |
| | | | | Oyama N, Ponde DE, Higashikubo R, et al. |
| | | | | In vitro and in vivo assessment of 18F-FLT as a |
| | | | | proliferation marker in prostate cancer tumor model |
| | | | | JOURNAL OF UROLOGY 171 (4): 291-291 Suppl. S APR |
| | | | | 2004 |
| | | | | Diffuse large B cell lymphoma: |
| | | | | Aref S, Mabed M, Zalata K, et al. |
| | | | | The interplay between C-Myc oncogene expression and |
| | | | | circulating vascular endothelial growth factor (sVEGF), its |
| | | | | antagonist receptor, soluble Flt-1 in diffuse large B cell |
| | | | | lymphoma (DLBCL): Relationship to patient outcome (vol |
| | | | | 45, pg 499, 2004) |
| | | | | LEUKEMIA & LYMPHOMA 45 (6): 1311-1311 JUN 2004 |
| SYK | 2136036 | −15.89 | Yes | Breast cancer: |
| | | | | Zhang XY, Shrikande U, Zhou Q, et al. |
| | | | | Localization of Syk in breast cancer cells and a role for the |
| | | | | tyrosine kinase in cell-cell adhesion |
| | | | | FASEB JOURNAL 18 (8): C107-C107 Suppl. S MAY 14 |
| | | | | 2004 |
| FGFR4 | 120051 | −15.71 | Yes | Breast cancer: |
| | | | | Jezequel P, Campion L, Joalland MP, et al. |
| | | | | G388R mutation of the FGFR4 gene is not relevant to breast |
| | | | | cancer prognosis |
| | | | | BRITISH JOURNAL OF CANCER 90 (1): 189-193 JAN 1 |
| | | | | 2004 |
| FAK | 3183518 | −15.70 | Yes | Ovarian cancer: |
| | | | | Sood AK, Coffin JE, Schneider GB, et al. |
| | | | | Role of FAK in ovarian cancer invasion and migration. |
| | | | | JOURNAL OF THE SOCIETY FOR GYNECOLOGIC |
| | | | | INVESTIGATION 11 (2): 181A-181A 323 Suppl. S FEB |
| | | | | 2004 |
| | | | | Pancreatic cancer: |
| | | | | Ito H, Gardner-Thorpe J, Duxbury MS, et al. |
| | | | | Focal adhesion kinase (FAK) gene silencing reduces |
| | | | | pancreatic cancer MMP activity and invasiveness. |
| | | | | JOURNAL OF THE AMERICAN COLLEGE OF |
| | | | | SURGEONS 197 (3): S76-S76 Suppl. S SEP 2003 |
| | | | | Colon cancer: |
| | | | | Walsh MF, Thamilselvan V, Grotelueschen R, et al. |
| | | | | Absence of adhesion triggers differential FAK and |
| | | | | SAPKp38 signals in SW620 human colon cancer cells that |
| | | | | may inhibit adhesiveness and lead to cell death |
| | | | | CELLULAR PHYSIOLOGY AND BIOCHEMISTRY 13 |
| | | | | (3): 135-146 2003 |
| FLT4 | 388522 | −15.63 | Yes | Thyroid disease: |
| | | | | Karamysheva A, Shushanov S, Bronstein M, et al. |
| | | | | Vascular endothelial growth factor c (VEGFc) and its |
| | | | | receptor FLT4 expression in human thyroid pathology. |
| | | | | JOURNAL OF INVESTIGATIVE MEDICINE 47 (4): |
| | | | | 195A-195A Suppl. S APR 1999 |

It is understood that each of the diseases listed in Table 10 is a disease for which imatinib and its derivatives can be used to treat. Thus, subjects having these diseases would be candidates for treatment with imatinib and its derivatives or purvalanol or SB 203580 or their derivatives depending on which receptor is target by which drug. Methods of treatment comprising administering imiatinib or a derivative to treat these diseases alone or in combination with other treatments for these diseases, such as radiation, surgical, or other chemotherapy protocols are also disclosed.

C. Computer Systems and Methods

1. Systems

It is understood that the methods disclosed herein are useful with computer systems for implementing the steps described herein. For example, disclosed herein is a computer system having a memory means, a processing means, a data input means, and a visual display means, the memory means containing sequence information for a known target capable of interacting with a molecule, such as a drug, and modules containing information to be compared with the sequence information of the known target, and the processing means being operable to compute molecule-potential target binding energy using the methods of identifying a target disclosed herein, and display the structures of molecules based on input atomic structure information with a visual display means.

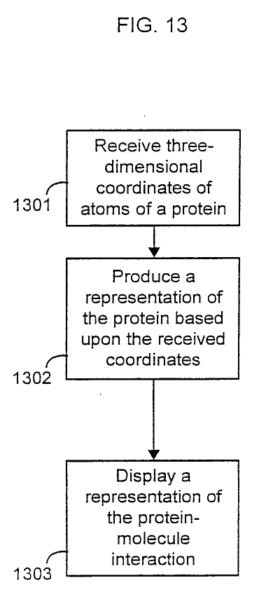

Also disclosed herein, and illustrated in FIG. 13, are methods of displaying a representation of a potential target-molecule interaction on a computer having a processing means, a memory means, a visual display means, an input means and an output means comprising: receiving the three-dimensional coordinates of atoms of the potential target (1301); producing a representation of the potential target based upon the received coordinates (1302); and displaying the representation of the potential target-molecule interaction on the visual display means, wherein the potential target in the potential target-molecule interaction comprises a potential target which is a homologue of the known target of the molecule (1303).

Also disclosed herein is an apparatus comprising: (a) a system data store capable of storing coordinate sets; and (b) a system processor in communication with the system data store that carries out the following steps: (i) modeling a molecule in complex with a known target for the molecule, (ii) obtaining potential target molecules by selecting potential target molecules with a defined homology to the known target, and (iii) determining the binding affinity of a potential target with the molecule by modeling the potential target with the molecule, wherein a Monte Carlo function is used for sampling of side chain rotamers.

It is also understood that the proteins disclosed herein can be represented as a sequence consisting of the nucleotides of amino acids, or as the amino acids themselves. There are a variety of ways to display these sequences, for example the nucleotide guanosine can be represented by G or g. Likewise the amino acid valine can be represented by Val or V. Those of skill in the art understand how to display and express any nucleic acid or protein sequence in any of the variety of ways that exist, each of which is considered herein disclosed. Specifically contemplated herein is the display of these sequences on computer readable mediums, such as, commercially available floppy disks, tapes, chips, hard drives, compact disks, and video disks, or other computer readable mediums. Also disclosed are the binary code representations of the disclosed sequences. Those of skill in the art understand what is meant by computer readable media. Thus, computer readable mediums on which the nucleic acids or protein sequences are recorded, stored, or saved.

a) Machine Readable Storage Media

Disclosed are machine-readable storage mediums, also referred to as computer readable media, comprising a data storage material encoded with machine readable data. Furthermore, the data can be extracted and manipulated by machines configured to read the data stored on the machine readable storage media, and in fact, when performing the molecular modeling, such as displaying a configuration of the disclosed compositions, as discussed herein, typically the data will be retrieved or stored on a machine readable storage media.

Disclosed are machine readable storage media comprising the coordinates set forth herein or obtained or coordinates producing equivalent configurations of the disclosed compositions or their variants as discussed herein.

For example, a system for reading a data storage medium may include a computer comprising a central processing unit (“CPU”), a working memory which may be, e.g., RAM (random access memory) or “core” memory, mass storage memory (such as one or more disk drives or CD-ROM drives), one or more display devices (e.g., cathode-ray tube (“CRT”) displays, light emitting diode (“LED”) displays, liquid crystal displays (“LCDs”), electroluminescent displays, vacuum fluorescent displays, field emission displays (“FEDs”), plasma displays, projection panels, etc.), one or more user input devices (e.g., keyboards, microphones, mice, touch screens, etc.), one or more input lines, and one or more output lines, all of which are interconnected by a conventional bidirectional system bus. The system may be a stand-alone computer, or may be networked (e.g., through local area networks, wide area networks, intranets, extranets, or the internet) to other systems (e.g., computers, hosts, servers, etc.). The system may also include additional computer controlled devices such as consumer electronics and appliances. Input hardware may be coupled to the computer by input lines and may be implemented in a variety of ways. Machine-readable data of this invention may be inputted via the use of a modem or modems connected by a telephone line or dedicated data line. Alternatively or additionally, the input hardware may comprise CD-ROM drives or disk drives. In conjunction with a display terminal, a keyboard may also be used as an input device. Output hardware may be coupled to the computer by output lines and may similarly be implemented by conventional devices. By way of example, the output hardware may include a display device for displaying a graphical representation of a binding pocket of this invention using a program such as QUANTA as described herein. Output hardware might also include a printer, so that hard copy output may be produced, or a disk drive, to store system output for later use.

In operation, a CPU coordinates the use of the various input and output devices, coordinates data accesses from mass storage devices, accesses to and from working memory, and determines the sequence of data processing steps. A number of programs may be used to process the machine-readable data of this invention. Such programs are discussed in reference to the computational methods of drug discovery as described herein. References to components of the hardware system are included as appropriate throughout the following description of the data storage medium.

Machine-readable storage devices useful in the present invention include, but are not limited to, magnetic devices, electrical devices, optical devices, and combinations thereof. Examples of such data storage devices include, but are not limited to, hard disk devices, CD devices, digital video disk devices, floppy disk devices, removable hard disk devices, magneto-optic disk devices, magnetic tape devices, flash memory devices, bubble memory devices, holographic storage devices, and any other mass storage peripheral device. It should be understood that these storage devices include necessary hardware (e.g., drives, controllers, power supplies, etc.) as well as any necessary media (e.g., disks, flash cards, etc.) to enable the storage of data.

2. Structures

The disclosed methods can be performed on computers and molecular structures are displayed and created.

Also disclosed are scalable three dimensional configurations of points derived from structure coordinates of at least a portion of the molecules used herein. In one embodiment, the scalable three dimensional set of points is derived from structure coordinates of a model.

Also disclosed are scalable three dimensional set of points derived from structure coordinates of at least a portion of a molecule or a molecular complex that is structurally homologous to a disclosed composition.

Also disclosed are molecules or molecular complexes and their cognate coordinates that are structurally homologous to a disclosed composition.

Also disclosed are methods involving molecular replacement, substitution, deletion, or alteration to obtain structural information about a molecule or molecular complex of unknown structure, but which is related to the disclosed structures, through for example, amino acid identity. The methods include producing a solution of the molecule or molecular complex, generating a solution structure aided by the information disclosed herein, and applying at least a portion of the structure coordinates obtained to the data related to the molecule or molecule complex to generate a three-dimensional structure of at least a portion of the molecule or molecular complex.

Also disclosed are methods for homology modeling.

Each of the constituent amino acids of a protein can be defined by a set of structure coordinates. The term “structure coordinates” refers to a Cartesian set of coordinates.

Disclosed are representation of variations in structure coordinates which can be generated by mathematically manipulating the disclosed structure coordinates. For example, the structure coordinates obtained for a given protein could be manipulated by permutations of the structure coordinates, fractionalization of the structure coordinates, integer additions or subtractions to sets of the structure coordinates, inversion of the structure coordinates, rotation of the structure coordinates about an arbitrary axis, or any combination of the above. Alternatively, modifications in the crystal structure due to mutations, additions, substitutions, and/or deletions of amino acids, or other changes in any of the components that make up the composition from which the coordinates were produced, could also yield variations in structure coordinates. Such variations in the individual coordinates will have little effect on the global shape. Furthermore, when variations are made in a concentrated region of the composition or in the structural representation of the composition, the effect on other structural regions of the molecule typically is minimal. One way of judging the effect the variations in one part of the composition or structure have on another part of the composition or structure is to compare the cognate regions to the disclosed structures standard error and judge whether the differences are in an acceptable range, for example, within the same error range for that region in the original structure. If the error is within the disclosed error ranges, the structures or compared regions of the structure can be said to be equivalent. The alterations and modifications discussed herein, in connection with the discussion of protein modifications and discussed herein indicate that modifications which will not alter, for example the properties of the disclosed compositions, such as binding between a molecule and a target, can be made and are disclosed.

a) Coordinates

Structure coordinates define a unique configuration of points in space. Those of skill in the art understand that a set of structure coordinates for protein or an protein/ligand complex, or a portion thereof, define a relative set of points that, in turn, define a configuration in three dimensions. A key piece of information obtained from the coordinates is the position of the atoms that make up the composition. The position of the atoms is defined in a Cartesian form, such that there are x-y-z positions which allow for a determination of distances and angles between two or more atoms. Thus, a similar or identical configuration, i.e. structure, can be defined by an entirely different set of coordinates, provided the distances and angles between coordinates remain essentially the same. By manipulating the distances and angles in a like manner a scalable representation can be obtained.

Disclosed are scalable three-dimensional configurations derived from structure coordinates obtained for the proteins and molecules discussed herein, or portion thereof, or from coordinates producing a configuration with essentially the same angles and distances between the atoms. Also disclosed are scalable three-dimensional configurations derived from the structure coordinates obtained from the protein structure database, such as the RCSB protein databank found at http://www.rcsb.org/pdb, and the NCBI structure database found at http://www.ncbi.nlm.nih.gov/Structure/. It is understood that in certain situations, the structures and information needed to produce these structures disclosed in these databases are incorporated by reference for material related to the structures of proteins and protein complexes for the coordinate material. In certain situations this incorporation is only for the material present in these databases as of the time of filing of this application.

Also disclosed are scalable three-dimensional configurations of points derived from structure coordinates of molecules or molecular complexes that are structurally homologous to the disclosed proteins, as well as structurally equivalent configurations.

The configurations of points in space derived from structure coordinates according to the invention can be visualized as, for example, a holographic image, a stereodiagram, a model or a computer-displayed image, and the invention thus includes such images, diagrams or models.

Comparisons between different structures, different conformations of the same structure, and different parts of the same structure can be performed in a variety of ways. For example, typically the structures (coordinates making up the structure) are loaded, the atom equivalences in these structures are defined; the structures are fit, and then the resulting comparisons are reviewed.

Modeling programs typically also allow for a determination of the variances, the root mean square deviations, and statistical significance of the various structures.

The term “root mean square deviation” means the square root of the arithmetic mean of the squares of the deviations. This allows for comparison of two sets of data for example or the cognate position in two configurations or structures.

3. Modeling and Modeling of Variants

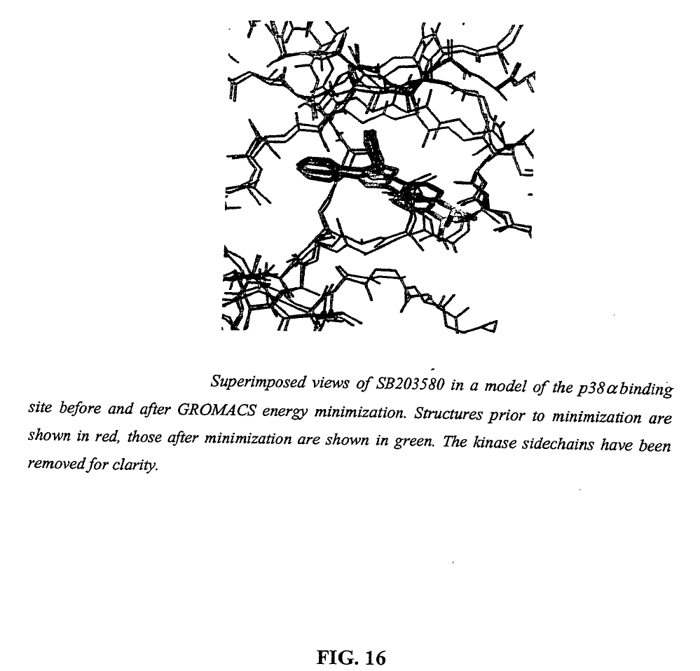

Computational techniques can be used to screen, identify, select and design chemical entities capable of associating with the identified targets or molecules or structurally homologous targets or molecules. The disclosed coordinates and those that produce similar homologous structures, i.e. having RMS deviations of less than or equal to 5, 4, 3, 2, or 1 angstroms can be used to model potential molecule-target interactions. Atoms of the potential ligand can be included in modeling simulation involving the known target or identified target and or molecule complex as disclosed herein, and the contacts that arise between the potential ligand in a variety of positions with the targets or with a region, such as the molecule binding site, can be investigated. Energy minimization of these contacts between the potential ligand and the molecule can indicate potential ligands having, for example a desired affinity or a desired specificity. FIG. 16 shows superimposed views of SB203580 in a model of the p38 ^{α} binding site before and after GROMACS energy minimization. Structures prior to minimization are shown in red, those after minimization are shown in green. The kinase sidechains have been removed for clarity. The ligands identified as having a desired number of contacts, with atoms of the target as positioned by the coordinates or homologs disclosed herein, can be chosen and then optionally further tested by synthesizing or making the ligand and target and performing standard biochemistry to assay binding activity or functional activity, such as those that use kinetic or thermodynamic methodology, such as, equilibrium dialysis, microcalorimetry, circular dichroism, capillary zone electrophoresis, nuclear magnetic resonance spectroscopy, fluorescence spectroscopy, and combinations thereof.

Drug designing typically involves computer-assisted design of chemical entities that associate with a target, its homologs, or portions thereof. Chemical entities can be designed in a step-wise fashion, one fragment at a time, or may be designed as a whole or “de novo.”

The binding sites of targets and molecules as disclosed herein set forth the position of target atoms for interaction with ligands which will be able to bind or inhibit the interaction. The conformation of the binding site allows for a precise three dimensional map for rationally designing molecules that will form, for example, a set number of contacts with the atoms defining the binding regions as disclosed herein.

A contact as used herein means any position between two atoms, typically one atom of a molecule, such as a ligand, and one atom of the target, such as a receptor, that when position by an energy minimization program, for example, are less than 5A°, 4A°, 3A°, 2A°, or 1A° apart. Thus, a contact can for example, correlate with, for example, non-covalent interactions, such as a hydrogen bonds, Vander Walls interactions, hydrophobic interactions, and electrostatic interactions, between two atoms. Typically a contact will add to the binding energy between two atoms, but it can also be repulsive, typically more repulsive the closer the two atoms become. It is understood that for a ligand to be a potential therapeutic candidate, it must have an appropriate level or quality of contacts, such that an interaction occurs, but that it should not cause steric and energetic problems. Conformational considerations include the overall three-dimensional structure and orientation of the chemical entity in relation to the binding pocket, and the spacing between various functional groups of an entity that directly interact with the binding pocket or homologs thereof.

The modeling and display of the disclosed compositions can be accomplished using any modeling program, such as QUANTA, SYBYL, Insight II/Discover (Molecular Simulations, Inc., San Diego, Calif. 92121). These programs may be implemented, for example, using a Silicon Graphics workstation such as an Indigo² with “IMPACT” graphics. Other hardware systems and software packages will be known to those skilled in the art. Drug design programs, such as, GRID (P. J. Goodford, J. Med. Chem. 28:849-857 (1985); available from Oxford University, Oxford, UK); MCSS (A. Miranker et al., Proteins: Struct. Funct. Gen., 11:29-34 (1991); available from Molecular Simulations, San Diego, Calif.); AUTODOCK (D. S. Goodsell et al., Proteins: Struct. Funct. Genet. 8:195-202 (1990); available from Scripps Research Institute, La Jolla, Calif.); and DOCK (I. D. Kuntz et al., J. Mol. Biol. 161:269-288 (1982); available from University of California, San Francisco, Calif.), LUDI (H.-J. Bohm, J. Comp. Aid. Molec. Design. 6:61-78 (1992); available from Molecular Simulations Inc., San Diego, Calif.); LEGEND (Y. Nishibata et al., Tetrahedron, 47:8985 (1991); available from Molecular Simulations Inc., San Diego, Calif.); LeapFrog (available from Tripos Associates, St. Louis, Mo.); and SPROUT (V. Gillet et al., J. Comput. Aided Mol. Design 7:127-153 (1993); available from the University of Leeds, UK), can also be used.

The efficiency of a potential ligand's interaction with a target can be evaluated and optimized. For example, typically a preferred ligand will cause little perturbation to the three dimensional positioning of the atoms of target that are in the vicinity of the interaction or are somehow allosterically affected. The level of perturbation can be determined by comparing the energy state of the structural conformation for the bound and unbound states. Typically the smaller the change the less perturbation and the less perturbation the higher the likelihood that the ligand will be desirable as for example, a competitive inhibitor. This perturbation energy can be, for example, less than or equal to about 30 kcal/mole, 20 kcal/mole, 15 kcal/mole, 10 kcal/mole, 8 kcal/mole, 6 kcal/mole, 5 kcal/mole, 4 kcal/mole, 3 kcal/mole, 2 kcal/mole, or 1 kcal.mole. Ligands may interact with the target molecule in more than one conformation that is similar in overall binding energy. In those cases, the perturbation energy of binding can be taken as the difference between the energy of the free entity and the average energy of the conformations observed when the ligand binds to the target molecule.

An entity designed or selected as binding to a target may be further computationally optimized so that in its bound state it would preferably lack repulsive electrostatic interaction with the target enzyme and with the surrounding water molecules. Such non-complementary electrostatic interactions include repulsive charge-charge, dipole-dipole, and charge-dipole interactions.

Specific computer software is available in the art to evaluate compound deformation energy and electrostatic interactions. Examples of programs designed for such uses include: Gaussian 94, revision C (M. J. Frisch, Gaussian, Inc., Pittsburgh, Pa. 15106); AMBER, version 4.1 (P. A. Kollman, University of California at San Francisco, 94143); QUANTA/CHARMM (Molecular Simulations, Inc., San Diego, Calif. 92121);

The disclosed structures and coordinates can also be used to screen potential ligands, for example, as drug candidates, which interact with, i.e. form contacts with, the identified target. Small molecule databases, such as structure databases can be used for this. Not only whole molecules can be screened, but subparts of molecule, for example, various functional groups can also be screen to find preferred functional groups for forming contacts with the identified target structures disclosed herein. Functional groups that make a desired set of contacts, for example, with a desired or particular region of the target molecule, can then be used to further build combinations of these and other types of functional groups to design ligands containing the functional groups or combinations of functional groups.

It is understood that also disclosed are iterative approaches which use successive performance of the various steps disclosed herein to optimize molecules and/or isolate molecules from sets of molecules. This can also be done with multiple coordinate sets that have been obtained, for example, from the solution of structures involving a ligand or series of structures involving a series of ligands. For example, molecules known to have preferred biochemical properties can be solved in a co-structure, and then the structure information obtained from this can be used to select potential ligands for function.

A compound that is identified or designed as a result of any of these methods disclosed herein can be obtained (or synthesized) and tested for its biological activity, e.g., inhibition of target activity or enhancement of target activity.

Structures of variant molecules or proteins can be produced without obtaining individual coordinates for the variant. In essence the coordinates of the molecule or protein, disclosed herein or coordinates that produce a similar structure are used as a starting point and the variant atom or atoms of the variant molecule or protein are substituted into the simulated structure and their relative position to the original unchanging atoms, i.e. coordinates, are determined through any of a variety of energy minimization functions. Thus, sequence alignment, secondary structure prediction, the screening of structural libraries of the disclosed molecules and proteins produced from the disclosed coordinates, or any combination of these can be used to overlay the variant structure. For example, the variant atom or atoms can also be modeled from any structural library having coordinates of similar or identical atoms. Thus, the initial structure to undergo energy minimization can be arrived at by modeling known coordinates for a given for the given atom or atoms. These libraries of structures can be screened for the optimal structure. A side chain rotomer library can be used to model a given side chain or set of side chains. After initial energy minimization iterative or new energy minimizations may be necessary if the structure produced after energy minimization violates a physical constraint, such as correct stereochemistry.

D. Compositions

Disclosed herein are compositions to be used with the methods disclosed herein, such as proteins and nucleic acids encoding the proteins, as well as molecules such as drugs. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular known target is disclosed and discussed and a number of modifications that can be made to a number of molecules including the amino acids are discussed, specifically contemplated is each and every combination and permutation of amino acids, and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

1. Homology/Identity

It is understood that one way to define any known variants and derivatives of the target, or those that might arise, to be used with the methods disclosed herein, is through defining the variants and derivatives in terms of homology to specific known sequences. For example a known target such as a protein has a particular sequence, and there is a particular nucleic acid corresponding to that particular sequence. Those of skill in the art readily understand how to determine the homology of two or more proteins or nucleic acids, such as genes. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. Mol. Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment.

2. Sequence similarities

It is understood that as discussed herein the use of the terms homology and identity mean the same thing as similarity. Thus, for example, if the use of the word homology is used between two non-natural sequences it is understood that this is not necessarily indicating an evolutionary relationship between these two sequences, but rather is looking at the similarity or relatedness between their nucleic acid sequences. Many of the methods for determining homology between two evolutionarily related molecules are routinely applied to any two or more nucleic acids or proteins for the purpose of measuring sequence similarity regardless of whether they are evolutionarily related or not.

In general, it is understood that one way to define any known variants and derivatives or those that might arise, of the disclosed genes and proteins herein, is through defining the variants and derivatives in terms of homology to specific known sequences. This identity of particular sequences disclosed herein is also discussed elsewhere herein. In general, variants of genes and proteins herein disclosed typically have at least, about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 percent homology to the stated sequence or the native sequence. Those of skill in the art readily understand how to determine the homology of two proteins or nucleic acids, such as genes. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. Mol. Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

For example, as used herein, a sequence recited as having a particular percent homology to another sequence refers to sequences that have the recited homology as calculated by any one or more of the calculation methods described above. For example, a first sequence has 80 percent homology, as defined herein, to a second sequence if the first sequence is calculated to have 80 percent homology to the second sequence using the Zuker calculation method even if the first sequence does not have 80 percent homology to the second sequence as calculated by any of the other calculation methods. As another example, a first sequence has 80 percent homology, as defined herein, to a second sequence if the first sequence is calculated to have 80 percent homology to the second sequence using both the Zuker calculation method and the Pearson and Lipman calculation method even if the first sequence does not have 80 percent homology to the second sequence as calculated by the Smith and Waterman calculation method, the Needleman and Wunsch calculation method, the Jaeger calculation methods, or any of the other calculation methods. As yet another example, a first sequence has 80 percent homology, as defined herein, to a second sequence if the first sequence is calculated to have 80 percent homology to the second sequence using each of calculation methods (although, in practice, the different calculation methods will often result in different calculated homology percentages).

a) Sequences

There are a variety of sequences related to, for example, the kinase receptors described herein, as well as any other protein disclosed herein that are disclosed on Genbank, and these sequences and others are herein incorporated by reference in their entireties as well as for individual subsequences contained therein.

A variety of sequences are provided herein and these and others can be found in Genbank, at www.pubmed.gov. Those of skill in the art understand how to resolve sequence discrepancies and differences and to adjust the compositions and methods relating to a particular sequence to other related sequences. Primers and/or probes can be designed for any sequence given the information disclosed herein and known in the art.

3. Peptides

a) Protein Variants

As discussed herein there are numerous variants of a known target, or a potential target (such as a protein), that are known and herein contemplated. Also disclosed are specific receptors whose sequences are known in the art. In addition to the known functional variants there are derivatives of the proteins which also function in the disclosed methods and compositions. Protein variants and derivatives are well understood to those of skill in the art and can involve amino acid sequence modifications. For example, amino acid sequence modifications typically fall into one or more of three classes: substitutional, insertional or deletional variants. Insertions include amino and/or carboxyl terminal fusions as well as intrasequence insertions of single or multiple amino acid residues. Insertions ordinarily will be smaller insertions than those of amino or carboxyl terminal fusions, for example, on the order of one to four residues. Immunogenic fusion protein derivatives, such as those described in the examples, are made by fusing a polypeptide sufficiently large to confer immunogenicity to the target sequence by cross-linking in vitro or by recombinant cell culture transformed with DNA encoding the fusion. Deletions are characterized by the removal of one or more amino acid residues from the protein sequence. Typically, no more than about from 2 to 6 residues are deleted at any one site within the protein molecule. These variants ordinarily are prepared by site specific mutagenesis of nucleotides in the DNA encoding the protein, thereby producing DNA encoding the variant, and thereafter expressing the DNA in recombinant cell culture. Techniques for making substitution mutations at predetermined sites in DNA having a known sequence are well known, for example M13 primer mutagenesis and PCR mutagenesis. Amino acid substitutions are typically of single residues, but can occur at a number of different locations at once; insertions usually will be on the order of about from 1 to 10 amino acid residues; and deletions will range about from 1 to 30 residues. Deletions or insertions preferably are made in adjacent pairs, i.e. a deletion of 2 residues or insertion of 2 residues. Substitutions, deletions, insertions or any combination thereof may be combined to arrive at a final construct. The mutations must not place the sequence out of reading frame and preferably will not create complementary regions that could produce secondary mRNA structure. Substitutional variants are those in which at least one residue has been removed and a different residue inserted in its place. Such substitutions generally are made in accordance with the following Tables 1 and 2 and are referred to as conservative substitutions.

TABLE 1
Amino Acid Abbreviations

| Amino Acid | Abbreviations |
|---|---|
| alanine | AlaA |
| allosoleucine | AIle |
| arginine | ArgR |
| asparagine | AsnN |
| aspartic acid | AspD |
| cysteine | CysC |
| glutamic acid | GluE |
| glutamine | GlnK |
| glycine | GlyG |
| histidine | HisH |
| isolelucine | IleI |
| leucine | LeuL |
| lysine | LysK |
| phenylalanine | PheF |
| proline | ProP |
| pyroglutamic acidp | Glu |
| serine | SerS |
| threonine | ThrT |
| tyrosine | TyrY |
| tryptophan | TrpW |
| valine | ValV |

TABLE 2
Amino Acid Substitutions
Original Residue Exemplary Conservative Substitutions, others
are known in the art.

| | |
|---|---|
| Ala | ser |
| Arg | lys, gln |
| Asn | gln; his |
| Asp | glu |
| Cys | ser |
| Gln | asn, lys |
| Glu | asp |
| Gly | pro |
| His | asn; gln |
| Ile | leu; val |
| Leu | ile; val |
| Lys | arg; gln; |
| Met | Leu; ile |
| Phe | met; leu; tyr |
| Ser | thr |
| Thr | ser |
| Trp | tyr |
| Tyr | trp; phe |
| Val | ile; leu |

Substantial changes in function or immunological identity are made by selecting substitutions that are less conservative than those in Table 2, i.e., selecting residues that differ more significantly in their effect on maintaining (a) the structure of the polypeptide backbone in the area of the substitution, for example as a sheet or helical conformation, (b) the charge or hydrophobicity of the molecule at the target site or (c) the bulk of the side chain. The substitutions which in general are expected to produce the greatest changes in the protein properties will be those in which (a) a hydrophilic residue, e.g. seryl or threonyl, is substituted for (or by) a hydrophobic residue, e.g. leucyl, isoleucyl, phenylalanyl, valyl or alanyl; (b) a cysteine or proline is substituted for (or by) any other residue; (c) a residue having an electropositive side chain, e.g., lysyl, arginyl, or histidyl, is substituted for (or by) an electronegative residue, e.g., glutamyl or aspartyl; or (d) a residue having a bulky side chain, e.g., phenylalanine, is substituted for (or by) one not having a side chain, e.g., glycine, in this case, (e) by increasing the number of sites for sulfation and/or glycosylation.

For example, the replacement of one amino acid residue with another that is biologically and/or chemically similar is known to those skilled in the art as a conservative substitution. For example, a conservative substitution would be replacing one hydrophobic residue for another, or one polar residue for another. The substitutions include combinations such as, for example, Gly, Ala; Val, Ile, Leu; Asp, Glu; Asn, Gln; Ser, Thr; Lys, Arg; and Phe, Tyr. Such conservatively substituted variations of each explicitly disclosed sequence are included within the mosaic polypeptides provided herein.

Substitutional or deletional mutagenesis can be employed to insert sites for N-glycosylation (Asn-X-Thr/Ser) or O-glycosylation (Ser or Thr). Deletions of cysteine or other labile residues also may be desirable. Deletions or substitutions of potential proteolysis sites, e.g. Arg, is accomplished for example by deleting one of the basic residues or substituting one by glutaminyl or histidyl residues.

Certain post-translational derivatizations are the result of the action of recombinant host cells on the expressed polypeptide. Glutaminyl and asparaginyl residues are frequently post-translationally deamidated to the corresponding glutamyl and asparyl residues. Alternatively, these residues are deamidated under mildly acidic conditions. Other post-translational modifications include hydroxylation of proline and lysine, phosphorylation of hydroxyl groups of seryl or threonyl residues, methylation of the o-amino groups of lysine, arginine, and histidine side chains (T. E. Creighton, Proteins: Structure and Molecular Properties, W.H. Freeman & Co., San Francisco pp 79-86 [1983]), acetylation of the N-terminal amine and, in some instances, amidation of the C-terminal carboxyl.

It is understood that one way to define the variants and derivatives of the disclosed proteins herein is through defining the variants and derivatives in terms of homology/identity to specific known sequences. Specifically disclosed are variants of both the target molecules and known targets herein disclosed which have at least, 30%, 40%, 50% or 60% or 70% or 75% or 80% or 85% or 90% or 95% homology to the stated sequence. Those of skill in the art readily understand how to determine the homology of two proteins. For example, the homology can be calculated after aligning the two sequences so that the homology is at its highest level.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment.

It is understood that the description of conservative mutations and homology can be combined together in any combination, such as embodiments that have at least 70% homology to a particular sequence wherein the variants are conservative mutations.

It is understood that there are numerous amino acid and peptide analogs which can be incorporated into the disclosed compositions. For example, there are numerous D amino acids or amino acids which have a different functional substituent then the amino acids shown in Table 1 and Table 2. The opposite stereo isomers of naturally occurring peptides are disclosed, as well as the stereo isomers of peptide analogs. These amino acids can readily be incorporated into polypeptide chains by charging tRNA molecules with the amino acid of choice and engineering genetic constructs that utilize, for example, amber codons, to insert the analog amino acid into a peptide chain in a site specific way (Thorson et al., Methods in Molec. Biol. 77:43-73 (1991), Zoller, Current Opinion in Biotechnology, 3:348-354 (1992); Ibba, Biotechnology & Genetic Enginerring Reviews 13:197-216 (1995), Cahill et al., TIBS, 14(10):400-403 (1989); Benner, TIB Tech, 12:158-163 (1994); Ibba and Hennecke, Bio/technology, 12:678-682 (1994) all of which are herein incorporated by reference at least for material related to amino acid analogs).

Molecules can be produced that resemble peptides, but which are not connected via a natural peptide linkage. For example, linkages for amino acids or amino acid analogs can include CH₂NH—, —CH₂S—, —CH₂—CH₂—, —CH═CH— (cis and trans), —COCH₂—, —CH(OH)CH₂—, and —CHH₂SO-(These and others can be found in Spatola, A. F. in Chemistry and Biochemistry of Amino Acids, Peptides, and Proteins, B. Weinstein, eds., Marcel Dekker, New York, p. 267 (1983); Spatola, A. F., Vega Data (March 1983), Vol. 1, Issue 3, Peptide Backbone Modifications (general review); Morley, Trends Pharm Sci (1980) pp. 463-468; Hudson, D. et al., Int J Pept Prot Res 14:177-185 (1979) (—CH₂NH—, CH₂CH₂—); Spatola et al. Life Sci 38:1243-1249 (1986) (—CH H₂—S); Hann J. Chem. Soc Perkin Trans. I 307-314 (1982) (—CH—CH—, cis and trans); Almquist et al. J. Med. Chem. 23:1392-1398 (1980) (—COCH₂—); Jennings-White et al. Tetrahedron Lett 23:2533 (1982) (—COCH₂—); Szelke et al. European Appln, EP 45665 CA (1982): 97:39405 (1982) (—CH(OH)CH₂—); Holladay et al. Tetrahedron. Lett 24:4401-4404 (1983) (—C(OH)CH₂—); and Hruby Life Sci 31:189-199 (1982) (—CH₂—S—); each of which is incorporated herein by reference. A particularly preferred non-peptide linkage is —CH₂NH—. It is understood that peptide analogs can have more than one atom between the bond atoms, such as b-alanine, g-aminobutyric acid, and the like.

Amino acid analogs and analogs and peptide analogs often have enhanced or desirable properties, such as, more economical production, greater chemical stability, enhanced pharmacological properties (half-life, absorption, potency, efficacy, etc.), altered specificity (e.g., a broad-spectrum of biological activities), reduced antigenicity, and others.

D-amino acids can be used to generate more stable peptides, because D amino acids are not recognized by peptidases and such. Systematic substitution of one or more amino acids of a consensus sequence with a D-amino acid of the same type (e.g., D-lysine in place of L-lysine) can be used to generate more stable peptides. Cysteine residues can be used to cyclize or attach two or more peptides together. This can be beneficial to constrain peptides into particular conformations. (Rizo and Gierasch Ann. Rev. Biochem. 61:387 (1992), incorporated herein by reference).

b) Pharmaceutically Acceptable Carriers

Disclosed herein are methods for inhibiting a receptor comprising incubating the receptor with a drug. Examples of such drugs discussed herein are purvalanol, imatinib, and SB203580. These drugs can be administered to treat a variety of diseases and disorders.

Suitable carriers and their formulations of the drugs disclosed herein are described in Remington: The Science and Practice of Pharmacy (19th ed.) ed. A. R. Gennaro, Mack Publishing Company, Easton, Pa. 1995. Typically, an appropriate amount of a pharmaceutically-acceptable salt is used in the formulation to render the formulation isotonic. Examples of the pharmaceutically-acceptable carrier include, but are not limited to, saline, Ringer's solution and dextrose solution. The pH of the solution is preferably from about 5 to about 8, and more preferably from about 7 to about 7.5. Further carriers include sustained release preparations such as semipermeable matrices of solid hydrophobic polymers containing the antibody, which matrices are in the form of shaped articles, e.g., films, liposomes or microparticles. It will be apparent to those persons skilled in the art that certain carriers may be more preferable depending upon, for instance, the route of administration and concentration of composition being administered.

Pharmaceutical carriers are known to those skilled in the art. These most typically would be standard carriers for administration of drugs to humans, including solutions such as sterile water, saline, and buffered solutions at physiological pH. The compositions can be administered intramuscularly or subcutaneously. Other compounds will be administered according to standard procedures used by those skilled in the art.

Pharmaceutical compositions may include carriers, thickeners, diluents, buffers, preservatives, surface active agents and the like in addition to the molecule of choice. Pharmaceutical compositions may also include one or more active ingredients such as antimicrobial agents, antiinflammatory agents, anesthetics, and the like.

The pharmaceutical composition may be administered in a number of ways depending on whether local or systemic treatment is desired, and on the area to be treated. Administration may be topically (including ophthalmically, vaginally, rectally, intranasally), orally, by inhalation, or parenterally, for example by intravenous drip, subcutaneous, intraperitoneal or intramuscular injection. The disclosed antibodies can be administered intravenously, intraperitoneally, intramuscularly, subcutaneously, intracavity, or transdermally.

Preparations for parenteral administration include sterile aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives may also be present such as, for example, antimicrobials, anti-oxidants, chelating agents, and inert gases and the like.

Formulations for topical administration may include ointments, lotions, creams, gels, drops, suppositories, sprays, liquids and powders. Conventional pharmaceutical carriers, aqueous, powder or oily bases, thickeners and the like may be necessary or desirable.

Compositions for oral administration include powders or granules, suspensions or solutions in water or non-aqueous media, capsules, sachets, or tablets. Thickeners, flavorings, diluents, emulsifiers, dispersing aids or binders may be desirable.

Some of the compositions may potentially be administered as a pharmaceutically acceptable acid- or base-addition salt, formed by reaction with inorganic acids such as hydrochloric acid, hydrobromic acid, perchloric acid, nitric acid, thiocyanic acid, sulfuric acid, and phosphoric acid, and organic acids such as formic acid, acetic acid, propionic acid, glycolic acid, lactic acid, pyruvic acid, oxalic acid, malonic acid, succinic acid, maleic acid, and fumaric acid, or by reaction with an inorganic base such as sodium hydroxide, ammonium hydroxide, potassium hydroxide, and organic bases such as mono-, di-, trialkyl and aryl amines and substituted ethanolamines.

c) Therapeutic Uses

Effective dosages and schedules for administering the compositions may be determined empirically, and making such determinations is within the skill in the art. The dosage ranges for the administration of the compositions are those large enough to produce the desired effect in which the symptoms disorder are effected. The dosage should not be so large as to cause adverse side effects, such as unwanted cross-reactions, anaphylactic reactions, and the like. Generally, the dosage will vary with the age, condition, sex and extent of the disease in the patient, route of administration, or whether other drugs are included in the regimen, and can be determined by one of skill in the art. The dosage can be adjusted by the individual physician in the event of any counterindications. Dosage can vary, and can be administered in one or more dose administrations daily, for one or several days. Guidance can be found in the literature for appropriate dosages for given classes of pharmaceutical products. For example, guidance in selecting appropriate doses for antibodies can be found in the literature on therapeutic uses of antibodies, e.g., Handbook of Monoclonal Antibodies, Ferrone et al., eds., Noges Publications, Park Ridge, N.J., (1985) ch. 22 and pp. 303-357; Smith et al., Antibodies in Human Diagnosis and Therapy, Haber et al., eds., Raven Press, New York (1977) pp. 365-389. A typical daily dosage of the antibody used alone might range from about 1 μg/kg to up to 100 mg/kg of body weight or more per day, depending on the factors mentioned above.

Following administration of a disclosed composition, such as an antibody, for treating, inhibiting, or preventing a disease, the efficacy of the therapeutic antibody can be assessed in various ways well known to the skilled practitioner. For instance, one of ordinary skill in the art will understand that a composition, such as an antibody, disclosed herein is efficacious in treating or inhibiting a disease or disorder in a subject.

Other molecules that interact with targets to inhibit various interactions which do not have a specific pharmaceutical function, but which may be used for tracking changes within cellular chromosomes or for the delivery of diagnositc tools for example can be delivered in ways similar to those described for the pharmaceutical products.

The disclosed compositions and methods can also be used for example as tools to isolate and test new drug candidates for a variety of diseases and conditions.

E. Methods of making the compositions

The compositions disclosed herein and the compositions necessary to perform the disclosed methods can be made using any method known to those of skill in the art for that particular reagent or compound unless otherwise specifically noted.

1. Peptide synthesis

One method of producing the molecules, such as proteins, disclosed herein is to link two or more peptides or polypeptides together by protein chemistry techniques. For example, peptides or polypeptides can be chemically synthesized using currently available laboratory equipment using either Fmoc (9-fluorenylmethyloxycarbonyl) or Boc (tert-butyloxycarbonoyl) chemistry. (Applied Biosystems, Inc., Foster City, Calif.). One skilled in the art can readily appreciate that a peptide or polypeptide corresponding to the disclosed proteins, for example, can be synthesized by standard chemical reactions. For example, a peptide or polypeptide can be synthesized and not cleaved from its synthesis resin whereas the other fragment of a peptide or protein can be synthesized and subsequently cleaved from the resin, thereby exposing a terminal group which is functionally blocked on the other fragment. By peptide condensation reactions, these two fragments can be covalently joined via a peptide bond at their carboxyl and amino termini, respectively, to form an antibody, or fragment thereof. (Grant GA (1992) Synthetic Peptides: A User Guide. W.H. Freeman and Co., N.Y. (1992); Bodansky M and Trost B., Ed. (1993) Principles of Peptide Synthesis. Springer-Verlag Inc., NY (which is herein incorporated by reference at least for material related to peptide synthesis). Alternatively, the peptide or polypeptide is independently synthesized in vivo as described herein. Once isolated, these independent peptides or polypeptides may be linked to form a peptide or fragment thereof via similar peptide condensation reactions.

For example, enzymatic ligation of cloned or synthetic peptide segments allow relatively short peptide fragments to be joined to produce larger peptide fragments, polypeptides or whole protein domains (Abrahmsen L et al., Biochemistry, 30:4151 (1991)). Alternatively, native chemical ligation of synthetic peptides can be utilized to synthetically construct large peptides or polypeptides from shorter peptide fragments. This method consists of a two step chemical reaction (Dawson et al. Synthesis of Proteins by Native Chemical Ligation. Science, 266:776-779 (1994)). The first step is the chemoselective reaction of an unprotected synthetic peptide—thioester with another unprotected peptide segment containing an amino-terminal Cys residue to give a thioester-linked intermediate as the initial covalent product. Without a change in the reaction conditions, this intermediate undergoes spontaneous, rapid intramolecular reaction to form a native peptide bond at the ligation site (Baggiolini M et al. (1992) FEBS Lett. 307:97-101; Clark-Lewis I et al., J. Biol. Chem., 269:16075 (1994); Clark-Lewis I et al., Biochemistry, 30:3128 (1991); Rajarathnam K et al., Biochemistry 33:6623-30 (1994)).

Alternatively, unprotected peptide segments are chemically linked where the bond formed between the peptide segments as a result of the chemical ligation is an unnatural (non-peptide) bond (Schnolzer, M et al. Science, 256:221 (1992)). This technique has been used to synthesize analogs of protein domains as well as large amounts of relatively pure proteins with full biological activity (deLisle Milton RC et al., Techniques in Protein Chemistry IV. Academic Press, New York, pp. 257-267 (1992)).

### F. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

a) Choice of Drugs to Study

The computational methods developed here accurately quantify the relative binding energetics of a drug of interest with many homologous receptors. To test the methods, seven different small-molecule inhibitors were selected for study, subject to the dual requirements of having high resolution structures in complex with at least one protein kinase target, and having experimental data for the drug's activity against ˜20 protein kinases. Kinase inhibitors provide an excellent test system since they target members of a very large family of closely related sequences (6), are attractive therapeutic agents (7), yield high resolution crystal structures in complex with their targets (8), and are often experimentally assayed against panels of several different potential kinase targets (9), thus providing a body of data that any predictive method must be able to reproduce. In the present work, it is shown that it is possible to compute relative binding energies of drugs in complex with ˜20 protein kinases that closely mirror experimental inhibition data. Three of the seven drugs (SB 203580, purvalanol B, and imatinib) have been screened against 493 human protein kinases; each of these ‘kinome’-wide screens was completed on modest computational hardware in a single day.

The drugs chosen, followed in parentheses by the PDB codes of their kinase co-crystal structures, were: SB 203580 (1PME; 10), H89 (1YDT; 11), purvalanol B (1CKP; 12), hymenialdisine (1DM2; 13), imatinib (1OPJ; 14), indirubin-3′-monoxime (1E9H; 15), and quercetin (2HCK; 16). To prepare each drug structure for calculations, the PRODRG webserver (17) was used to build in atoms that were unresolved or absent from the crystal structures.

b) Construction of Protein Kinase Models

The computation of a drug's affinity for a kinase of interest requires an accurate structural model of the protein. To construct the latter, a conservative approach was adopted: for each drug, all kinases to be tested were modeled with backbone conformations identical to those found in the drug-receptor crystal structure. With this assumption all that is required to construct structural models is a reliable sequence alignment. To this end, the Kinase Sequence Database (KSD) was used, a curated alignment of the ATP-catalytic domains of over 7000 kinases constructed by Shokat and co-workers (21). The alignment of the sequences in this database with the sequence of each drug-bound crystal structure kinase was accomplished using the ‘profile alignment’ function of the multiple sequence alignment program CLUSTALW (22). Using the resulting alignment, a structure file for each kinase to be tested was created; no attempt was made to model insertions relative to the crystal structure, and residues outside of the catalytic (ATP-binding) domain were omitted. To complete preparation of the structures, sidechains were added using the rotamer-modeling program SCWRL (23), and hydrogens were added using the hydrogen bond-optimization module of the modeling program WHATIF (24).

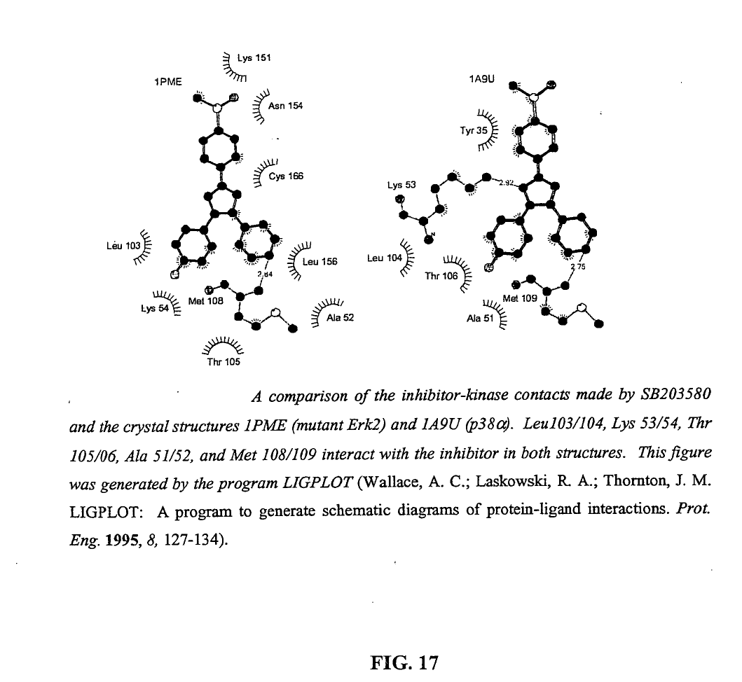

FIG. 17 shows a comparison of the inhibitor-kinase contacts made by SB203580 and the crystal structures 1PME (mutant Erk2) and 1A9U (p38ALPHA). Leu103/104, Lys 53/54, Thr 105/06, Ala 51/52, and Met 108/109 interact with the inhibitor in both structures. This figure was generated by the program LIGPLOT (Wallace, A. C.; Laskowski, R. A.; Thornton, J. M. LIGPLOT: A program to generate schematic diagrams of protein-ligand interactions. Prot. Eng. 1995, 8, 127-134).

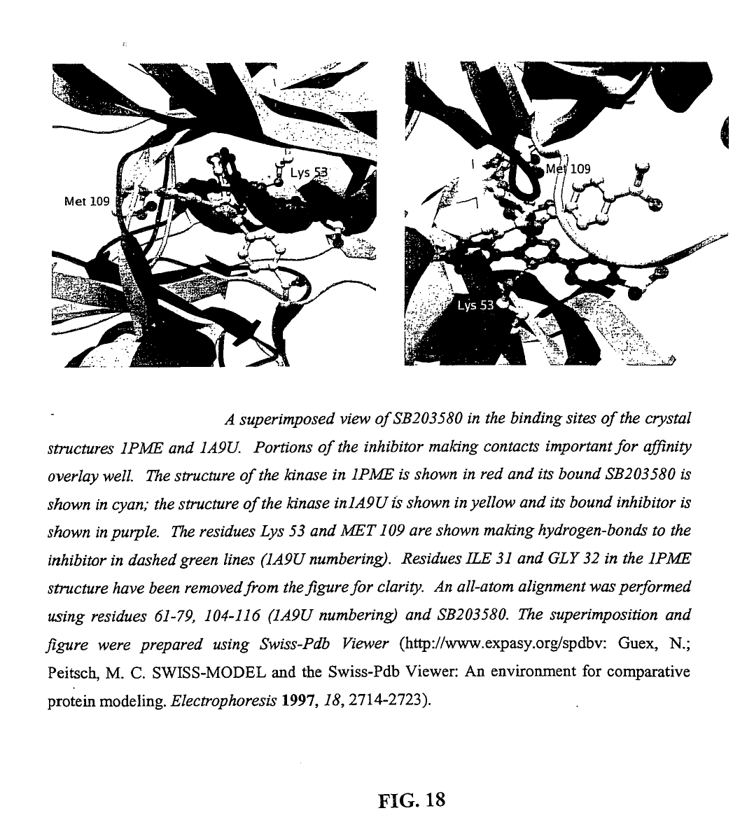

194. FIG. 18 shows a superimposed view of SB203580 in the binding sites of the crystal structures 1PME and 1A9U. Portions of the inhibitor making contacts important for affinity overlay well. The structure of the kinase in 1PME is shown in red and its bound SB203580 is shown in cyan; the structure of the kinase in 1A9U is shown in yellow and its bound inhibitor is shown in purple. The residues Lys 53 and MET 109 are shown making hydrogen-bonds to the inhibitor in dashed green lines (1A9U numbering). Residues ILE 31 and GLY 32 in the 1PME structure have been removed from the figure for clarity. An all-atom alignment was performed using residues 61-79, 104-116 (1A9U numbering) and SB203580. The superimposition and figure were prepared using Swiss-Pdb Viewer: An environment for comparative protein modeling. Electrophoresis 1997, 18, 2714-2723).

c) Computation of drug-receptor binding energies

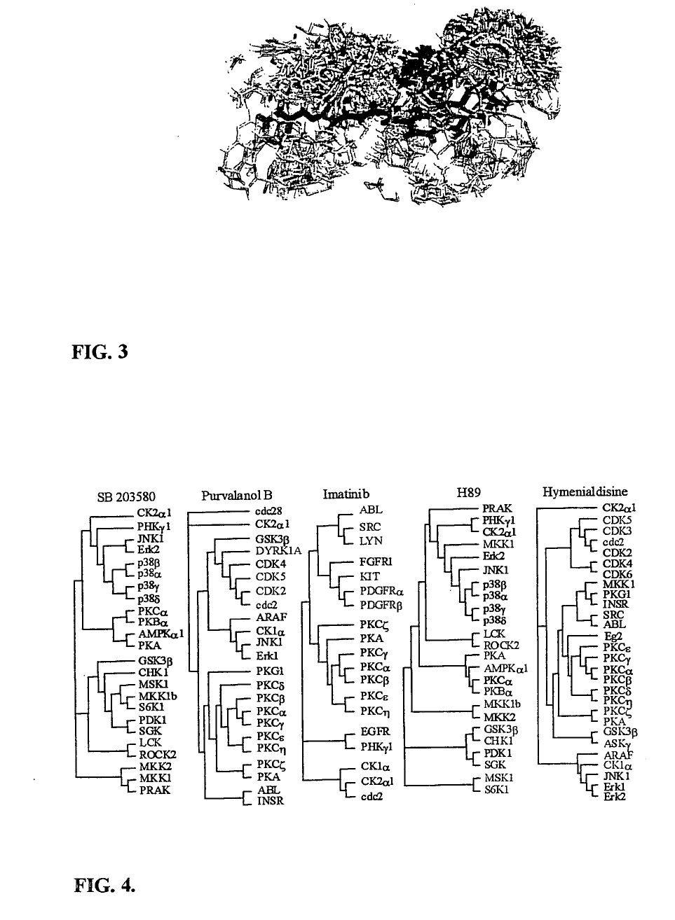

For the purposes of calculating the binding energy of a drug with a potential receptor, a new software program (SCR) was written in FORTRAN90. The program incorporates flexibility in the protein residues that are close to the drug through the use of rotamer libraries (5) that are sampled by Monte Carlo methods (25). The rotamer libraries used in the calculations reported here were the highest resolution sets developed by Xiang and Honig (26), providing good coverage of conformational possibilities; the library for arginine for example contains 1948 different rotamers. For each drug-receptor combination studied, flexibility was modeled for all residues that had at least one atom located within 5.0 Å of any drug atom in the initial SCWRL-built model (see above); typical calculations involved ˜20 moving residues. A structural picture of the rotamers sampled in a typical binding site is shown in FIG. 3.

The sampling of sidechain positions and the computation of the binding thermodynamics were accomplished using a simple, empirical function that models the energy of the drug-receptor system as a sum of electrostatic and van der Waals interactions between all pairs of atoms. Electrostatic interactions (in kcal/mol) were computed using a basic Coulombic model:
E_{elec}=332.08q1q2/εr
where q1 and q2 are the partial atomic charges on the interacting atoms (in proton units), r is the distance between the two atoms (in Ångstroms), and ε is the relative dielectric constant, assumed here to be 78 (i.e. that of water). For the protein atoms, partial atomic charges were taken from the PARSE parameter set (27); for the drugs, partial charges were assigned on the basis of analogy with similar functional groups present in the PARSE parameter set, e.g. for carbonyl groups, charges of +0.5e and −0.5e were assigned to the C and O atoms respectively.

Additional contributions to the computed energy were made by van der Waals interactions, with a deliberately simple approach again being adopted. For interacting pairs in which both atoms were carbon or sulfur, a Lennard-Jones 12-6 interaction was used:
E_{vdw}=ε{σₐₜₜ¹²/r¹²−σₐₜₜ⁶/r6}
For all other interacting pairs, a purely repulsive 1/r¹² term was calculated:
E_{vdw}=ε{σᵣₑₚ¹²/r^{12}}

In these expressions σₐₜₜ and σᵣₑₚ are constants (in the former case corresponding to the distance at which the Lennard-Jones interaction changes from being attractive to repulsive), ε has the units of energy (kcal/mol) and r is the distance between the two atoms. A single σᵣₑₚ value was used for all interactions between non-hydrogen atoms, and (based on early calculations) this was always 0.75 Å shorter than the single σₐₜₜ value used for all C—C, C—S and S—S interactions. H—H interactions were assigned a σᵣₑₚ of 0.5 Å; for mixed interactions between hydrogen and non-hydrogen atoms, we calculated σᵣₑₚ as the geometric mean: σ=√σ_{rep,i}σᵣₑₚⱼ. As a further simplifying assumption, a single value of ε(0.2 kcal/mol) was assigned to all pairwise interactions. The rationale for the above definitions is that they provide a straightforward but effective way of accounting for hydrophobic interactions: contacts between carbons and sulfurs (all of which are here considered hydrophobic) are energetically rewarded, whereas all other contacts are considered to be energetically neutral (the 1/r¹² term being used only to prevent overlap of atoms).

With the energy function defined above, binding energies for each drug-receptor combination were calculated in the following way. Monte Carlo sampling of the flexible sidechains in the receptor was conducted in the presence and absence of the drug; in the former simulations the drug was held fixed in the position it adopted in the crystal structure. Trial moves were made by first randomly selecting one of the moveable sidechains, and then randomly selecting a new rotamer for the chosen sidechain. Following each trial move and the computation of the new energy, a Metropolis test (28) was applied (assuming a temperature of 298 K) to determine whether to accept the new conformation. For both the drug-present and drug-absent situations, 10 independent simulations were performed, each consisting of one million ‘equilibration’ MC steps, followed by 5 million ‘production’ MC steps; during each production phase the average energy of the moving residues was accumulated. The drug-receptor binding energy was then computed as the difference between the best average energy found in the 10 simulations without the drug, and the best average energy found in the 10 simulations with the drug present. Use of 10 independent simulations was made to avoid complications occurring when individual MC simulations became locked in local energy minima; such situations were rare, and the differences among the 10 computed values were usually within 0.01-0.03 kcal/mol.

d) Quantifying Predictions of Receptor Selectivity

To validate the predictions made by SCR and to pave the way for its use in making large-scale predictions for the entire human ‘kinome’, one of the first goals of the present work was to calculate the binding energy of each of the seven selected drugs with ˜20 protein kinases and to compare the computed relative binding energies with experimental results. Experimental inhibition data for the drugs was obtained from several sources. For SB 203580, H89, indirubin-3′-monoxime and quercetin, data were taken from studies by Cohen's group (9, 18); these data consist of the percent activity of >20 protein kinases following addition of a fixed concentration (usually 10 μM) of the drug. Inhibition data for the compounds purvalanol B, hymenialdisine and imatinib were obtained in the form of IC₅₀ data primarily from references 12, 13, and 19 respectively; for imatinib three additional targets (cKit, PDGFRα, and PDGFRβ) were identified in ref. 20.

If direct experimental binding data were available, it would be possible to assess the computational predictions by linear regression of the computed and experimental energies. However, since the available data (e.g. IC₅₀ values) provide only indirect estimates of relative binding affinities, we have used a simple classification-based scheme to quantify the accuracy of the computed results: kinases were classified as either being ‘targets’ or ‘non-targets’ of a particular drug according to their degree of inhibition observed experimentally. In the case of those drugs for which IC₅₀ data have been reported, kinases with IC₅₀ values <100 nM were categorized as ‘targets’; in the case of drugs for which percent kinase activity has been reported (refs. 9 and 26), only those kinases with activities <50% were categorized as ‘targets’. All kinases not meeting these criteria were categorized as ‘non-targets’ of the drug.

A similar binary classification scheme was also applied to the computed binding energies: a cut-off was chosen (see below), as described below, such that kinases with binding energies equal to or more favorable than the cut-off were classified as ‘computed targets’, with all other kinases being ‘computed non-targets’. Once kinases were classified as ‘targets’ or ‘non-targets’ according to both the computed and experimental data, the measures of predictive value theory were used to quantify the degree of agreement between the two sets of classifications. Although a variety of measures could in principle can be used (specificity, sensitivity etc.), we chose to quantify the success of the computations were quantified by calculating the classification efficiency, defined as:

$$Effciency = \frac{\{ \# truepositives + \# truenegatives \} \times 100 \%}{\begin{matrix}\{ \# truepositives + \# falsepositives + \\ \# truenegatives + \# falsenegatives \}\end{matrix}} \qquad ( 1 )$$

where ‘true positive’ denotes a kinase determined to be a ‘target’ of the drug both computationally and experimentally, ‘false positive’ a kinase computed to be a ‘target’ but designated a ‘non-target’ experimentally, ‘false negative’ a kinase computed to be a ‘non-target’ when designated a ‘target’ experimentally, and ‘true negative’ a kinase determined to be a ‘non-target’ both computationally and experimentally.

Having a defined, quantitative measure of the degree of correspondence between computed and experimental ‘target’/‘non-target’ classifications of kinases provides a route to optimizing SCR so that its results more closely describe reality. Only very minor adjustments were made; in fact, for each drug studied here, we have adjusted only a single parameter parameter was adusted: the value of σᵣₑₚ (which in turn defines σₐₜₜ; see above). For six of the seven drugs, an optimal value of σᵣₑₚ was found simply by varying it in 0.1 Å increments within the range 2.6 Å to 3.4 Å and finding the value that maximized the classification efficiency; for the particular case of hymenialdisine, optimal results were obtained with a σᵣₑₚ of 2.4 Å. The extent to which adjustment of this single parameter maximizes the classification efficiency for the full set of ˜20 kinases for each drug provides a key first indication of the potential utility of the computational method; in particular, it demonstrates how well the method operates when ‘trained’ on a relatively large set of data. (FIG. 8)

Binding energies computed for a prototypical panel of six kinases tested against a hypothetical drug are shown. The three kinases that are true experimental ‘targets’ (A, B and C) are shaded; those that are experimental ‘non-targets’ (D, E and F) are unshaded. In each column, kinases are listed in order of their computed binding energies. A binding energy cutoff (indicated by the bold line) separates those kinases that are computed to be ‘targets’ from ‘non-targets’: those kinases lying above the cutoff in the FIG. 8 are computed ‘targets.’ In the above example, the cutoff is set equal to the least favorable binding energy of the experimental ‘targets’ (see text). When the calculations are performed with the atomic van der Waals radius (σᵣₑₚ) set to 2.6 Å, the cutoff is such that all kinases in the panel would be computed ‘targets’; given that this would result in three false positives, this would clearly be a less than ideal result. When the radius is increased to 2.7 Å, it is possible to set the cutoff so that only one false positive (kinase D) is obtained; when a radius of 2.8 Å is used, a perfect result can be achieved with no false positives. TP denotes true positive, and TN denotes true negative.

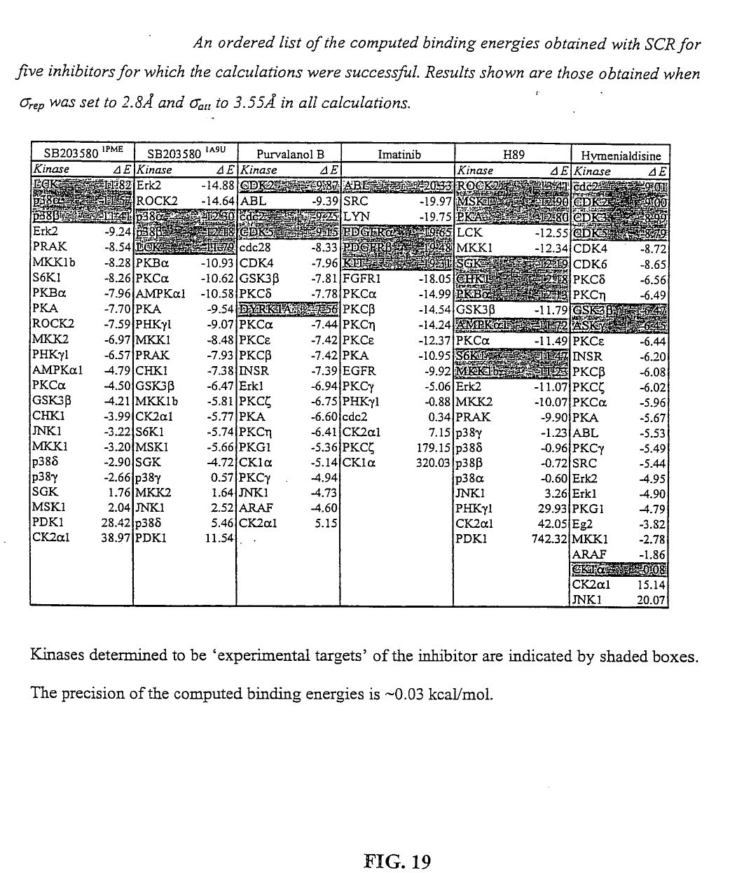

FIG. 19 shows an ordered list of the computed binding energies obtained with SCR for five inhibitors for which the calculations were successful. Results shown are those obtained when σᵣₑₚ was set to 2.8 Å and σₐₜₜ to 3.55 Å in all calculations. Kinases determined to be “experimental targets” of the inhibitor are indicated by shaded boxes. The precision of the computed binding energies is ˜0.03 kcal/mol.

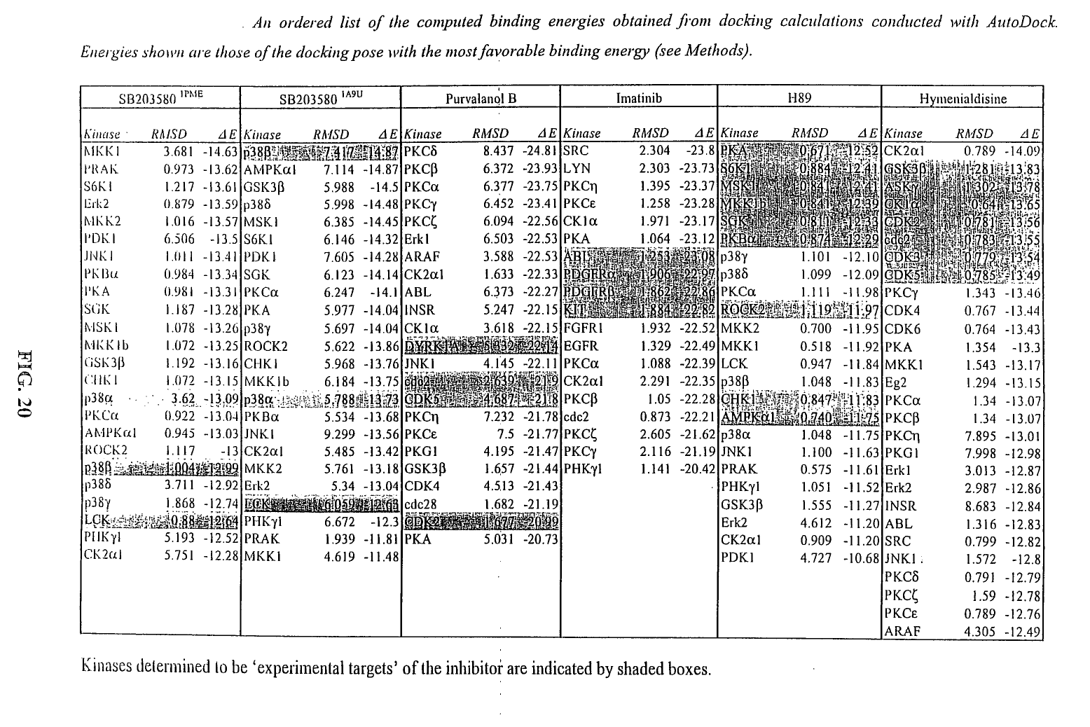

FIG. 20 shows an ordered list of the computed binding energies obtained from docking calculations with AutoDock. Energies shown are those of the docking pose with the most favorable binding energy. Kinases determined to be “experimental targets” of the inhibitor are indicated by shaded boxes.

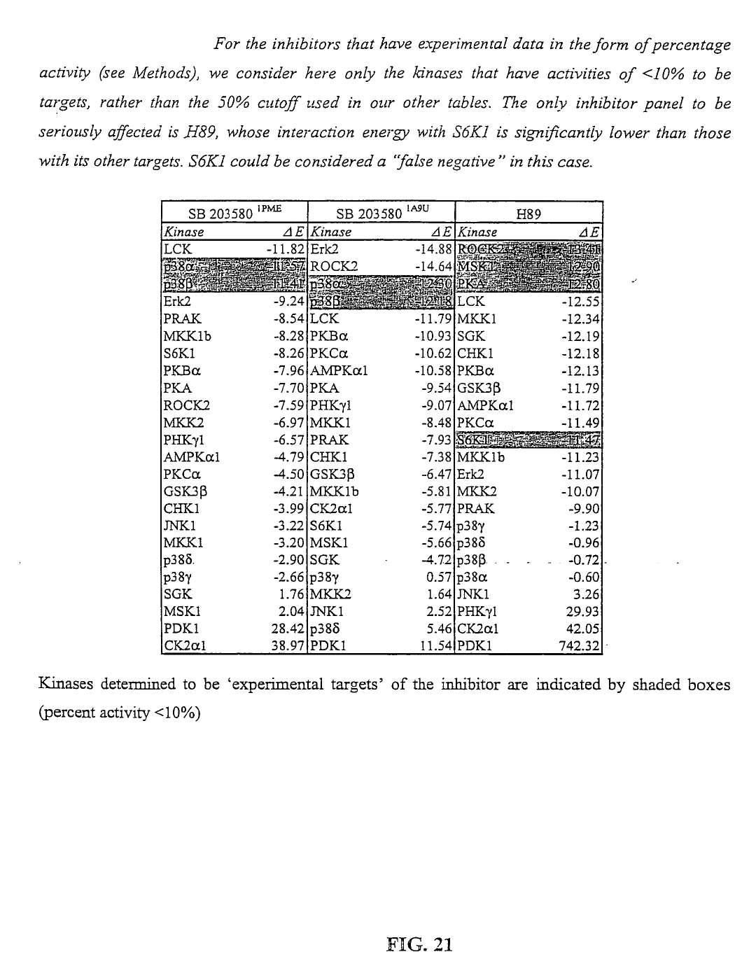

For the inhibitors that have experimental data in the form of percentage activity, FIG. 21 shows only the kinases that have activities of <10% to be targets, rather than the 50% cutoff used in the other tables. The only inhibitor panel to be seriously affected is H89, whose interaction energy with S6K1 is significantly lower than those with its other targets. S6K1 could be considered a “false negative” in this case. Kinases determined to be “experimental targets” of the inhibitor are indicated by shaded boxes (percent activity <10%).

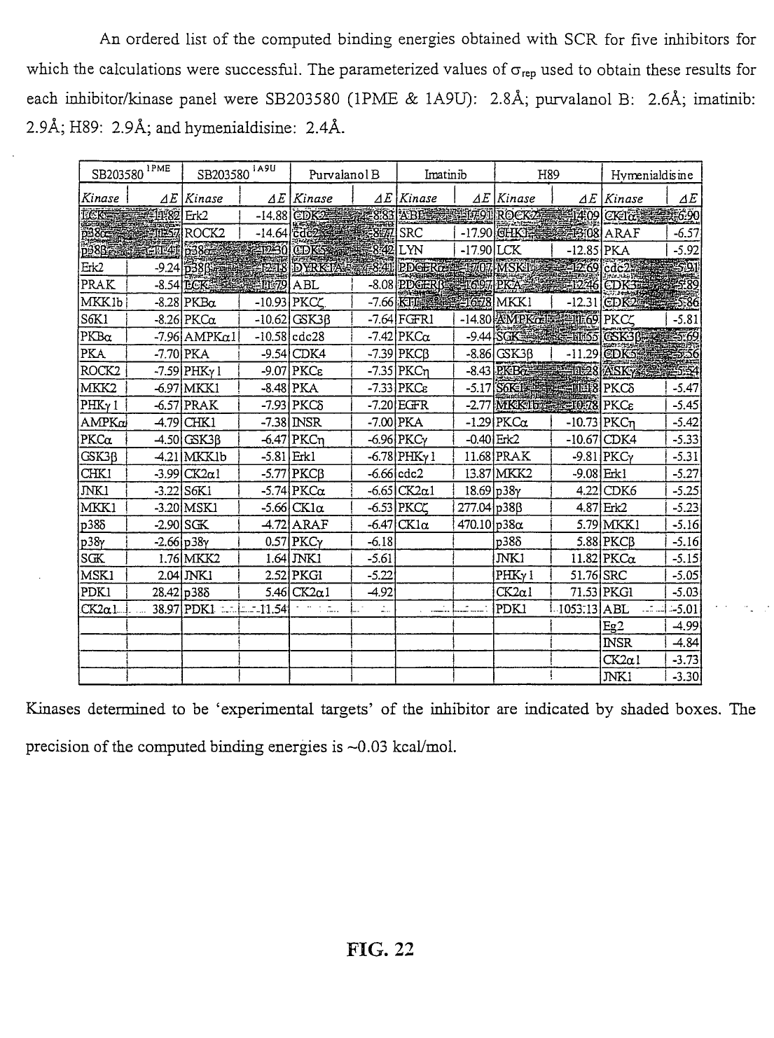

FIG. 22 shows an ordered list of the computed binding energies obtained with SCR for five inhibitors for which the calculations were successful. The parameterized values of σᵣₑₚ used to obtain these results for each inhibitor/kinase panel were SB203580 (1PME & 1A9U): 2.8 Å; purvalanol B: 2.6 Å; imatinib: 2.9 Å; H89: 2.9 Å; and hymenialdisine: 2.4 Å. Kinases determined to be “experimental targets” of the inhibitor are indicated by shaded boxes. The precision of the computed binding energies is ˜0.03 kcal/mol.

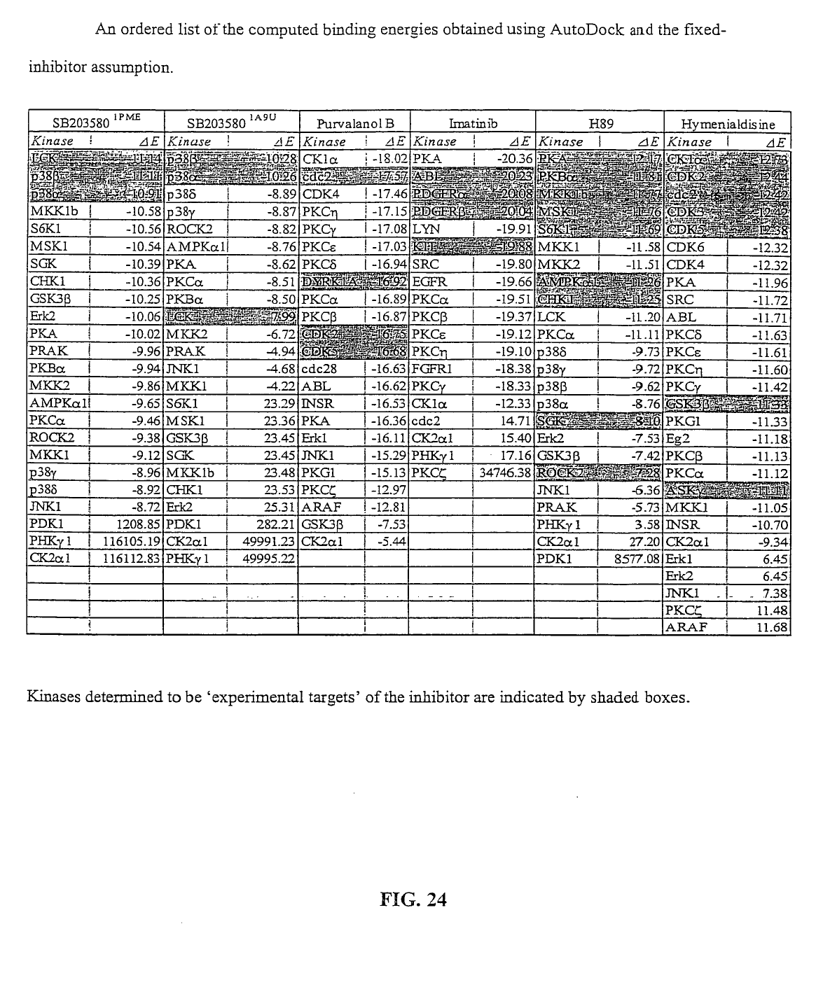

FIG. 24 shows an ordered list of the computed binding energies obtained using AutoDock and the fixed-inhibitor assumption. Kinases determined to be “experimental targets” of the inhibitor are indicated by shaded boxes.

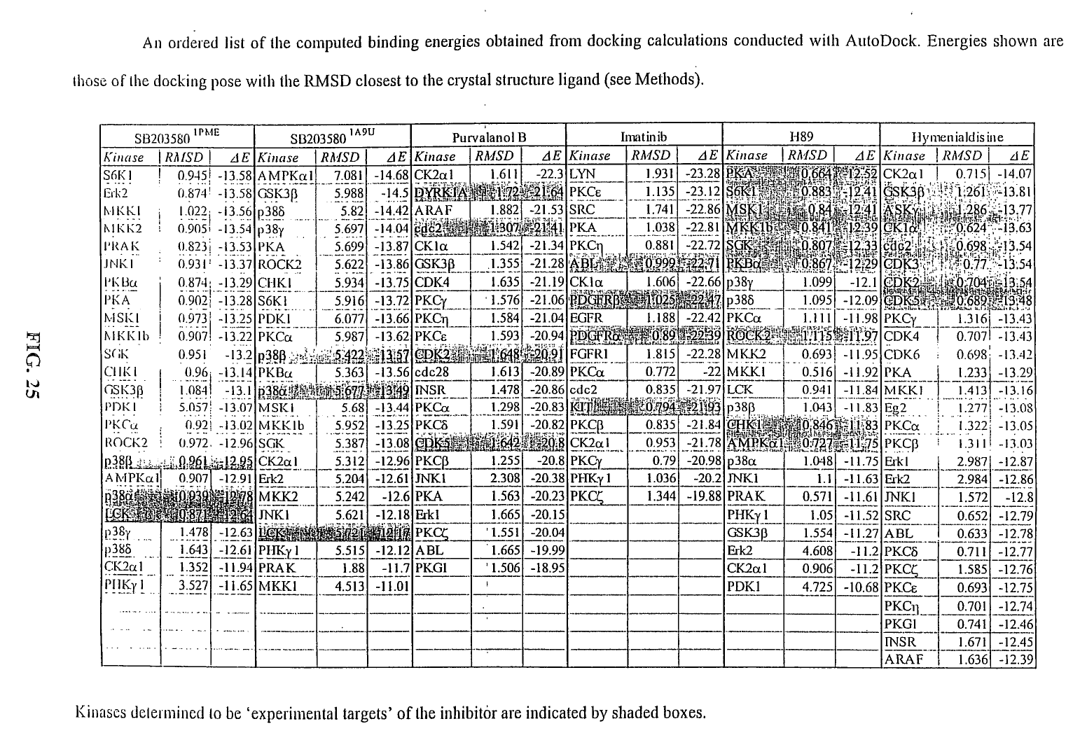

FIG. 25 shows an ordered list of the computed binding energies obtained from docking calculations conducted with AutoDock. Energies shown are those of the docking pose with the RMSD closest to the crystal structure ligand. Kinases determined to be “experimental targets” of the inhibitor are indicated by shaded boxes.

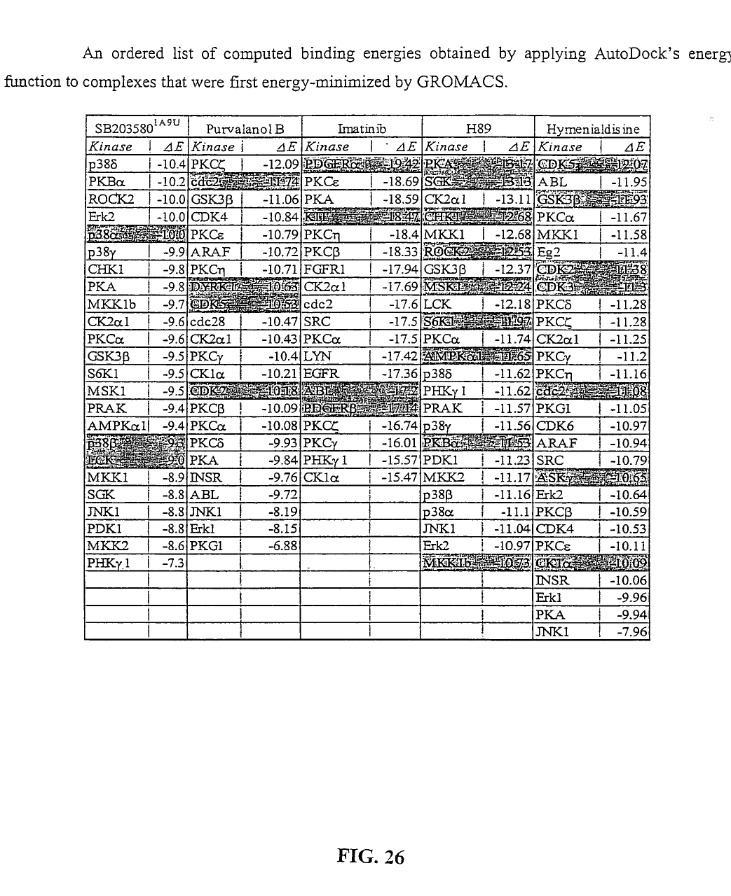

FIG. 26 shows an ordered list of the computed binding energies obtained by applying AutoDock's energy function to complexes that were first energy-minimized by GROMACS.

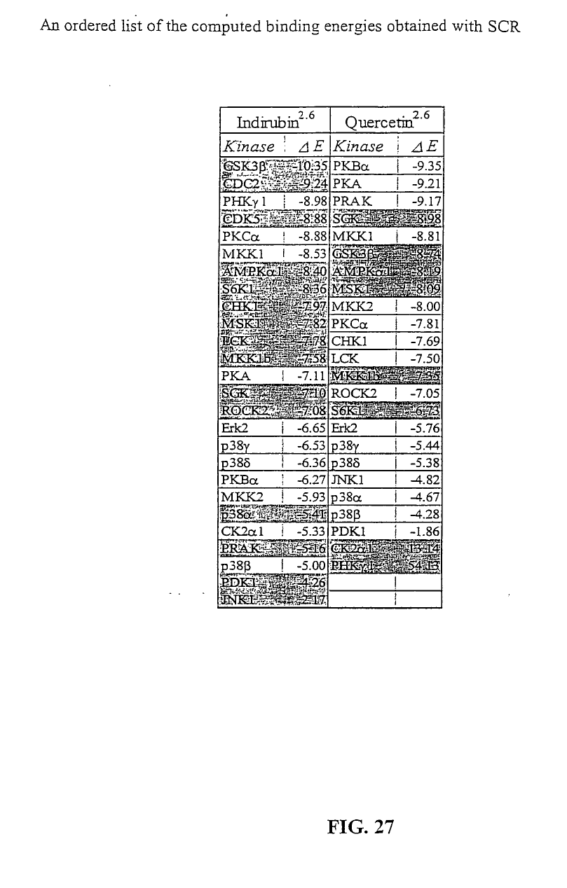

FIG. 27 shows an ordered list of the computed binding energies obtained with SCR.

e) Validation of Predictive Ability

In order to provide a direct route to assessing the likely predictive ability of the computational method, a training/testing procedure was devised and carried out for the three drugs that showed the most selective experimental inhibition profiles (SB 203580, purvalanol B, and imatinib). For each drug, the ˜20 kinases that have been experimentally studied were randomly divided into two sets (a ‘training’ set and a ‘testing’ set), subject only to the requirement that both sets contained the same numbers of ‘targets’ (one or two) and ‘non-targets’ (between seven and ten). For the training set, a σᵣₑₚ value that maximized the classification efficiency was found in the same way as described above for the full set of ˜20 kinases; note however, that in this new scenario the method was ‘trained’ with only half of the available experimental data instead of the full set used previously. The same σᵣₑₚ value found for the training set, together with its corresponding cutoff energy, was then applied unaltered to the kinases in the testing set and the classification efficiency in the testing set determined. This process of randomly dividing the kinases into training and testing sets, determining an optimal σᵣₑₚ value from a training set and quantifying classification efficiencies for a testing set using identical conditions, was repeated a total of 1000 times for each drug in order to obtain a statistically meaningful measure of the classification efficiencies that might be expected in truly predictive scenarios. In order to determine whether the results obtained with the method exceed those expected on the basis of chance, the above sampling procedure was conducted a second time, but with the labels ‘target’ and ‘non-target’ being randomly reassigned among the kinases within both the training and testing sets in each of the 1000 randomly drawn samples (while keeping the number of targets and non-targets in each panel the same as in the non-random scenario). Histograms of the computed classification efficiencies in the testing sets were constructed for each drug with both the true experimental ‘target’/‘non-target’ classifications and the randomly reassigned classifications (see Results).

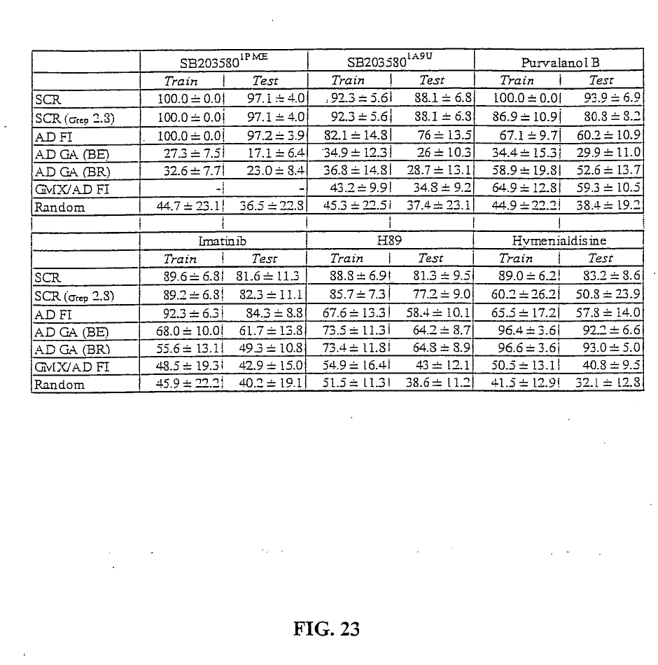

FIG. 23 shows a summary of training/setting results for various screening protocols applied to five inhibitors and their respective kinase panels. Percent efficiencies are shown along with standard deviations for 1000 training/testing iterations. SCR refers to Side Chain Rotamer program; AD FI refers to AutoDock calculations within the fixed-inhibitor assumption; AD GA (BE) refers to AutoDock genetic algorithm dockings in which the docked ligand with the best energy is selected; AD GA (BR) refers to docking in which the docked ligand that has the lowest RMSD to the crystal structure is selected; GMC/AD FI refers to the case where the models are energy-minimized with GROMACS prior to the AutoDock fixed-inhibitor calculation, and Random shows the efficiency that would be expected if a method had no predictive ability. With the exception of the hymenialdisine panel, keeping the ligand in the same orientation for all members of a panel (as is done in the SCR and AD FI cases) produces better efficiencies than allowing the ligand to assume different orientations in each receptor of a given panel.

f) Defining a Binding Energy Cutoff

Central to the method's use in each of the above tests is the definition of the binding energy cutoff that separates the computed ‘targets’ from ‘non-targets.’ In the initial set of calculations aimed at investigating how well the method classifies kinases when trained on all the available experimental data for a given drug (see above), the cut-off was simply set equal to the weakest computed binding energy of the known experimental ‘targets’. By definition, this approach ensures that all of the known ‘experimental targets’ of the drug are also ‘computed targets’, so the real test of the method in such a scenario is the extent to which it also incorrectly identifies ‘experimental non-targets’ as ‘computed targets’ (i.e. the rate at which it predicts ‘false positives’).

For the training/testing calculations aimed at demonstrating how well the method can predict ‘targets’ and ‘non-targets’ when trained on only half of the available data, it became clear that in many cases assigning the binding energy cut-off to be equal to the weakest binding energy of the known targets in the training set was too restrictive a criterion. In particular, experience showed that such a criterion can fail to identify true ‘targets’ present in the testing set because their computed binding energies were slightly less favorable than the computed binding energies of the true ‘targets’ present in the training set. To eliminate this problem—which results in an unnecessarily high rate of false negatives in the testing set—the definition of the binding energy cutoff was modified to be equal to the weakest binding energy of the known targets in the training set multiplied by a scaling factor between 0.80 and 1.00. This has the effect of making the binding energy cutoff less negative, so that more receptors in the testing set are classified as computed ‘targets’; this in turn means that the number of false negatives is reduced, while the number of false positives increases. To thoroughly test the use of different scaling factors, the full set of 1000-sample training/testing calculations was repeated with each of the following factors being applied: 0.80, 0.85, 0.90, 0.95 and 1.00.

g) Large Scale Applications to Human Protein Kinases

For three of the drugs studied here, the computations were extended beyond the ˜20 kinases for which experimental data was available, to the full array of human protein kinases. As before, the creation of structural models required a suitable sequence alignment. To this end, 637 human kinase sequences were taken from the comprehensive study performed by Manning et al. (6); sequences with atypical kinase domains and non-coding pseudogenes were removed from this list to give a total of 493 kinases to be screened against the drugs. 363 of these sequences could be found immediately in the Shokat group's KSD alignment; the remaining 130 sequences were added to the alignment using CLUSTALW as described above. Binding energy computations for these 493 kinases were conducted in the same way as before; a complete set of calculations for one drug required about 24 hours of CPU time on a 16-node 2.6 GHz PC cluster.

h) Results

The goal of the methodology reported here is the accurate identification of those receptors that are targets of a drug based solely on relative binding energies computed from atomistic MC simulations. As a first test of the method, its ability to correctly discriminate between ˜20 ‘targets’ and ‘non-targets’ of seven different kinase inhibitors was investigated (see Methods). The extent to which accurate discrimination could be achieved is indicated by the computed binding energies listed in Table 3 for each drug-kinase combination tested. For each drug, the numbers listed are those producing the best agreement with experiment, as quantified by the ‘classification efficiency’ (see Methods). Importantly, calibration of the method was achieved (separately for each drug) by adjusting only a single parameter in the energy function: the van der Waals radius (σᵣₑₚ)—identical for all non-hydrogen atom types. The dependence of the classification efficiency on the range of σᵣₑₚ values investigated is shown for all seven drugs in Supporting Information.

For five of the drugs (SB203580, purvalanol B, imatinib, H89 and hymenialdisine), the agreement is clearly excellent: when the kinases are listed in order of decreasing affinity for each drug, the known experimental targets (shaded boxes) all cluster at the top of each list (Table 3). For two of these five drugs, SB 203580 and purvalanol B, the calculations correctly identify all experimental ‘targets’ as having computed binding energies that are clearly more favorable than all ‘non-targets’. This general trend is maintained with imatinib, H89 and hymenialdisine, The agreement is very good, and if the weakest binding energy of the known ‘targets’ of each drug as a binding energy cutoff for discriminating between ‘targets’ and ‘non-targets’, a total of 27 true ‘targets’ can be correctly identified at the expense of only 8 experimental ‘non-targets’ being incorrectly computed to be ‘targets’. A summary of the accuracy of the ‘target’/‘non-target’ classifications is provided in Table 4.

For the five drugs for which the calculations were successful, it is clear that ‘targets’ and ‘non-targets’ can be discriminated with a high degree of confidence, and that this appears to be true for the more selective inhibitors SB 203580, purvalanol B and imatinib (Table 3). Crucially, the kinases that are correctly computed to be ‘targets’ of a particular drug are often only distantly related to each other in terms of sequence, and their common status as ‘targets’ is therefore not a result that could be reproduced by a trivial comparison of their sequences. To illustrate this, phylogenetic trees constructed from the ‘sequence’ of residues in contact with each drug are shown in FIG. 4 for the five drugs for which the computations were successful; similar results were obtained when trees were constructed from all residues in the catalytic domain.

Although there is an expected overall tendency for the ‘experimental targets’ of each drug to cluster in the trees, there are clear and interesting exceptions, and a particularly striking observation is that two of the ‘targets’ of SB 203580 (p38α and p38%) are phylogenetically very remote from the drug's third ‘target’, LCK (6). A closer examination of the computed results for these kinases reveals why they are successfully identified as ‘targets’. In the computations a significant favorable contribution to drug-binding to the p38 kinases is made by the sidechain of Leu144 (numbered according to the KSD entry for p38α). This contribution is absent in LCK because of a Leu→Ala substitution at that position, and if this were the only difference between the two kinases, a decreased affinity for the drug would be computed. However, a simultaneous Ala→Leu substitution at the nearby position 137 in LCK compensates almost perfectly for the lost interaction such that the binding affinities to the p38 and LCK kinases are all computed to be more or less identical. When phylogenetic trees were constructed for the problematic drugs quercetin and indirubin-3′-monoxime, the kinases identified experimentally as targets did not show any obvious clustering at all.

A scaling factor was applied to the binding energy cutoff determined from the training set results in order to limit the number of false negatives obtained in the testing set calculations. Based on a more complete set of calculations, a scaling factor of 0.90 was determined to be most appropriate, which in a practical situation means that if a binding energy cutoff of −10.00 kcal/mol is found to be sufficient to identify all true ‘targets’ in a training set, then a more reasonable binding energy cutoff to use in a predictive, testing scenario can be −10.00×0.90=−9.00 kcal/mol. This would in effect allow for the possibility that other kinases can exist outside of the training set that, while binding the drug somewhat weaker, nevertheless still bind it sufficiently strongly to be considered ‘targets’.

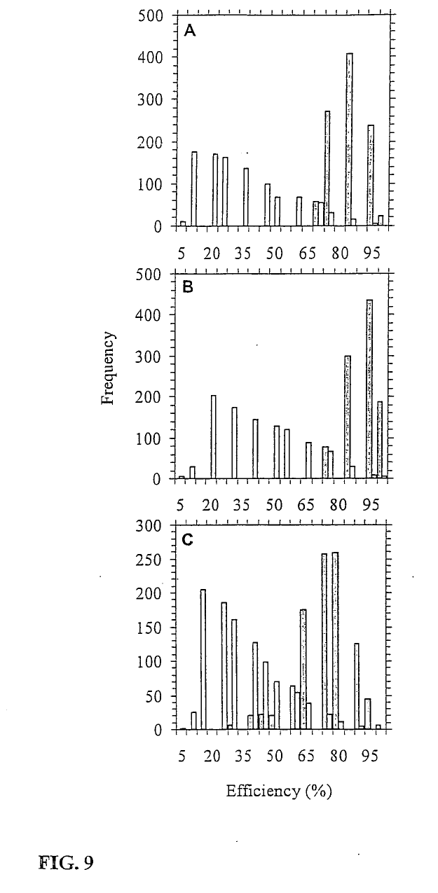

The distributions of calculated classification efficiencies for the testing sets, obtained from 1000 training/testing procedures with this scaling factor of 0.90 applied, are shown for each of the three drugs in FIG. 9. Also shown are distributions of calculated classification efficiencies obtained when the ‘target’/‘non-target’ classifications are reassigned randomly among the kinases rather than being taken from experiment. For all three drugs, the predictions obtained with the computational method are clearly far superior to those expected on the basis of chance: the non-parametric Mann-Whitney U test two-tailed p value was <0.0001 for a 99.0% confidence interval, establishing a highly significant difference between the medians of the model-computed and randomized distributions.

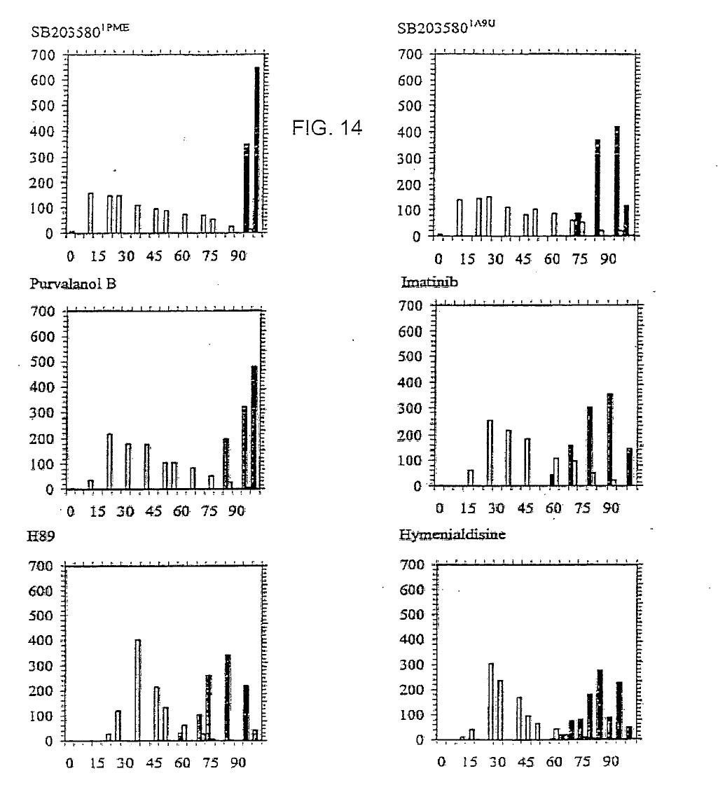

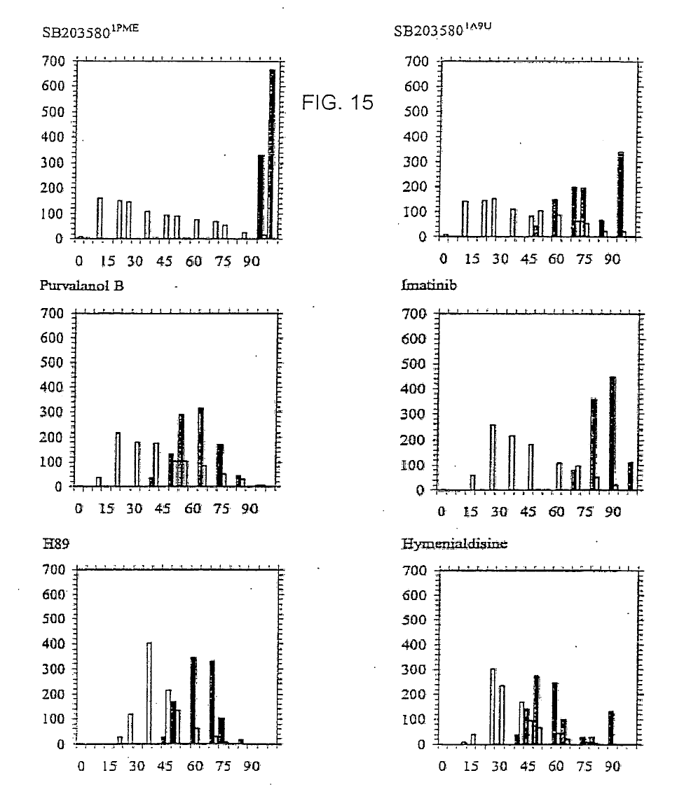

FIG. 14 shows the distribution of classification efficiencies of the testing sets obtained from SCR calculations. SCR's computed efficiencies are shown as dark bars; those obtained from randomized trials as white bars. FIG. 15 shows the distribution of testing set classification efficiencies obtained from AutoDock calculations with the fixed inhibitor assumption. AutoDock's computed results are shown as dark bars, those obtained from randomized trials as white bars.

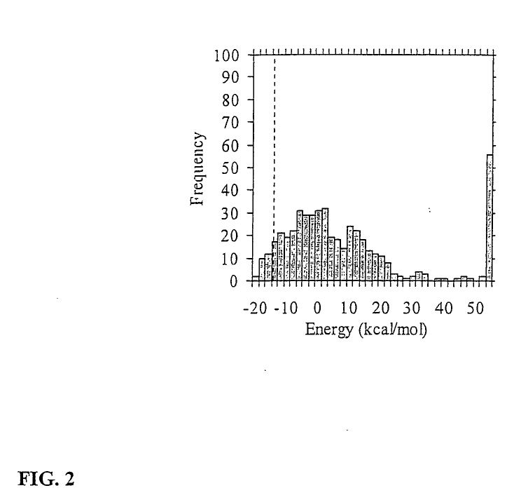

The demonstration of a significant predictive power to the computations provided sufficient confidence to attempt the ultimate goal of this work, which was to make reasonable predictions of the drugs' activity against a far larger sample of potential targets. To this end, binding energy calculations were carried out for SB 203580, purvalanol B and imatinib, each with a more or less full complement of 493 human protein kinases (see Methods). A histogram of the computed binding energies obtained from the large-scale screen of imatinib is shown in FIG. 2; the distribution is approximately normal, with a pronounced skew to the right due to kinases computed to have very positive binding energies (because of strong steric clashes with the drug). From the earlier calculations of imatinib binding to ˜20 kinases, a binding energy cutoff of −16.78 kcal/mol was identified (Table 3); applying a scaling factor of 0.90 converts this to a cutoff of −15.10 kcal/mol that might be reasonable to use in a predictive setting (see above). Using this cutoff, 32 of the 493 kinases (6.5%) were predicted to be ‘targets’ of imatinib. Similar histograms of computed binding energies were obtained from computational screens of SB 203580 and purvalanol B; these screens produced a total of 55 and 111 predicted ‘targets’ respectively for the two drugs.

TABLE 3
An ordered list of the computed binding energies obtained for each of the seven drugs with each kinase for which experimental data are available.

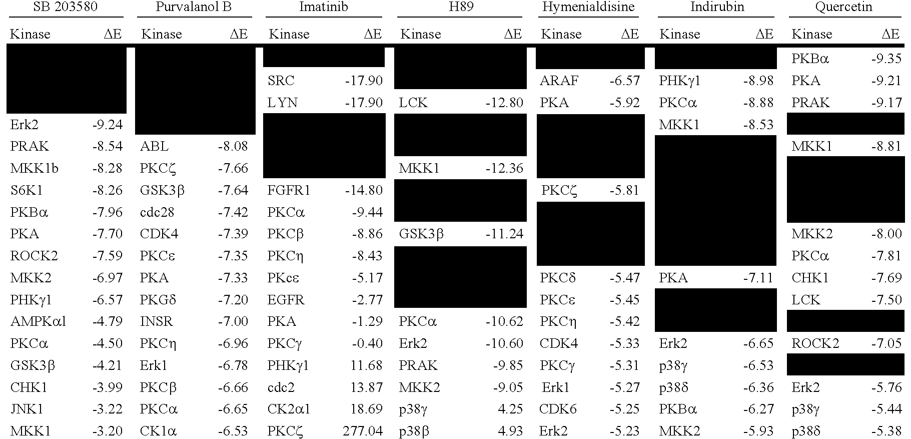

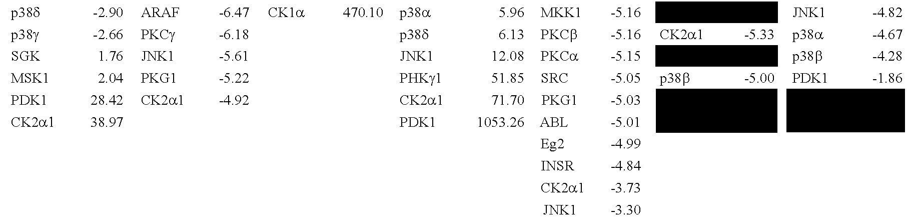

TABLE 4

| | SB. | P.B | Ima. | H89 |
|---|---|---|---|---|
| Tested | 24 | 23 | 19 | 24 |
| TP | 3 | 4 | 4 | 9 |
| FP | 0 | 0 | 2 | 3 |
| TN | 21 | 19 | 13 | 12 |
| FN | 0 | 0 | 0 | 0 |
| Eff. % | 100 | 100 | 89.5 | 87.5 |

| | Hym. | Ind. | Que. |
|---|---|---|---|
| Tested | 28 | 24 | 24 |
| TP | 7 | 13 | 8 |
| FP | 3 | 11 | 16 |
| TN | 18 | 0 | 0 |
| FN | 0 | 0 | 0 |
| Eff. | 89.3 | 54.1 | 33.3 |

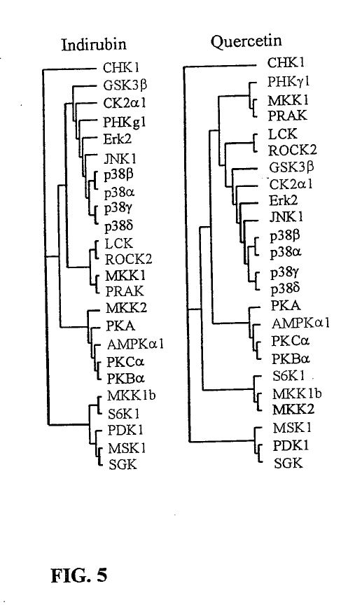

Importantly, the kinases that were correctly identified as targets by the binding energy computations were often only distantly related to each other in terms of sequence. Phylogenetic trees constructed from the ‘sequence’ of residues in contact with each drug are shown in FIG. 4 for the 5 drugs for which the computations were successful; similar results were obtained when trees were constructed from all residues in the catalytic domain. Although there is an expected overall tendency for the targets of each drug to cluster in the trees, there are clear exceptions: the two p38 targets of SB 203580 for example are phylogenetically remote from the drug's third target, LCK. Interestingly, a significant favorable contribution to drug-binding to p38α is made by the sidechain of Leu144 (KSD numbering); this contribution is lost in LCK because of a Leu to Ala substitution at that position. However, a simultaneous Ala AE Leu substitution at the nearby Ala137 (in p38α) neatly compensates for the lost interaction such that the binding affinities to p38α and LCK are more or less identical. The notion that even quite distantly related kinases can be targets of the same drug has been expressed already by Cohen and co-workers (8); it is notable however that this finding is reproduced by the current structure-based computations since it is unlikely to be easily captured with purely sequence-based approaches. Interestingly, when phylogenetic trees were constructed for quercetin and indirubin-3′-monoxime, the kinases identified experimentally as targets did not show any obvious clustering (FIG. 5).

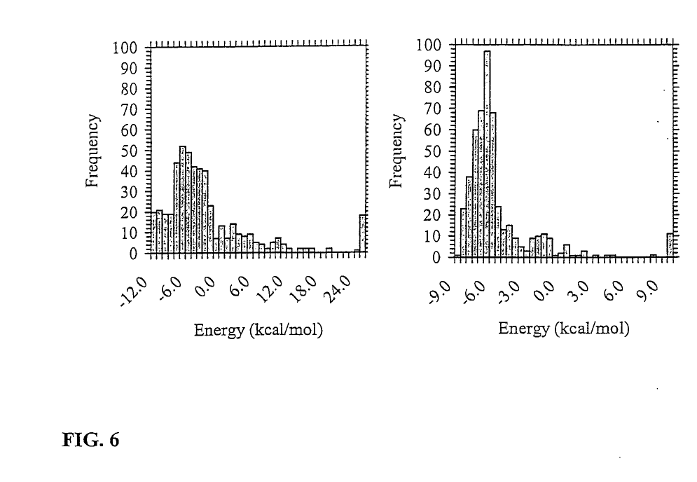

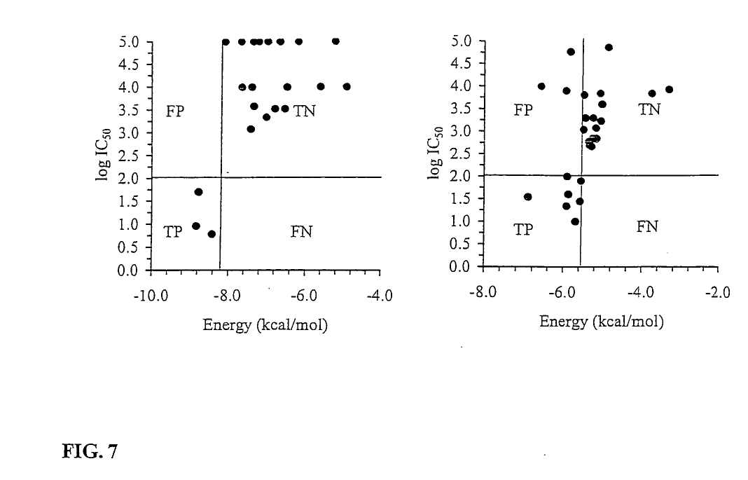

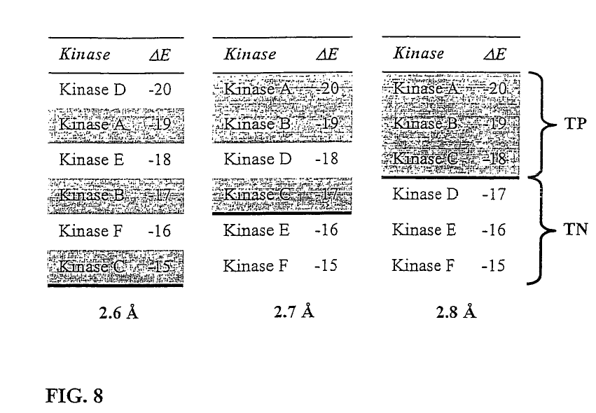

For the five successful drugs, the ability of the computations to reproduce experimental data for ˜20 kinases provided sufficient confidence to make predictions of drug activity against a much larger sample of potential targets. To this end, binding energy calculations were carried out for three of the drugs (SB 203580, purvalanol B and imatinib) with 493 human kinases. FIG. 2 shows a histogram of the computed binding energies obtained from the large-scale screen of imatinib; the distribution is approximately normal, with a pronounced skew to the right due to kinases computed to have very positive binding energies (because of strong steric clashes with the drug). In total, 22 of the 493 kinases (4.5%) are predicted to be targets of imatinib; the full list of such targets, which contains several kinases that are of potential therapeutic interest is given in Table 5. Similar histograms of computed binding energies were obtained from computational screens of purvalanol B and SB 203580 (FIG. 6); these screens produced a total of 33 and 36 predicted targets respectively for the two drugs (Tables 6 & 7).

TABLE 5
An ordered list of human protein kinases predicted to be targets
of imatinib. Known targets of the drug are indicated by shaded boxes.
An additional known target (ARG) that falls just outside of the cutoff
is indicated at the bottom of the list.

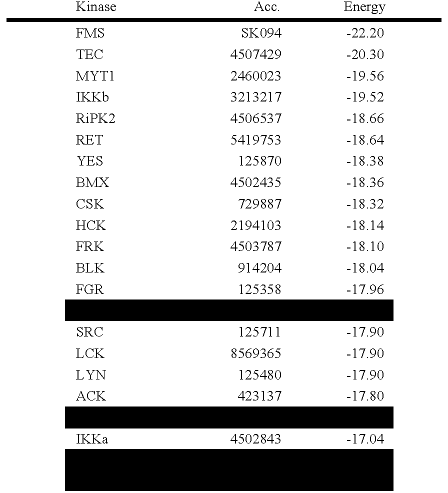

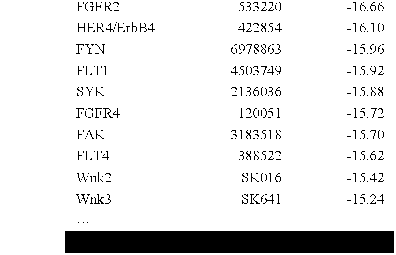

TABLE 6
Same as the previous table, except results are for purvalanol B.

| Kinase | Acc. | Energy |
|---|---|---|
| MAK | 7019738 | −9.02 |
| FLT4 | 388522 | −8.98 |
| MUSK | 5031927 | −8.95 |
| CDK3 | 231726 | −8.88 |
| KDR | 2655412 | −8.86 |
| PCTAIRE2 | 4505649 | −8 83 |
| 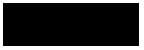 | 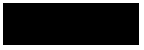 | 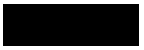 |
| PCTAIRE1 | 266425 | −8.82 |
| 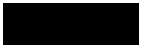 | 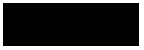 | 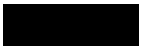 |
| FLT3 | 1362915 | −8.76 |
| CDKL1 | SK203 | −8.76 |
| Erk3 | 1294779 | −8.73 |
| ICK | SK497 | −8.72 |
| CDK7 | 4502743 | −8.68 |
| TRKA | 339918 | −8.65 |
| PCTAIRE3 | 547804 | −8.64 |
| CDC7 | 2102637 | −8.63 |
| Erk4 | 4506089 | −8.60 |
| GCN2 | 7243057 | −8.59 |
| ROR1 | 346351 | −8.57 |
| NEK3 | SK252 | −8.55 |
| FLT1 | 4503749 | −8.55 |
| NEK6 | 6009759 | −8.53 |
| PDGFRa | 5453870 | −8.50 |
| FGFR2 | 533220 | −8.49 |
| CASK | 3087818 | −8.49 |
| ROR2 | 4758842 | −8.49 |
| Erk7 | SK465 | −8.48 |
| NEK7 | SK421 | −8.45 |
| CCRK | 7106269 | −8.44 |
| TRKB | 530791 | −8.42 |
| 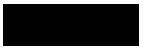 | 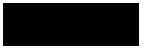 | 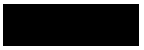 |
| 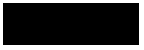 | 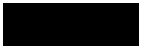 | 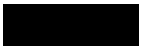 |
| TRKC | 442390 | −8.34 |
| MPSK1 | 3646280 | −8.33 |
| AurA | 4507275 | −8.31 |
| MAP3K4 | 1504010 | −8.30 |
| RET | 5419753 | −8.29 |
| DYRK1B | 6753698 | −8.29 |
| CDK9 | 4502747 | −8.28 |
| CDKL3 | 7108631 | −8.24 |
| AurB | 5688866 | −8.23 |
| JAK2 | 3236322 | −8.22 |
| TIE1 | 1512414 | −8.21 |
| AurC | 3127068 | −8.21 |
| MSK1 | 3411157 | −8.17 |
| PEK | 7341091 | −8.15 |
| MER | 5453738 | −8.11 |
| PFTAIRE2 | SK462 | −8.11 |
| PIM2 | 6470337 | −8.11 |
| SGK | 5442269 | −8.10 |
| ABL | 625609 | −8.08 |
| Wee1 | 499072 | −8.08 |
| PFTAIRE1 | 4240157 | −8.08 |
| LMR2 | 7662476 | −8.07 |
| CDKL2 | 4505569 | −8.07 |
| Wee1B | 4153873 | −8.07 |
| PAK5 | 6331022 | −8.03 |
| CLK3 | 3913243 | −8.03 |
| TLK1 | 6063017 | −8.02 |
| TLK2 | 6063019 | −8.02 |
| PAK4 | 6329959 | −8.01 |
| EphA1 | 339717 | −7.99 |
| EphA7 | 755568 | −7.97 |
| JAK1 | 125060 | −7.94 |
| MSK2 | 4506735 | −7.90 |
| DDR1 | 4503451 | −7.89 |
| KIT | 1817734 | −7.89 |
| CDK11 | SK443 | −7.89 |
| CDK8 | 4502745 | −7.88 |
| FGFR3 | 182569 | −7.87 |
| PKCτ | 5453976 | −7.85 |
| DDR2 | 5453814 | −7.85 |
| SRPK2 | 3406051 | −7.84 |
| PDGFRb | 4505683 | −7.83 |
| FGFR1 | 220738 | −7.81 |
| DYRK4 | SK116 | −7.80 |
| EphB3 | 542989 | −7.80 |
| TIE2 | 464868 | −7.79 |
| CDK6 | 266423 | −7.78 |
| Fused | 6331315 | −7.77 |
| PKACg | 3115220 | −7.76 |
| NEK9 | 4885696 | −7.75 |
| SRLPK1 | 3135976 | −7.74 |
| TYK2 | 267184 | −7.74 |
| RSK1 | 401772 | −7.72 |
| RSK3 | 6677811 | −7.72 |
| HCK | 2194103 | −7.72 |
| RSK2 | 1730070 | −7.71 |
| RSK4 | 6467562 | −7.69 |
| EphA6 | SK646 | −7.68 |
| PKCζ | 6166241 | −7.66 |
| CHED | 4502711 | −7.65 |
| GSK3B | 423729 | −7.64 |
| DMPK2 | SK112 | −7.64 |
| JAK3 | 508731 | −7.64 |
| MRCKb | 5006445 | −7.64 |
| PYK2 | 1165219 | −7.63 |
| ITK | 5031811 | −7.61 |
| IRAK1 | 1302664 | −7.61 |
| PKCι | 6679349 | −7.61 |
| MRCKa | 1695873 | −7.60 |
| MLK1 | 462606 | −7.60 |
| MAP2K5 | 1616781 | −7.60 |
| HRI | 6580979 | −7.59 |
| EphA10 | SK627 | −7.59 |
| DMPK1 | 976147 | −7.59 |
| CDKL4 | SK466 | −7.58 |
| YES | 125870 | −7.58 |
| EphB6 | 4758292 | −7.58 |
| SYK | 2136036 | −7.57 |

TABLE 7
An ordered list of the most favorable computed binding energies
obtained from a screen of SB 203580 with 493 human protein kinases.

| Kinase | Acc. | Energy |
|---|---|---|
| EphA1 | 339717 | −13.64 |
| EphB3 | 542989 | −13.44 |
| EphB1 | 4104413 | −13.04 |
| EphB4 | 495473 | −12.90 |
| RIPK3 | 5803143 | −12.82 |
| EphB2 | 1706665 | −12.54 |
| DDR1 | 4503451 | −12.44 |
| FRK | 4503787 | −12.40 |
| DDR2 | 5453814 | −12.40 |
| EphA8 | 7263928 | −12.34 |
| PDGFRα | 5453870 | −12.28 |
| YES | 125870 | −12.26 |
| BRK | 5174647 | −12.22 |
| BLK | 914204 | −12.10 |
| MAP2K5 | 1616781 | −12.10 |
| QIK | SK513 | −12.10 |
| LYN | 125480 | −12.08 |
| QSK | 4589642 | −12.06 |
| FGR | 125358 | −12.02 |
| EphA6 | SK646 | −12.00 |
| HCK | 2194103 | −11.94 |
| PDGFRβ | 4505683 | −11.92 |
| 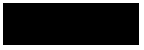 | 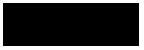 | 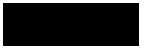 |
| YANK2 | 7160989 | −11.78 |
| EphA3 | 125387 | −11.78 |
| SIK | SK604 | −11.74 |
| EphA4 | 2833208 | −11.72 |
| MOK | 5139689 | −11.62 |
| 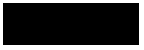 | 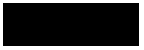 | 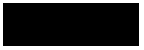 |
| EphA5 | 1177466 | −11.56 |
| SRM | SK425 | −11.52 |
| YANK3 | SK469 | −11.52 |
| YANK1 | SK624 | −11.48 |
| SRC | 125711 | −11.48 |
| FYN | 6978863 | −11.42 |
| 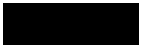 | 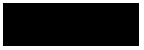 | 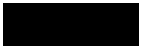 |
| 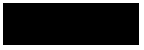 | 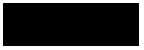 | 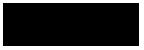 |
| MLK4 | SK691 | −11.22 |
| EphA2 | 125333 | −11.20 |
| EphB6 | 4758292 | −11.14 |
| RSK4 | zSK518b | −11.02 |
| 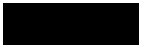 | 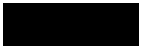 | 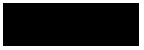 |
| RET | 5419753 | −10.94 |
| RSK3 | zSK338b | −10.80 |
| TGFbR2 | 1827475 | −10.76 |
| BRAF | 7304933 | −10.68 |
| CSK | 729887 | −10.62 |
| ACK | 423137 | −10.60 |
| RAF1 | 525211 | −10.58 |
| CaMKK1 | SK697 | −10.40 |
| HER4/ErbB4 | 422854 | −10.38 |
| BTK | 575890 | −10.32 |
| KDR | 2655412 | −10.28 |
| FLT4 | 388522 | −10.28 |
| KIT | 1817734 | −10.26 |

Known targets of the drug are indicated by shaded boxes. Acc. is the KSD accession number, or in the cases where kinase sequences were obtained from our own CLUSTALW alignment (see Methods), the accession number used by Manning et al. (denoted by the prefix “SK”).

234.

TABLE 8
Preliminary results for the application of the method to protein
phosphatases. Four protein phosphatases were screened for activity
with the inhibitor okadaic acid. Although the method failed to identify
the phosphatases inhibited by okadaic acid when the simulations were
run with a dielectric value of 78, PP1 and PP2A were correctly identified
as strongly binding this inhibitor when the dielectric value was
adjusted to 4.

| | | |
|---|---|---|
| Phosphatase | Energy | IC50 (nM) |

Dielectric 78

| | | |
|---|---|---|
| PP2B | −6.453 | 5000 |
| PP1 | −5.952 | 42 |
| PP2A | −5.209 | 0.51 |
| PP2C | −0.353 | >>10,000 |

Dielectric 4

| | | |
|---|---|---|
| PP1 | −12.453 | 42 |
| PP2A | −8.778 | 0.51 |
| PP2C | −2.226 | >>10,000 |
| PP2B | −2.182 | 5000 |

i) Discussion

Validating the methods used herein, three new kinase targets of the drug: RiPK2 (RICK), GAK, and CK1δ were discovered (4). In our computational screen of the same drug, RiPK2 and GAK ranked #37 and #42 respectively in the list of 493 computed binding energies (see Table 7), with energies that placed them inside the scaled binding energy cutoff(−10.27 kcal.mol) identified in the ˜20 kinase calculations (Table 3). These two kinases can also be considered to be predicted targets of the drug.

Regarding the disagreement between prediction and experiment for quercetin and indirubin-3′-monoxime, the explanation for these discrepancies comes from work by Shoichet and co-workers (36) showing that certain kinase inhibitors can aggregate at concentrations used in experimental inhibition studies: the aggregates thus formed can sequester the kinase leading to an artifactual decrease in kinase activity. Crucially, both quercetin and indirubin exhibit this behavior; of the other drugs studied here only SB 203580 has so far been tested in this way and it was shown not to undergo significant aggregation (36). This suggests that the two apparent failures of the computational method are actually due to problems with the experimental data; support for this idea comes from the seemingly random distribution of ‘inhibited’ kinases among the branches of the computed phylogenetic trees (FIG. 5). These can be resolved by the use of computational estimates of binding affinities to identify suspect experimental data.

### G. REFERENCES

1. Hardman, J. G., Limbird, L. E., & Gilman, A. G. The Pharmacological Basis of Therapeutics McGraw-Hill, New York, N.Y. (2001).
2. Tuveson, D. A., Willis, N. A., Jacks, T., Griffin, J. D., Singer, S., Fletcher, C. D. M., Fletcher, J. A., & Demetri, G. D. (2001) Oncogene 20, 5054-5058.
3. Zhu, H., & Snyder, M. (2003) Curr. Opin. Chem. Biol. 7, 55-63.
4. Godl, K., Wissing, J., Kurtenbach, A., Habenberger, P., Blencke, S., Gutbrod, H., Salassidis, K., Stein-Gerlach, M., Missio, A., Cotton, M., & Daub, H. (2003) Proc. Natl. Acad. Sci. USA 100, 15434-15439.
5. Dunbrack, R. L. (2002) Curr. Opin. Struct. Biol. 12, 431-440.
6. Manning, G., Whyte, D. B., Martinez, R., Hunter, T., & Sudarsanam, S. (2002) Science 298, 1912-1934.
7. Cohen, P. (2002) Nat. Rev. Drug Discov. 1, 309-315.
8. Woolfrey, J. R., Weston, G. S. (2002) Curr. Pharm. Design 8, 1527-1545.
9. Davies, S. P., Reddy, H., Caivano, M., & Cohen, P. (2000) Biochem. J. 351, 95-105.
10. Fox, T., Coll, J. T., Xie, X., Ford, P. J., Germann, U. A., Porter, M. D., Pazhanisamy, S., Fleming, M. A., Galullo, V., Su, M. S. S., & Wilson, K. P. (1998) Protein Sci. 7, 2249-2255.
11. Engh, R. A., Girod, A., Kinzel, V., Huber, R., & Bossemeyer, D. (1996) J. Biol. Chem. 271, 26157-26164.
12. Gray, N. S., Wodicka, L., Thunnissen, A.-M. W. H., Norman, T. C., Kwon, S., Espinoza, F. H., Morgan, D. O., Barnes, G., LeClerc, S., Meijer, L., Kim, S.-H., Lockhart, D. J., & Schultz, P. G. (1998) Science 281, 533-538.
13. Meijer, L., Thunnissen, A.-M. W. H., White, A. W., Garnier, M., Nikolic, M., Tsai, L.-H., Walter, J., Cleverley, K. E., Salinas, P. C., Wu, Y.-Z., Biernat, J., Mandelkow, E.-M., Kim, S.-H., & Pettit, G. R. (2000) Chem. Biol. 7, 51-63.
14. Nagar, B., Hantschel, O., Young, M. A., Scheffzek, K., Veach, D., Bornmann, V., Clarkson, B., Superti-Furga, G., & Kuriyan, J. (2003) Cell 112, 859-871.
15. Davies, T. G., Tunnah, P., Meijer, L., Marko, D., Eisenbrand, G., Endicott, J. A., & Noble, M. E. M. (2001) Structure 9, 389-397.
16. Sicheri, F., Moarefi, I., & Kuriyan, J. (1997) Nature 385, 602-609.
17. van Aalten, D. M. F., Bywater, R., Findlay, J. B. C., Hendlich, M., Hooft, R. W. W., & Vriend, G. (1996) J. Comput. Aid. Mol. Design 10, 255-262.
18. Bain, J., McLauchlan, H., Elliott, M., & Cohen, P. (2003) Biochem. J. 371, 199-204.
19. Druker, B. J., Tamura, S., Buchdunger, E., Ohno, S., Segal, G. M., Fanning, S., Zimmermann, J., & Lydon, N. B. (1996)Nat. Med. 2,561-566.
20. Roskoski Jr., R. (2003)Biochem. Biophys. Res. Commun. 309,709-717.
21. Buzko, O., & Shokat, K. M. (2002) Bioinformatics 18, 1274-1275.
22. Thompson, J. D., Higgins, D. G., & Gibson, T. J. (1994) Nucleic Acids Res. 22, 4673-4680.
23. Canutescu, A. A., Shelenkov, A. A., & Dunbrack, R. L. (2003) Protein Sci. 12,2001-2014.
24. Vriend, G. (1990)J. Mol. Graph. 8, 52-52.
25. Allen, M. P., & Tildesley, D. J. Computer Simulation of Liquids Clarendon Press, Oxford Science Publications, Oxford, UK (1987).
26. Xiang, Z. X., & Honig, B. (2001) J. Mol. Biol. 311,421-430.
27. Sitkoff, D., Sharp, K. A., & Honig, B. (1994) J. Phys. Chem. 98, 1978-1988.
28. Metropolis, N., Rosenbluth, A. W., Rosenbluth, M. N., Teller, A. H., & Teller, E. (1953) J. Chem. Phys. 21, 1087-1093.
29. Wong, C. F., Hünenberger, P. H., Akamine, P., Narayana, N., Diller, T., McCammon, J. A., Taylor, S. S., & Xuong, N.-H. (2002) J. Med. Chem. 44, 1530-1539.
30. Shoichet, B. K., Leach, A. R., & Kuntz, I. D. (1999) Proteins 34, 4-16.
31. Chen, Y. Z., & Zhi, D. G. (2001) Proteins 43, 217-226.
32. Rockey, W. M., & Elcock, A. H. (2002) Proteins 48, 664-671.
33. Sims, P. A., Wong, C. F., & McCammon, J. A. (2003) J. Med. Chem. 46,3314-3325.
34. De Moliner, E., Brown, N. R., & Johnson, L. N. (2003) Eur. J. Biochem. 270, 3174-3181.
35. Schindler, T., Bornmann, W., Pellicena, P., Miller, W. T., Clarkson, B., & Kuriyan, J. (2000) Science 289, 1938-1942.
36. McGovern, S. L., & Shoichet, B. K. (2003) J. Med. Chem. 46, 1478-1483.
37. Honkanen, R. E., Zwiller, J., Moore, R. E., Daily, S. L., Khatra, B. S., Dukelow, M., & Boynton, A. L. (1990) J. Biol. Chem. 265, 19401-19404.
38. Bialojan, C. & Takai, A. (1988) Biochem. J. 256,283-290.

What is claimed is:

1. A method of identifying a target for a molecule comprising the steps: a) modeling the molecule in complex with a known target for the molecule, b) obtaining potential target molecules by selecting potential target molecules with a defined homology to the known target, c) determining the binding affinity of a potential target with the molecule by modeling the potential target with the molecule, wherein side chain rotamers are sampled from a rotamer library during homology modeling.

2. A method of identifying a target for a molecule comprising the steps: a) obtaining a structural model of the molecule and a known target, wherein the known target comprises a known target-molecule binding domain, b) obtaining a potential target by identifying potential targets having a defined homology with the known target, c) performing homology modeling with the identified potential target, wherein during the homology modeling backbone conformations are held identical to the known target, wherein sidechains are sampled from a library of rotamers, and d) calculating a binding energy of the molecule and the identified potential target.

3. The method of claim 2, wherein the homology modeling is performed with only those positions in the potential target that have a cognate position in the known target.

4. The method of claim 2, wherein all residues outside of the known target-molecule binding domain are left out of the modeling process.

5. The method of claim 2, wherein the binding energy is calculated such that positions of the residues close to the molecule in the homology model are sampled using a rotamer library.

6. The method of claim 5, wherein the sampling occurs using Monte Carlo methods.

7. The method of claim 5, wherein the residues within 5 Å of the molecule are sampled.

8. The method of claim 2, wherein the binding energy is calculated by obtaining the total energy of the potential target and molecule system, and wherein the total energy is the sum of the electrostatic and van der Waals forces.

9. The method of claim 8, wherein the electrostatic interaction is calculated by a Debye-Huckel model.

10. The method of claim 9, wherein the Debye Huckel model is calculated using the formula E_{elec}=332.08q₁q₂exp(−κΓ)/εΓ.

11. The method of claim 8, wherein the van der Waals forces are calculated using the formula E_{vdw}=ε{σₐₜₜ¹²/r¹²−σₐₜₜ⁶/r⁶}.

12. The method of claim 8, wherein the van der Waals forces are calculated using the formula E_{vdw}=ε{σᵣₑₚ¹²/r¹²}.

13. The method of claim 8, wherein the binding energy is calculated by obtaining the difference between the energy of the potential target after optimization and the energy of the potential target complexed with the molecule after optimization.

14. The method of claim 8, further comprising selecting a potential target as a candidate target when the binding energy of the potential target complexed with the target is equal to or less than the binding energy of the known target complexed with the molecule.

15. A method of identifying a desired protein-molecule interaction comprising: (a) determining structural information for a protein known to interact with the molecule of interest; (b) identifying which residues of the protein of step a) interact with the molecule; (c) comparing the residues identified in step b) with a database of proteins; (d) selecting proteins having an area of similarity to the residues identified in step b); (e) calculating interaction energies between the proteins of step d) and the molecule of interest; and (f) determining which proteins are capable of interacting in a desired fashion with the molecule of interest.

16. The method of claim 15, wherein the interaction energies are calculated using any one or more of the following: sidechain conformations, electrostatic forces, and van der Waals forces.

17. The method of claim 15, wherein in step c) all possible sidechain conformations are calculated.

18. The method of claim 15, wherein the protein of step a) is a receptor.

19. The method of claim 15, wherein the proteins of step b) are receptors.

20. The method of claim 15, wherein the molecule is a drug.

21. The method of claim 15, wherein the molecule-protein interaction comprises hydrogen bonding.

22. The method of claim 15, wherein structural information of the protein of step a) is known.

23. The method of claim 15, wherein the structural information of the protein of step a) was obtained from a crystal structure.

24. The method of claim 16, wherein the structural information of the protein of step a) was obtained from a solution structure.

25. The method of claim 15, wherein in step b) the residues are compared only for a given region of the proteins.

26. The method of claim 25, wherein the given region is a drug binding site.

27. The method of claim 16, wherein calculating the interaction energy includes calculating electrostatic interaction.

28. The method of claim 27, wherein the electrostatic interaction is calculated by Debye-Huckel model.

29. The method of claim 28, wherein the Debye Huckel model is calculated by using the formula E_{elec}=332.08 q₁q₂exp(−κΓ)/εΓ.

30. The method of claim 16, wherein calculating the interaction energy includes calculating van der Waals forces.

31. The method of claim 30, wherein for interacting pairs in which both atoms are carbon or sulfur, the van der Waals forces are calculated by using the formula E_{vdw}=ε{σₐₜₜ¹²/r¹²−σₐₜₜ⁶/r⁶}.

32. The method of claim 30, wherein for all interacting pairs except those where both atoms are carbon or sulfur, the van der Waals forces are calculated by using the formula E_{vdw}=ε{σᵣₑₚ¹²/r¹²}.

33. The method of claim 15, wherein a Metropolis test is applied to compute molecule-protein interaction.

34. The method of claim 15, wherein a Monte Carlo function is used for sampling of side chain rotamers when calculating interaction energies.

35. A computer system having a processing means, memory means, and a visual display means, the memory means containing sequence information for a protein known to interact with a molecule of interest, and modules containing information to be compared with the sequence information of the protein known to interact with the molecule of interest, and the processing means being operable to compute molecule-protein binding energy using the method of claim 52.

36. A method of making a pharmaceutical comprising a) modeling the pharmaceutical in complex with a known target for the molecule; b) obtaining potential target molecules by selecting potential target molecules with a defined homology to the known target, c) determining the binding affinity of a potential target with the pharmaceutical by modeling the potential target with the pharmaceutical, wherein a Monte Carlo function is used for sampling of side chain rotamers during homology modeling; d) identifying target molecules of the pharmaceutical; e) synthesizing the pharmaceutical;
and f) testing the pharmaceutical for binding to the target molecule.

37. A method of inhibiting a receptor selected from the group consisting of CRK7, SYK, TEC, RET, BMX, ABL, IKKb, TRKA, HER4/ErbB, SgK288, DDR2, TRKB, ARG, TRKC, DDR1, TIE1, FMS, YES, ACK, FGFR2, BLK, FRK, FYN, CSK, ANKRD3, HCK, MST1, SRC, LYN, IKKa, FGR, TXK, NDR2, FLT1, LCK, NDR1, PDGFRa, PDGFRb, FLT4, MST2, and KIT comprising incubating the receptor with the drug imatinib.

38. A method of inhibiting a receptor selected from the group consisting of MUSK, FLT3, CDK2, DYRK1A, FLT4, CDK3, CDC2, KDR, CDKL1, TRKB, CASK, MAK, TRKC, DYRK1B, CDK5, ROR1, PCTAIRE2, TRKA, PCTAIRE1, FLT1, TIE1, RET, CDK7, CDKL3, PDGFRa, ROR2, JAK2, AurA, FGFR2, PCTAIRE3, CDC7, CDKL2, AurC, AurB, GCN2, TLK2, TLK1, CDK9, TIE2, MAP3K4, KIT, MSK1, and PLK2 comprising incubating the receptor with the drug purvanol.

39. A method of inhibiting a receptor selected from the group consisting of FRK, DDR1, BRK, QIK, EphA1, EphB2, DDR2, QSK, EphB3, SRM, EphB1, ACK, EphA6, SIK, MOK, YANK2, EphB4, EphA8, HER4/erbB4, RET, YANK1, YANK3, EphA4, EphA5, GAK, EDFR, PDGFRa, PDGFRb, EphA2, FGR, RIPK3, YES, MLK4, EphA3, LCK, HER2/ErbB2, SRC, BLK, BTK, FYN, LYN, HCK, RIPK2, CSK, ARG, TXK, Domain2_RSK4, p38α, p38β, and CaMKK1 comprising incubating the receptor with the drug SB 203580.

40. The method of claim 37, 38, and 39 further comprising identifying a subject in need of inhibition of the receptor.

41. The method of claim 37, 38, and 39 further comprising identifying a subject having a disease associated with the receptor.

42. A method of characterizing a protein-molecule interaction using the method of claim 1.

43. A method of displaying a representation of a protein-molecule interaction on a computer having a processing means, a memory means, an input means and an output means comprising: receiving the three-dimensional coordinates of atoms of the protein; producing a representation of the protein based upon the received coordinates; and displaying the representation of the protein-molecule interaction on the visual display means, wherein the protein in the protein-molecule interaction comprises a protein which is a homologue of the native target of the molecule.

44. An apparatus comprising:
(a) a system data store capable of storing coordinate sets; and
(b) a system processor in communication with the system data store that carries out the following steps:
(i) modeling a molecule in complex with a known target for the molecule,
(ii) obtaining potential target molecules by selecting potential target molecules with a defined homology to the known target,
(iii) determining the binding affinity of a potential target with the molecule by modeling the potential target with the molecule,
wherein a Monte Carlo function is used for sampling of side chain rotamers during homology modeling.


SEQUENCE LISTING (64 sequences)

SEQ ID NO: 1 - protein, 1130 aa, Artificial Sequence [sequence omitted]

SEQ ID NO: 2 - protein, 1036 aa, Artificial Sequence
  Description of Artificial Sequence/note = synthetic construct
MQPEEGTGWLLELLSEVQLQQYFLRLRDDLNVTRLSHFEYVKNEDLEKIGMGRPGQRRLWEAVKRRKALCKRKSWMSKVFSGKRLEAEFPPHHSQSTFRKTSPAPGGPAGEGPLQSLTCLIGEKDLRLLEKLGDGSFGVVRRGEWDAPSGKTVSVAVKCLKPDVLSQPEAMDDFIREVNAMHSLDHRNLIRLYGVVLTPPMKMVTELAPLGSLLDRLRKHQGHFLLGTLSRYAVQVAEGMGYLESKRFIHRDLAARNLLLATRDLVKIGDFGLMRALPQNDDHYVMQEHRKVPFAWCAPESLKTRTFSHASDTWMFGVTLWEMFTYGQEPWIGLNGSQILHKIDKEGERLPRPEDCPQDIYNVMVQCWAHKPEDRPTFVALRDFLLEAQPTDMRALQDFEEPDKLHIQMNDVITVIEGRAENYWWRGQNTRTLCVGPFPRNVVTSVAGLSAQDISQPLQNSFIHTGHGDSDPRHCWGFPDRIDELYLGNPMDPPDLLSVELSTSRPPQHLGGVKKPTYDPVSEDQDPLSSDFKRLGLRKPGLPRGLWLAKPSARVPGTKASRGSGAEVTLIDFGEEPVVPALRPCPPSLAQLAMDACSLLDETPPQSPTRALPRPLHPTPVVDWDARPLPPPPAYDDVAQDEDDFEICSINSTLVGAGVPAGPSQGQTNYAFVPEQARPPPPLEDNLFLPPQGGGKPPSSAQTAEIFQALQQECMRQLQAPGSPAPSPSPGGDDKPQVPPRVPIPPRPTRPHVQLSPAPPGEEETSQWPGPASPPRVPPREPLSPQGSRTPSPLVPPGSSPLPPRLSSSPGKTMPTTQSFASDPKYATPQVIQAPGAGGPCILPIVRDGKKVSSTHYYLLPERPSYLERYQRFLREAQSPEEPTPLPVPLLLPPPSTPAPAAPTATVRPMPQAALDPKANFSTNNSNPGARPPPPRATARLPQRGCPGDGPEAGRPADKIQMAMVHGVTTEECQAALQCHGWSVQRAAQYLKVEQLFGLGLRPRGECHKVLEMFDWNLEQAGCHLLGSWGPAHHKR

SEQ ID NO: 3 - protein, 2245 aa, Artificial Sequence
  Description of Artificial Sequence/note = synthetic construct
MEPGRGAGPAGMAEPRAKAARPGPQRFLRRSVVESDQEEPPGLEAAEAPGPQPPQPLQRRVLLLCKTRRLIAERARGRPAAPAPAALVAQPGAPGAPADAGPEPVGTQEPGPDPIAAAVETAPAPDGGPREEAAATVRKEDEGAAEAKPEPGRTRRDEPEEEEDDEDDLKAVATSLDGRFLKFDIELGRGSFKTVYKGLDTETWVEVAWCELQDRKLTKLERQRFKEEAEMLKGLQHPNIVRFYDFWESSAKGKRCIVLVTELMTSGTLKTYLKRFKVMKPKVLRSWCRQILKGLLFLHTRTPPIIHRDLKCDNIFITGPTGSVKIGDLGLATLKRASFAKSVIGTPEFMAPEMYEEHYDESVDVYAFGMCMLEMATSEYPYSECQNAAQIYRKVTCGIKPASFEKVHDPEIKEIIGECICKNKEERYEIKDLLSHAFFAEDTGVRVELAEEDHGRKSTIALRLWVEDPKKLKGKPKDNGAIEFTFDLEKETPDEVAQEMIESGFFHESDVKIVAKSIRDRVALIQWRRERIWPALQPKEQQDVGSPDKARGPPVPLQVQVTYHAQAGQPGPPEPEEPEADQHLLPPTLPTSATSLASDSTFDSGQGSTVYSDSQSSQQSVMLGSLADAAPSPAQCVCSPPVSEGPVLPQSLPSLGAYQQPTAAPGLPVGSVPAPACPPSLQQHFPDPAMSFAPVLPPPSTPMPTGPGQPAPPGQQPPPLAQPTPLPQVLAPQPVVPLQPVPPHLPPYLAPASQVGAPAQLKPLQMPQAPLQPLAQVPPQMPPIPVVPPITPLAGIDGLPPALPDLPTATVPPVPPPQYFSPAVILPSLAAPLPPASPALPLQAVKLPHPPGAPLAMPCRTIVPNAPATIPLLAVAPPGVAALSIHSAVAQLPGQPVYPAAFPQMAPTDVPPSPHHTVQNMRATPPQPALPPQPTLPPQPVLPPQPTLPPQPVLPPQPTRPPQPVLPPQPMLPPQPVLPPQPALPVRPEPLQPHLPEQAAPAATPGSQILLGHPAPYAVDVAAQVPTVPVPPAAVLSPPLPEVLLPAAPELLPQFPSSLATVSASVQSVPTQTATLLPPANPPLPGGPGIASPCPTVQLTVEPVQEEQASQDKPPGLPQSCESYGGSDVTSGKELSDSCEGAFGGGRLEGRAARKHHRRSTRARSRQERASRPRLTILNVCNTGDKMVECQLETHNHKMVTFKFDLDGDAPDEIATYMVEHDFILQAERETFIEQMKDVMDKAEDMLSEDTDADRGSDPGTSPPHLSTCGLGTGEESRQSQANAPVYQQNVLHTGKRWFIICPVAEHPAPEAPESSPPLPLSSLPPEASQDSAPYKDQLSSKEQPSFLASQQLLSQAGPSNPPGAPPAPLAPSSPPVTALPQDGAAPATSTMPEPASGTASQAGGPGTPQGLTSELETSQPLAETHEAPLAVQPLVVGLAPCTPAPEAASTRDASAPREPLPPPAPEPSPHSGTPQPALGQPAPLLPAAVGAVSLATSQLPSPPLGPTVPPQPPSALESDGEGPPPRVGFVDSTIKSLDEKLRTLLYQEHVPTSSASAGTPVEVGDRDFTLEPLRGDQPRSEVCGGDLALPPVPKEAVSGRVQLPQPLVEKSELAPTRGAVMEQGTSSSMTESSPRSMLGYDRDGRQVASDSHVVPSVPQDVPAFVRPARVEPTDRDGGEAGESSAEPPPSDMGTVGGQASHPQTLGARALGSPRKRPEQQDVSSPAKTVGRFSVVSTQDEWTLASPHSLRYSAPPDVYLDEAPSSPDVKLAVRRAQTASSIEVGVGEPVSSDSGDEGPRARPPVQKQASLPVSGSVAGDFVKKATAFLQRPSRAGSLGPETPSRVGMKVPTISVTSFHSQSSYISSDNDSELEDADIKKELQSLREKHLKEISELQSQQKQEIEALYRRLGKPLPPNVGFFHTAPPTGRRRKTSKSKLKAGKLLNPLVRQLKVVASSTGHLADSSRGPPAKDPAQASVGLTADSTGLSGKAVQTQQPCSVRASLSSDICSGLASDGGGARGQGWTVYHPTSERVTYKSSSKPRARFLSGPVSVSIWSALKRLCLGKEHSSRSSTSSLAPGPEPGPQPALHVQAQVNNSNNKKGTFTDDLHKLVDEWTSKTVGAAQLKPTLNQLKQTQKLQDMEAQAGWAAPGEARAMTAPRAGVGMPRLPPAPGPLSTTVIPGAAPTLSVPTPDGALGTARRNQVWFGLRVPPTACCGHSTQPRGGQRVGSKTASFAASDPVRS

SEQ ID NO: 4 - protein, 505 aa, Artificial Sequence [sequence omitted]

SEQ ID NO: 5 - protein, 972 aa, Artificial Sequence
  Description of Artificial Sequence/note = synthetic construct
MGPGVLLLLLVATAWHGQGIPVIEPSVPELVVKPGATVTLRCVGNGSVEWDGPPSPHWTLYSDGSSSILSTNNATFQNTGTYRCTEPGDPLGGSAAIHLYVKDPARPWNVLAQEVVVFEDQDALLPCLLTDPVLEAGVSLVRVRGRPLMRHTNYSFSPWHGFTIHRAKFIQSQDYQCSALMGGRKVMSISIRLKVQKVIPGPPALTLVPAELVRIRGEAAQIVCSASSVDVNFDVFLQHNNTKLAIPQQSDFHNNRYQKVLTLNLDQVDFQHAGNYSCVASNVQGKHSTSMFFRVVESAYLNLSSEQNLIQEVTVGEGLNLKVMVEAYPGLQGFNWTYLGPFSDHQPEPKLANATTKDTYRHTFTLSLPRLKPSEAGRYSFLARNPGGWRALTFELTLRYPPEVSVIWTFINGSGTLLCAASGYPQPNVTWLQCSGHTDRCDEAQVLQVWDDPYPEVLSQEPFHKVTVQSLLTVETLEHNQTYECRAHNSVGSGSWAFIPISAGAHTHPPDEFLFTPVVVACMSIMALLLLLLLLLLYKYKQKPKYQVRWKIIESYEGNSYTFIDPTQLPYNEKWEFPRNNLQFGKTLGAGAFGKVVEATAFGLGKEDAVLKVAVKMLKSTAHADEKEALMSELKIMSHLGQHENIVNLLGACTHGGPVLVITEYCCYGDLLNFLRRKAEAMLGPSLSPGQDPEGGVDYKNIHLEKKYVRRDSGFSSQGVDTYVEMRPVSTSSNDSFSEQDLDKEDGRPLELRDLLHFSSQVAQGMAFLASKNCIHRDVAARNVLLTNGHVAKIGDFGLARDIMNDSNYIVKGNARLPVKWMAPESIFDCVYTVQSDVWSYGILLWEIFSLGLNPYPGILVNSKFYKLVKDGYQMAQPAFAPKNIYSIMQACWALEPTHRPTFQQICSFLQEQAQEDRRERDYTNLPSSSRSGGSGSSSSELEEESSSEHLTCCEQGDIAQPLLQPNNYQFC

SEQ ID NO: 6 - protein, 450 aa, Artificial Sequence
  Description of Artificial Sequence/note = synthetic construct
MSAIQAAWPSGTECIAKYNFHGTAEQDLPFCKGDVLTIVAVTKDPNWYKAKNKVGREGIIPANYVQKREGVKAGTKLSLMPWFHGKITREQAERLLYPPETGLFLVRESTNYPGDYTLCVSCDGKVEHYRIMYHASKLSIDEEVYFENLMQLVEHYTSDADGLCTRLIKPKVMEGTVAAQDEFYRSGWALNMKELKLLQTIGKGEFGDVMLGDYRGNKVAVKCIKNDATAQAFLAEASVMTQLRHSNLVQLLGVIVEEKGGLYIVTEYMAKGSLVDYLRSRGRSVLGGDCLLKFSLDVCEAMEYLEGNNFVHRDLAARNVLVSEDNVAKVSDFGLTKEASSTQDTGKLPVKWTAPEALREKKFSTKSDVWSFGILLWEIYSFGRVPYPRIPLKDVVPRVEKGYKMDAPDGCPPAVYEVMKNCWHLDAAMRPSFLQLREQLEHIKTHELHL

SEQ ID NO: 7 - protein, 1052 aa, Artificial Sequence
  Description of Artificial Sequence/note = synthetic construct
MAAAYLDPNLNHTPNSSTKTHLGTGMERSPGAMERVLKVFHYFESNSEPTTWASIIRHGDATDVRGIIQKIVDSHKVKHVACYGFRLSHLRSEEVHWLHVDMGVSSVREKYELAHPPEEWKYELRIRYLPKGFLNQFTEDKPTLNFFYQQVKSDYMLEIADQVDQEIALKLGCLEIRRSYWEMRGNALEKKSNYEVLEKDVGLKRFFPKSLLDSVKAKTLRKLIQQTFRQFANLNREESILKFFEILSPVYRFDKECFKCALGSSWIISVELAIGPEEGISYLTDKGCNPTHLADFTQVQTIQYSNSEDKDRKGMLQLKIAGAPEPLTVTAPSLTIAENMADLIDGYCRLVNGTSQSFIIRPQKEGERALPSIPKLANSEKQGMRTHAVSVSETDDYAEIIDEEDTYTMPSTRDYEIQRERIELGRCIGEGQFGDVHQGIYMSPENPALAVAIKTCKNCTSDSVREKFLQEALTMRQFDHPHIVKLIGVITENPVWIIMELCTLGELRSFLQVRKYSLDLASLILYAYQLSTALAYLESKRFVHRDIAARNVLVSSNDCVKLGDFGLSRYMEDSTYYKASKGKLPIKWMAPESINFRRFTSASDVWMFGVCMWEILMHGVKPFQGVKNNDVIGRIENGERLPMPPNCPPTLYSLMTKCWAYDPSRRPRFTELKAQLSTILEEEKAQQEERMRMESRRQATVSWDSGGSDEAPPKPSRPGYPSPRSSEGFYPSPQHMVQTNHYQVSGYPGSHGITAMAGSIYPGQASLLDQTDSWNHRPQEIAMWQPNVEDSTVLDLRGIGQVLPTHLMEERLIRQQQEMEEDQRWLEKEERFLKPDVRLSRGSIDREDGSLQGPIGNQHIYQPVGKPDPAAPPKKPPRPGAPGHLGSLASLSSPADSYNEGVKLQPQEISPPPTANLDRSNDKVYENVTGLVKAVIEMSSKIQPAPPEEYVPMVKEVGLALRTLLATVDETIPLLPASTHREIEMAQKLLNSDLGELINKMKLAQQYVMTSLQQEYKKQMLTAAHALAVDAKNLLDVIDQARLKMLGQTRPH

SEQ ID NO: 8 - protein, 821 aa, Artificial Sequence
  Description of Artificial Sequence/note = synthetic construct
MVSWGRFICLVVVTMATLSLARPSFSLVEDTTLEPEEPPTKYQISQPEVYVAAPGESLEVRCLLKDAAVISWTKDGVHLGPNNRTVLIGEYLQIKGATPRDSGLYACTASRTVDSETWYFMVNVTDAISSGDDEDDTDGAEDFVSENSNNKRAPYWTNTEKMEKRLHAVPAANTVKFRCPAGGNPMPTMRWLKNGKEFKQEHRIGGYKVRNQHWSLIMESVVPSDKGNYTCVVENEYGSINHTYHLDVVERSPHRPILQAGLPANASTVVGGDVEFVCKVYSDAQPHIQWIKHVEKNGSKYGPDGLPYLKVLKAAGVNTTDKEIEVLYIRNVTFEDAGEYTCLAGNSIGISFHSAWLTVLPAPGREKEITASPDYLEIAIYCIGVFLIACMVVTVILCRMKNTTKKPDFSSQPAVHKLTKRIPLRRQVTVSAESSSSMNSNTPLVRITTRLSSTADTPMLAGVSEYELPEDPKWEFPRDKLTLGKPLGEGCFGQVVMAEAVGIDKDKPKEAVTVAVKMLKDDATEKDLSDLVSEMEMMKMIGKHKNIINLLGACTQDGPLYVIVEYASKGNLREYLRARRPPGMEYSYDINRVPEEQMTFKDLVSCTYQLARGMEYLASQKCIHRDLAARNVLVTENNVMKIADFGLARDINNIDYYKKTTNGRLPVKWMAPEALFDRVYTHQSDVWSFGVLMWEIFTLGGSPYPGIPVEELFKLLKEGHRMDKPANCTNELYMMMRDCWHAVPSQRPTFKQLVEDLDRILTLTTNEEYLDLSQPLEQYSPSYPDTRSSCSSGDDSVFSPDPMPYEPCLPQYPHINGSVKT

SEQ ID NO: 9 - protein, 802 aa, Artificial Sequence [sequence omitted]

SEQ ID NO: 10 - protein, 529 aa, Artificial Sequence
  Description of Artificial Sequence/note = synthetic construct
MGCVFCKKLEPVATAKEDAGLEGDFRSYGAADHYGPDPTKARPASSFAHIPNYSNFSSQAINPGFLDSGTIRGVSGIGVTLFIALYDYEARTEDDLTFTKGEKFHILNNTEGDWWEARSLSSGKTGCIPSNYVAPVDSIQAEEWYFGKIGRKDAERQLLSPGNPQGAFLIRESETTKGAYSLSIRDWDQTRGDHVKHYKIRKLDMGGYYITTRVQFNSVQELVQHYMEVNDGLCNLLIAPCTIMKPQTLGLAKDAWEISRSSITLERRLGTGCFGDVWLGTWNGSTKVAVKTLKPGTMSPKAFLEEAQVMKLLRHDKLVQLYAVVSEEPIYIVTEFMCHGSLLDFLKNPEGQDLRLPQLVDMAAQVAEGMAYMERMNYIHRDLRAANILVGERLACKIADFGLARLIKDDEYNPCQGSKFPIKWTAPEAALFGRFTIKSDVWSFGILLTELITKGRIPYPGMNKREVLEQVEQGYHMPCPPGCPASLYEAMEQTWRLDPEERPTFEYLQSFLEDYFTSAEPQYQPGDQT

SEQ ID NO: 11 - protein, 1338 aa, Artificial Sequence
  Description of Artificial Sequence/note = synthetic construct
MVSYWDTGVLLCALLSCLLLTGSSSGSKLKDPELSLKGTQHIMQAGQTLHLQCRGEAAHKWSLPEMVSKESERLSITKSACGRNGKQFCSTLTLNTAQANHTGFYSCKYLAVPTSKKKETESAIYIFISDTGRPFVEMYSEIPEIIHMTEGRELVIPCRVTSPNITVTLKKFPLDTLIPDGKRIIWDSRKGFIISNATYKEIGLLTCEATVNGHLYKTNYLTHRQTNTIIDVQISTPRPVKLLRGHTLVLNCTATTPLNTRVQMTWSYPDEKNKRASVRRRIDQSNSHANIFYSVLTIDKMQNKDKGLYTCRVRSGPSFKSVNTSVHIYDKAFITVKHRKQQVLETVAGKRSYRLSMKVKAFPSPEVVWLKDGLPATEKSARYLTRGYSLIIKDVTEEDAGNYTILLSIKQSNVFKNLTATLIVNVKPQIYEKAVSSFPDPALYPLGSRQILTCTAYGIPQPTIKWFWHPCNHNHSEARCDFCSNNEESFILDADSNMGNRIESITQRMAIIEGKNKMASTLVVADSRISGIYICIASNKVGTVGRNISFYITDVPNGFHVNLEKMPTEGEDLKLSCTVNKFLYRDVTWILLRTVNNRTMHYSISKQKMAITKEHSITLNLTIMNVSLQDSGTYACRARNVYTGEEILQKKEITIRDQEAPYLLRNLSDHTVAISSSTTLDCHANGVPEPQITWFKNNHKIQQEPGIILGPGSSTLFIERVTEEDEGVYHCKATNQKGSVESSAYLTVQGTSDKSNLELITLTCTCVAATLFWLLLTLLIRKMKRSSSEIKTDYLSIIMDPDEVPLDEQCERLPYDASKWEFARERLKLGKSLGRGAFGKVVQASAFGIKKSPTCRTVAVKMLKEGATASEYKALMTELKILTHIGHHLNVVNLLGACTKQGGPLMVIVEYCKYGNLSNYLKSKRDLFFLNKDAALHMEPKKEKMEPGLEQGKKPRLDSVTSSESFASSGFQEDKSLSDVEEEEDSDGFYKEPITMEDLISYSFQVARGMEFLSSRKCIHRDLAARNILLSENNVVKICDFGLARDIYKNPDYVRKGDTRLPLKWMAPESIFDKIYSTKSDVWSYGVLLWEIFSLGGSPYPGVQMDEDFCSRLREGMRMRAPEYSTPEIYQIMLDCWHRDPKERPRFAELVEKLGDLLQANVQQDGKDYIPINAILTGNSGFTYSTPAFSEDFFKESISAPKFNSGSSDDVRYVNAFKFMSLERIKTFEELLPNATSMFDDYQGDSSTLLASPMLKRFTWTDSKPKASLKIDLRVTSKSKESGLSDVSRPSFCHSSCGHVSEGKRRFTYDHAELERKIACCSPPPDYNSVVLYSTPPI

SEQ ID NO: 12 - protein, 1298 aa, Artificial Sequence
  Description of Artificial Sequence/note = synthetic construct
MQRGAALCLRLWLCLGLLDGLVSGYSMTPPTLNITEESHVIDTGDSLSISCRGQHPLEWAWPGAQEAPATGDKDSEDTGVVRDCEGTDARPYCKVLLLHEVHANDTGSYVCYYKYIKARIEGTTAASSYVFVRDFEQPFINKPDTLLVNRKDAMWVPCLVSIPGLNVTLRSQSSVLWPDGQEVVWDDRRGMLVSTPLLHDALYLQCETTWGDQDFLSNPFLVHITGNELYDIQLLPRKSLELLVGEKLVLNCTVWAEFNSGVTFDWDYPGKQAERGKWVPERRSQQTHTELSSILTIHNVSQHDLGSYVCKANNGIQRFRESTEVIVHENPFISVEWLKGPILEATAGDELVKLPVKLAAYPPPEFQWYKDGKALSGRHSPHALVLKEVTEASTGTYTLALWNSAAGLRRNISLELVVNVPPQIHEKEASSPSIYSRHSRQALTCTAYGVPLPLSIQWHWRPWTPCKMFAQRSLRRRQQQDLMPQCRDWRAVTTQDAVNPIESLDTWTEFVEGKNKTVSKLVIQNANVSAMYKCVVSNKVGQDERLIYFYVTTIPDGFTIESKPSEELLEGQPVLLSCQADSYKYEHLRWYRLNLSTLHDAHGNPLLLDCKNVHLFATPLAASLEEVAPGARHATLSLSIPRVAPEHEGHYVCEVQDRRSHDKHCHKKYLSVQALEAPRLTQNLTDLLVNVSDSLEMQCLVAGAHAPSIVWYKDERLLEEKSGVDLADSNQKLSIQRVREEDAGRYLCSVCNAKGCVNSSASVAVEGSEDKGSMEIVILVGTGVIAVFFWVLLLLIFCNMRRPAHADIKTGYLSIIMDPGEVPLEEQCEYLSYDASQWEFPRERLHLGRVLGYGAFGKVVEASAFGIHKGSSCDTVAVKMLKEGATASEHRALMSELKILIHIGNHLNVVNLLGACTKPQGPLMVIVEFCKYGNLSNFLRAKRDAFSPCAEKSPEQRGRFRAMVELARLDRRRPGSSDRVLFARFSKTEGGARRASPDQEAEDLWLSPLTMEDLVCYSFQVARGMEFLASRKCIHRDLAARNILLSESDVVKICDFGLARDIYKDPDYVRKGSARLPLKWMAPESIFDKVYTTQSDVWSFGVLLWEIFSLGASPYPGVQINEEFCQRLRDGTRMRAPELATPAIRRIMLNCWSGDPKARPAFSELVEILGDLLQGRGLQEEEEVCMAPRSSQSSEEGSFSQVSTMALHIAQADAEDSPPSLQRHSLAARYYNWVSFPGCLARGAETRGSSRMKTFEEFPMTPTTYKGSVDNQTDSGMVLASEEFEQIESRHRQESGFR

SEQ ID NO: 13 - protein, 537 aa, Artificial Sequence
  Description of Artificial Sequence/note = synthetic construct
MGCVQCKDKEATKLTEERDGSLNQSSGYRYGTDPTPQHYPSFGVTSIPNYNNFHAAGGQGLTVFGGVNSSSHTGTLRTRGGTGVTLFVALYDYEARTEDDLSFHKGEKFQILNSSEGDWWEARSLTTGETGYIPSNYVAPVDSIQAEEWYFGKLGRKDAERQLLSFGNPRGTFLIRESETTKGAYSLSIRDWDDMKGDHVKHYKIRKLDNGGYYITTRAQFETLQQLVQHYSERAAGLCCRLVVPCHKGMPRLTDLSVKTKDVWEIPRESLQLIKRLGNGQFGEVWMGTWNGNTKVAIKTLKPGTMSPESFLEEAQIMKKLKHDKLVQLYAVVSEEPIYIVTEYMNKGSLLDFLKDGEGRALKLPNLVDMAAQVAAGMAYIERMNYIHRDLRSANILVGNGLICKIADFGLARLIEDNEYTARQGAKFPIKWTAPEAALYGRFTIKSDVWSFGILLTELVTKGRVPYPGMNNREVLEQVERGYRMPCPQDCPISLHELMIHCWKKDPEERPTFEYLQSFLEDYFTATEPQYQPGENL

SEQ ID NO: 14 - protein, 526 aa, Artificial Sequence
  Description of Artificial Sequence/note = synthetic construct
MGGRSSCEDPGCPRDEERAPRMGSMKSKFLQVGGNTFSKTETSASPHCPVYVPDPTSTIKPGPNSHNSNTPGIREAGSEDIIVVALYDYEAIHHEDLSFQKGDQMVVLEESGEWWKARSLATRKEGYIPSNYVARVDSLETEEWFFKGISRKDAERQLLAPGNMLGSFMIRDSETTKGSYSLSVRDYDPRQGDTVKHYKIRTLDNGGFYISPRSTFSTLQELVDHYKKGNDGLCQKLSVPCMSSKPQKPWEKDAWEIPRESLKLEKKLGAGQFGEVWMATYNKHTKVAVKTMKPGSMSVEAFLAEANVMKTLQHDKLVKLHAVVTKEPIYIITEFMAKGSLLDFLKSDEGSKQPLPKLIDFSAQIAEGMAFIEQRNYIHRDLRAANILVSASLVCKIADFGLARVIEDNEYTAREGAKFPIKWTAPEAINFGSFTIKSDVWSFGILLMEIVTYGRIPYPGMSNPEVIRALERGYRMPRPENCPEELYNIMMRCWKNRPEERPTFEYIQSVLDDFYTATESQYQQQP

SEQ ID NO: 15 - protein, 1308 aa, Artificial Sequence
  Description of Artificial Sequence/note = synthetic construct
MKPATGLWVWVSLLVAAGTVQPSDSQSVCAGTENKLSSLSDLEQQYRALRKYYENCEVVMGNLEITSIEHNRDLSFLRSVREVTGYVLVALNQFRYLPLENLRIIRGTKLYEDRYALAIFLNYRKDGNFGLQELGLKNLTEILNGGVYVDQNKFLCYADTIHWQDIVRNPWPSNLTLVSTNGSSGCGRCHKSCTGRCWGPTENHCQTLTRTVCAEQCDGRCYGPYVSDCCHRECAGGCSGPKDTDCFACMNFNDSGACVTQCPQTFVYNPTTFQLEHNFNAKYTYGAFCVKKCPHNFVVDSSSCVRACPSSKMEVEENGIKMCKPCTDICPKACDGIGTGSLMSAQTVDSSNIDKFINCTKINGNLIFLVTGIHGDPYNAIEAIDPEKLNVFRTVREITGFLNIQSWPPNMTDFSVFSNLVTIGGRVLYSGLSLLILKQQGITSLQFQSLKEISAGNIYITDNSNLCYYHTINWTTLFSTINQRIVIRDNRKAENCTAEGMVCNHLCSSDGCWGPGPDQCLSCRRFSRGRICIESCNLYDGEFREFENGSICVECDPQCEKMEDGLLTCHGPGPDNCTKCSHFKDGPNCVEKCPDGLQGANSFIFKYADPDRECHPCHPNCTQGCNGPTSHDCIYYPWTGHSTLPQHARTPLIAAGVIGGLFILVIVGLTFAVYVRRKSIKKKRALRRFLETELVEPLTPSGTAPNQAQLRILKETELKRVKVLGSGAFGTVYKGIWVPEGETVKIPVAIKILNETTGPKANVEFMDEALIMASMDHPHLVRLLGVCLSPTIQLVTQLMPHGCLLEYVHEHKDNIGSQLLLNWCVQIAKGMMYLEERRLVHRDLAARNVLVKSPNHVKITDFGLARLLEGDEKEYNADGGKMPIKWMALECIHYRKFTHQSDVWSYGVTIWELMTFGGKPYDGIPTREIPDLLEKGERLPQPPICTIDVYMVMVKCWMIDADSRPKFKELAAEFSRMARDPQRYLVIQGDDRMKLPSPNDSKFFQNLLDEEDLEDMMDAEEYLVPQAFNIPPPIYTSRARIDSNRSEIGHSPPPAYTPMSGNQFVYRDGGFAAEQGVSVPYRAPTSTIPEAPVAQGATAEIFDDSCCNGTLRKPVAPHVQEDSSTQRYSADPTVFAPERSPRGELDEEGYMTPMRDKPKQEYLNPVEENPFVSRRKNGDLQALDNPEYHNASNGPPKAEDEYVNEPLYLNTFANTLGKAEYLKNNILSMPEKAKKAFDNPDYWNHSLPPRSTLQHPDYLQEYSTKYFYKQNGRIRPIVAENPEYLSEFSLKPGTVLPPPPYRHRNTVV

SEQ ID NO: 16 - protein, 745 aa, Artificial Sequence
  Description of Artificial Sequence/note = synthetic construct
MERPPGLRPGAGGPWEMRERLGTGGFGNVCLYQHRELDLKIAIKSCRLELSTKNRERWCHEIQIMKKLNHANVVKACDVPEELNILIHDVPLLAMEYCSGGDLRKLLNKPENCCGLKESQILSLLSDIGSGIRYLHENKIIHRDLKPENIVLQDVGGKIIHKIIDLGYAKDVDQGSLCTSFVGTLQYLAPELFENKPYTATVDYWSFGTMVFECIAGYRPFLHHLQPFTWHEKIKKKDPKCIFACEEMSGEVRFSSHLPQPNSLCSLIVEPMENWLQLMLNWDPQQRGGPVDLTLKQPRCFVLMDHILNLKIVHILNMTSAKIISFLLPPDESLHSLQSRIERETGINTGSQELLSETGISLDPRKPASQCVLDGVRGCDSYMVYLFDKSKTVYEGPFASRSLSDCVNYIVQDSKIQLPIIQLRKVWAEAVHYVSGLKEDYSRLFQGQRAAMLSLLRYNANLTKMKNTLISASQQLKAKLEFFHKSIQLDLERYSEQMTYGISSEKMLKAWKEMEEKAIHYAEVGVIGYLEDQIMSLHAEIMGLQKSPYGRRQGDLMESLEQRAIDLYKQLKHRPSDHSYSDSTEMVKIIVHTVQSQDRVLKELFGHLSKLLGCKQKIIDLLPKVEVALSNIKEADNTVMFMQGKRQKEIWHLLKIACTQSSARSLVGSSLEGAVTPQTSAWLPPTSAEHDHSLSCVVTPQDGETSAQMIEENLNCLGHLSTIIHEANEEQGNSMMNLDWSWLTE

SEQ ID NO: 17 - protein, 756 aa, Artificial Sequence
  Description of Artificial Sequence/note = synthetic construct
MSWSPSLTTQTCGAWEMKERLGTGGFGNVIRWHNQETGEQIAIKQCRQELSPRNRERWCLEIQIMRRLTHPNVVAARDVPEGMQNLAPNDLPLLAMEYCQGGDLRKYLNQFENCCGLREGAILTLLSDIASALRYLHENRIIHRDLKPENIVLQQGEQRLIHKIIDLGYAKELDQGSLCTSFVGTLQYLAPELLEQQKYTVTVDYWSFGTLAFECITGFRPFLPNWQPVQWHSKVRQKSEVDIVVSEDLNGTVKFSSSLPYPNNLNSVLAERLEKWLQLMLMWHPRQRGTDPTYGPNGCFKALDDILNLKLVHILNMVTGTIHTYPVTEDESLQSLKARIQQDTGIPEEDQELLQEAGLALIPDKPATQCISDGKLNEGHTLDMDLVFLFDNSKITYETQISPRPQPESVSCILQEPKRNLAFFQLRKVWGQVWHSIQTLKEDCNRLQQGQRAAMMNLLRNNSCLSKMKNSMASMSQQLKAKLDFFKTSIQIDLEKYSEQTEFGITSDKLLLAWREMEQAVELCGRENEVKLLVERMMALQTDIVDLQRSPMGRKQGGTLDDLEEQARELYRRLREKPRDQRTEGDSQEMVRLLLQAIQSFEKKVRVIYTQLSKTVVCKQKALELLPKVEEVVSLMNEDEKTVVRLQEKRQKELWNLLKIACSKVRGPVSGSPDSMNASRLSQPGQLMSQPSTASNSLPEPAKKSEELVAEAHNLCTLLENAIQDTVREQDQSFTALDWSWLQTEEEEHSCLEQAS

SEQ ID NO: 18 - protein, 976 aa, Artificial Sequence [sequence omitted]

SEQ ID NO: 19 - protein, 509 aa, Artificial Sequence
  Description of Artificial Sequence/note = synthetic construct
MGCGCSSHPEDDWMENIDVCENCHYPIVPLDGKGTLLIRNGSEVRDPLVTYEGSNPPASPLQDNLVIALHSYEPSHDGDLGFEKGEQLRILEQSGEWWKAQSLTTGQEGFIPFNFVAKANSLEPEPWFFKNLSRKDAERQLLAPGNTHGSFLIRESESTAGSFSLSVRDFDQNQGEVVKHYKIRNLDNGGFYISPRITFPGLHELVRHYTNASDGLCTRLSRPCQTQKPQKPWWEDEWEVPRETLKLVERLGAGQFGEVWMGYYNGHTKVAVKSLKQGSMSPDAFLAEANLMKQLQHQRLVRLYAVVTQEPIYIITEYMENGSLVDFLKTPSGIKLTINKLLDMAAQIAEGMAFIEERNYIHRDLRAANILVSDTLSCKIADFGLARLIEDNEYTAREGAKFPIKWTAPEAINYGTFTIKSDVWSFGILLTEIVTHGRIPYPGMTNPEVIQNLERGYRMVRPDNCPEELYQLMRLCWKERPEDRPTFDYLRSVLEDFFTATEGQYQPQP

SEQ ID NO: 20 - protein, 512 aa, Artificial Sequence
  Description of Artificial Sequence/note = synthetic construct
MGCIKSKGKDSLSDDGVDLKTQPVRNTERTIYVRDPTSNKQQRPVPESQLLPGQRFQTKDPEEQGDIVVALYPYDGIHPDDLSFKKGEKMKVLEEHGEWWKAKSLLTKKEGFIPSNYVAKLNTLETEEWFFKDITRKDAERQLLAPGNSAGAFLIRESETLKGSFSLSVRDFDPVHGDVIKHYKIRSLDNGGYYISPRITFPCISDMIKHYQKQADGLCRRLEKACISPKPQKPWDKDAWEIPRESIKLVKRLGAGQFGEVWMGYYNNSTKVAVKTLKPGTMSVQAFLEEANLMKTLQHDKLVRLYAVVTREEPIYIITEYMAKGSLLDFLKSDEGGKVLLPKLIDFSAQIAEGMAYIERKNYIHRDLRAANVLVSESLMCKIADFGLARVIEDNEYTAREGAKFPIKWTAPEAINFGCFTIKSDVWSFGILLYEIVTYGKIPYPGRTNADVMTALSQGYRMPRVENCPDELYDIMKMCWKEKAEERPTFDYLQSVLDDFYTATEGQYQQQP

SEQ ID NO: 21 - protein, 499 aa, Artificial Sequence
  Description of Artificial Sequence/note = synthetic construct
MLERPPALAMPMPTEGTPPPLSGTPIPVPAYFRHAEPGFSLKRPRGLSRSLPPPPPAKGSIPISRLFPPRTPGWHQLQPRRVSFRGEASETLQSPGYDPSRPESFFQQSFQRLSRLGHGSYGEVFKVRSKEDGRLYAVKRSMSPFRGPKDRARKLAEVGSHEKVGQHPCCVRLEQAWEEGGILYLQTELCGPSLQQHCEAWGASLPEAQVWGYLRDTLLALAHLHSQGLVHLDVKPANIFLGPRGRCKLGDFGLLVELGTAGAGEVQEGDPRYMAPELLQGSYGTAADVFSLGLTILEVACNMELPHGGEGWQQLRQGYLPPEFTAGLSSELRSVLVMMLEPDPKLRATAEALLALPVLRQPRAWGVLWCMAAEALSRGWALWQALLALLCWLWHGLAHPASWLQPLGPPATPPGSPPCSLLLDSSLSSNWDDDSLGPSLSPEAVLARTVGSTSTPRSRCTPRDALDLSDINSEPPRGSFPSFEPRNLLSLFEDTLDPT

SEQ ID NO: 22 - protein, 1089 aa, Artificial Sequence
  Description of Artificial Sequence/note = synthetic construct
MGTSHPAFLVLGCLLTGLSLILCQLSLPSILPNENEKVVQLNSSFSLRCFGESEVSWQYPMSEEESSDVEIRNEENNSGLFVTVLEVSSASAAHTGLYTCYYNHTQTEENELEGRHIYIYVPDPDVAFVPLGMTDYLVIVEDDDSAIIPCRTTDPETPVTLHNSEGVVPASYDSRQGFNGTFTVGPYICEATVKGKKFQTIPFNVYALKATSELDLEMEALKTVYKSGETIVVTCAVFNNEVVDLQWTYPGEVKGKGITMLEEIKVPSIKLVYTLTVPEATVKDSGDYECAARQATREVKEMKKVTISVHEKGFIEIKPTFSQLEAVNLHEVKHFVVEVRAYPPPRISWLKNNLTLIENLTEITTDVEKIQEIRYRSKLKLIRAKEEDSGHYTIVAQNEDAVKSYTFELLTQVPSSILDLVDDHHGSTGGQTVRCTAEGTPLPDIEWMICKDIKKCNNETSWTILANNVSNIITEIHSRDRSTVEGRVTFAKVEETIAVRCLAKNLLGAENRELKLVAPTLRSELTVAAAVLVLLVIVIISLIVLVVIWKQKPRYEIRWRVIESISPDGHEYIYVDPMQLPYDSRWEFPRDGLVLGRVLGSGAFGKVVEGTAYGLSRSQPVMKVAVKMLKPTARSSEKQALMSELKIMTHLGPHLNIVNLLGACTKSGPIYIITEYCFYGDLVNYLHKNRDSFLSHHPEKPKKELDIFGLNPADESTRSYVILSFENNGDYMDMKQADTTQYVPMLERKEVSKYSDIQRSLYDRPASYKKKSMLDSEVKNLLSDDNSEGLTLLDLLSFTYQVARGMEFLASKNCVHRDLAARNVLLAQGKIVKICDFGLARDIMHDSNYVSKGSTFLPVKWMAPESIFDNLYTTLSDVWSYGILLWEIFSLGGTPYPGMMVDSTFYNKIKSGYRMAKPDHATSEVYEIMVKCWNSEPEKRPSFYHLSEIVENLLPGQYKKSYEKIHLDFLKSDHPAVARMRVDSDNAYIGVTYKNEEDKLKDWEGGLDEQRLSADSGYIIPLPDIDPVPEEEDLGKRNRHSSQTSEESAIETGSSSSTFIKREDETIEDIDMMDDIGIDSSDLVEDSFL

SEQ ID NO: 23 - protein, 1106 aa, Artificial Sequence
  Description of Artificial Sequence/note = synthetic construct
MRLPGAMPALALKGELLLLSLLLLLEPQISQGLVVTPPGPELVLNVSSTFVLTCSGSAPVVWERMSQEPPQEMAKAQDGTFSSVLTLTNLTGLDTGEYFCTHNDSRGLETDERKRLYIFVPDPTVGFLPNDAEELFIFLTEITEITIPCRVTDPQLVVTLHEKKGDVALPVPYDHQRGFSGIFEDRSYICKTTIGDREVDSDAYYVYRLQVSSINVSVNAVQTVVRQGENITLMCIVIGNEVVNFEWTYPRKESGRLVEPVTDFLLDMPYHIRSILHIPSAELEDSGTYTCNVTESVNDHQDEKAINITVVESGYVRLLGEVGTLQFAELHRSRTLQVVFEAYPPPTVLWFKDNRTLGDSSAGEIALSTRNVSETRYVSELTLVRVKVAEAGHYTMRAFHEDAEVQLSFQLQINVPVRVLELSESHPDSGEQTVRCRGRGMPQPNIIWSACRDLKRCPRELPPTLLGNSSEEESQLETNVTYWEEEQEFEVVSTLRLQHVDRPLSVRCTLRNAVGQDTQEVIVVPHSLPFKVVVISAILALVVLTIISLIILIMLWQKKPRYEIRWKVIESVSSDGHEYIYVDPMQLPYDSTWELPRDQLVLGRTLGSGAFGQVVEATAHGLSHSQATMKVAVKMLKSTARSSEKQALMSELKIMSHLGPHLNVVNLLGACTKGGPIYIITEYCRYGDLVDYLHRNKHTFLQHHSDKRRPPSAELYSNALPVGLPLPSHVSLTGESDGGYMDMSKDESVDYVPMLDMKGDVKYADIESSNYMAPYDNYVPSAPERTCRATLINESPVLSYMDLVGFSYQVANGMEFLASKNCVHRDLAARNVLICEGKLVKICDFGLARDIMRDSNYISKGSTFLPLKWMAPESIFNSLYTTLSDVWSFGILLWEIFTLGGTPYPELPMNEQFYNAIKRGYRMAQPAHASDEIYEIMQKCWEEKFEIRPPFSQLVLLLERLLGEGYKKKYQQVDEEFLRSDHPAILRSQARLPGFHGLRSPLDTSSVLYTAVQPNEGDNDYIIPLPDPKPEVADEGPLEGSPSLASSTLNEVNTSSTISCDSPLEPQDEPEPEPQLELQVEPEPELEQLPDSGCPAPRAEAEDSFL

SEQ ID NO: 24 - protein, 1114 aa, Artificial Sequence
  Description of Artificial Sequence/note = synthetic construct
MAKATSGAAGLRLLLLLLLPLLGKVALGLYFSRDAYWEKLYVDQAAGTPLLYVHALRDAPEEVPSFRLGQHLYGTYRTRLHENNWICIQEDTGLLYLNRSLDHSSWEKLSVRNRGFPLLTVYLKVFLSPTSLREGECQWPGCARVYFSFFNTSFPACSSLKPRELCFPETRPSFRIRENRPPGTFHQFRLLPVQFLCPNISVAYRLLEGEGLPFRCAPDSLEVSTRWALDREQREKYELVAVCTVHAGAREEVVMVPFPVTVYDEDDSAPTFPAGVDTASAVVEFKRKEDTVVATLRVFDADVVPASGELVRRYTSTLLPGDTWAQQTFRVEHWPNETSVQANGSFVRATVHDYRLVLNRNLSISENRTMQLAVLVNDSDFQGPGAGVLLLHFNVSVLPVSLHLPSTYSLSVSRRARRFAQIGKVCVENCQAFSGINVQYKLHSSGANCSTLGVVTSAEDTSGILFVNDTKALRRPKCAELHYMVVATDQQTSRQAQAQLLVTVEGSYVAEEAGCPLSCAVSKRRLECEECGGLGSPTGRCEWRQGDGKGITRNFSTCSPSTKTCPDGHCDVVETQDINICPQDCLRGSIVGGHEPGEPRGIKAGYGTCNCFPEEEKCFCEPEDIQDPLCDELCRTVIAAAVLFSFIVSVLLSAFCIHCYHKFAHKPPISSAEMTFRRPAQAFPVSYSSSGARRPSLDSMENQVSVDAFKILEDPKWEFPRKNLVLGKTLGEGEFGKVVKATAFHLKGRAGYTTVAVKMLKENASPSELRDLLSEFNVLKQVNHPHVIKLYGACSQDGPLLLIVEYAKYGSLRGFLRESRKVGPGYLGSGGSRNSSSLDHPDERALTMGDLISFAWQISQGMQYLAEMKLVHRDLAARNILVAEGRKMKISDFGLSRDVYEEDSYVKRSQGRIPVKWMAIESLFDHIYTTQSDVWSFGVLLWEIVTLGGNPYPGIPPERLFNLLKTGHRMERPDNCSEEMYRLMLQCWKQEPDKRPVFADISKDLEKMMVKRRDYLDLAASTPSDSLIYDDGLSEEETPLVDCNNAPLPRALPSTWIENKLYGMSDPNWPGESPVPLTRADGTNTGFPRYPNDSVYANWMLSPSAAKLMDTFDS

SEQ ID NO: 25 - protein, 540 aa, Artificial Sequence
  Description of Artificial Sequence/note = synthetic construct
MNGEAICSALPTIPYHKLADLRYLSRGASGTVSSARHADWRVQVAVKHLHIHTPLLDSERKDVLREAEILHKARFSYILPILGICNEPEFLGIVTEYMPNGSLNELLHRKTEYPDVAWPLRFRILHEIALGVNYLHNMTPPLLHHDLKTQNILLDNEFHVKIADFGLSKWRMMSLSQSRSSKSAPEGGTIIYMPPENYEPGQKSRASIKHDIYSYAVITWEVLSRKQPFEDVTNPLQIMYSVSQGHRPVINEESLPYDIPHRARMISLIESGWAQNPDERPSFLKCLIELEPVLRTFEEITFLEAVIQLKKTKLQSVSSAIHLCDKKKMELSLNIPVNHGPQEESCGSSQLHENSGSPETSRSLPAPQDNDFLSRKAQDCYFMKLHHCPGNHSWDSTISGSQRAAFCDHKTTPCSSAIINPLSTAGNSERLQPGIAQQWIQSKREDIVNQMTEACLNQSLDALLSRDLIMKEDYELVSTKPTRTSKVRQLLDTTDIQGEEFAKVIVQKLKDNKQMGLQPYPEILVVSRSPSLNLLQNKSM

SEQ ID NO: 26 - protein, 536 aa, Artificial Sequence
  Description of Artificial Sequence/note = synthetic construct
MGSNKSKPKDASQRRRSLEPAENVHGAGGGAFPASQTPSKPASADGHRGPSAAFAPAAAEPKLFGGFNSSDTVTSPQRAGPLAGGVTTFVALYDYESRTETDLSFKKGERLQIVNNTEGDWWLAHSLSTGQTGYIPSNYVAPSDSIQAEEWYFGKITRRESERLLLNAENPRGTFLVRESETTKGAYCLSVSDFDNAKGLNVKHYKIRKLDSGGFYITSRTQFNSLQQLVAYYSKHADGLCHRLTTVCPTSKPQTQGLAKDAWEIPRESLRLEVKLGQGCFGEVWMGTWNGTTRVAIKTLKPGTMSPEAFLQEAQVMKKLRHEKLVQLYAVVSEEPIYIVTEYMSKGSLLDFLKGETGKYLRLPQLVDMAAQIASGMAYVERMNYVHRDLRAANILVGENLVCKVADFGLARLIEDNEYTARQGAKFPIKWTAPEAALYGRFTIKSDVWSFGILLTELTTKGRVPYPGMVNREVLDQVERGYRMPCPPECPESLHDLMCQCWRKEPEERPTFEYLQAFLEDYFTSTEPQYQPGENL

SEQ ID NO: 27 - protein, 635 aa, Artificial Sequence
  Description of Artificial Sequence/note = synthetic construct
MASSGMADSANHLPFFFGNITREEAEDYLVQGGMSDGLYLLRQSRNYLGGFALSVAHGRKAHHYTIERELNGTYAIAGGRTHASPADLCHYHSQESDGLVCLLKKPFNRPQGVQPKTGPFEDLKENLIREYVKQTWNLQGQALEQAIISQKPQLEKLIATTAHEKMPWFHGKISREESEQIVLIGSKTNGKFLIRARDNNGSYALCLLHEGKVLHYRIDKDKTGKLSIPEGKKFDTLWQLVEHYSYKADGLLRVLTVPCQKIGTQGNVNFGGRPQLPGSHPATWSAGGIISRIKSYSFPKPGHRKSSPAQGNRQESTVSFNPYEPELAPWAADKGPQREALPMDTEVYESPYADPEEIRPKEVYLDRKLLTLEDKELGSGNFGTVKKGYYQMKKVVKTVAVKILKNEANDPALKDELLAEANVMQQLDNPYIVRMIGICEAESWMLVMEMAELGPLNKYLQQNRHVKDKNIIELVHQVSMGMKYLEESNFVHRDLAARNVLLVTQHYAKISDFGLSKALRADENYYKAQTHGKWPVKWYAPECINYYKFSSKSDVWSFGVLMWEAFSYGQKPYRGMKGSEVTAMLEKGERMGCPAGCPREMYDLMNLCWTYDVENRPGFAAVELRLRNYYYDVVN

SEQ ID NO: 28 - protein, 631 aa, Artificial Sequence
  Description of Artificial Sequence/note = synthetic construct
MNFNTILEEILIKRSQQKKKTSPLNYKERLFVLTKSMLTYYEGRAEKKYRKGFIDVSKIKCVEIVKNDDGVIPCQNKYPFQVVHDANTLYIFAPSPQSRDLWVKKLKEEIKNNNNIMIKYHPKFWTDGSYQCCRQTEKLAPGCEKYNLFESSIRKALPPAPETKKRRPPPPIPLEEEDNSEEIVVAMYDFQAAEGHDLRLERGQEYLILEKNDVHWWRARDKYGNEGYIPSNYVTGKKSNNLDQYEWYCRNMNRSKAEQLLRSEDKEGGFMVRDSSQPGLYTVSLYTKFGGEGSSGFRHYHIKETTTSPKKYYLAEKHAFGSIPEIIEYHKHNAAGLVTRLRYPVSVKGKNAPTTAGFSYEKWEINPSELTFMRELGSGLFGVVRLGKWRAQYKVAIKAIREGAMCEEDFIEEAKVMMKLTHPKLVQLYGVCTQQKPIYIVTEFMERGCLLNFLRQRQGHFSRDVLLSMCQDVCEGMEYLERNSFIHRDLAARNCLVSEAGVVKVSDFGMARYFLDDQYTSSSGAKFPVKWCPPEVFNYSRFSSKSDVWSFGVLMWEVFTEGRMPFEKYTNYEVVTMVTRGHRLYQPKLASNYVYEVMLRCWQEKPEGRPSFEDLLRTIDELVECEETFGR

SEQ ID NO: 29 - protein, 543 aa, Artificial Sequence
  Description of Artificial Sequence/note = synthetic construct
MGCIKSKENKSPAIKYRPENTPEPVSTSVSHYGAEPTTVSPCPSSSAKGTAVNFSSLSMTPFGGSSGVTPFGGASSSFSVVPSSYPAGLTGGVTIFVALYDYEARTTEDLSFKKGERFQIINNTEGDWWEARSIATGKNGYIPSNYVAPADSIQAEEWYFGKMGRKDAERLLLNPGNQRGIFLVRESETTKGAYSLSIRDWDEIRGDNVKHYKIRKLDNGGYYITTRAQFDTLQKLVKHYTEHADGLCHKLTTVCPTVKPQTQGLAKDAWEIPRESLRLEVKLGQGCFGEVWMGTWNGTTKVAIKTLKPGTMMPEAFLQEAQIMKKLRHDKLVPLYAVVSEEPIYIVTEFMSKGSLLDFLKEGDGKYLKLPQLVDMAAQIADGMAYIERMNYIHRDLRAANILVGENLVCKIADFGLARLIEDNEYTARQGAKFPIKWTAPEAALYGRFTIKSDVWSFGILQTELVTKGRVPYPGMVNREVLEQVERGYRMPCPQGCPESLHELMNLCWKKDPDERPTFEYIQSFLEDYFTATEPQYQPGENL

SEQ ID NO: 30 - protein, 680 aa, Artificial Sequence
  Description of Artificial Sequence/note = synthetic construct
MKDDNMDTKSILEELLLKRSQQKKKMSPNNYKERLFVLTKTNLSYYEYDKMKRGSRKGSIEIKKIRCVEKVNLEEQTPVERQYPFQIVYKDGLLYVYASNEESRSQWLKALQKEIRGNPHLLVKYHSGFFVDGKFLCCQQSCKAAPGCTLWEAYANLHTAVNEEKHRVPTFPDRVLKIPRAVPVLKMDAPSSSTTLAQYDNESKKNYGSQPPSSSTSLAQYDSNSKKIYGSQPNFNMQYIPREDFPDWWQVRKLKSSSSSEDVASSNQKERNVNHTTSKISWEFPESSSSEEEENLDDYDWFAGNISRSQSEQLLRQKGKEGAFMVRNSSQVGMYTVSLFSKAVNDKKGTVKHYHVHTNAENKLYLAENYCFDSIPKLIHYHQHNSAGMITRLRHPVSTKANKVPDSVSLGNGIWELKREEITLLKELGSGQFGVVQLGKWKGQYDVAVKMIKEGSMSEDEFFQEAQTMMKLSHPKLVKFYGVCSKEYPIYIVTEYISNGCLLNYLRSHGKGLEPSQLLEMCYDVCEGMAFLESHQFIHRDLAARNCLVDRDLCVKVSDFGMTRYVLDDQYVSSVGTKFPVKWSAPEVFHYFKYSSKSDVWAFGILMWEVFSLGKQPYDLYDNSQVVLKVSQGHRLYRPHLASDTIYQIMYSCWHELPEKRPTFQQLLSSIEPLREKDKH

SEQ ID NO: 31 - protein, 505 aa, Artificial Sequence
  Description of Artificial Sequence/note = synthetic construct
MSNICQRLWEYLEPYLPCLSTEADKSTVIENPGALCSPQSQRHGHYFVALFDYQARTAEDLSFRAGDKLQVLDTLHEGWWFARHLEKRRDGSSQQLQGYIPSNYVAEDRSLQAEPWFFGAIGRSDAEKQLLYSENKTGSFLIRESESQKGEFSLSVLDGAVVKHYRIKRLDEGGFFLTRRRIFSTLNEFVSHYTKTSDGLCVKLGKPCLKIQVPAPFDLSYKTVDQWEIDRNSIQLLKRLGSGQFGEVWEGLWNNTTPVAVKTLKPGSMDPNDFLREAQIMKNLRHPKLIQLYAVCTLEDPIYIITELMRHGSLQEYLQNDTGSKIHLTQQVDMAAQVASGMAYLESRNYIHRDLAARNVLVGEHNIYKVADFGLARVFKVDNEDIYESRHEIKLPVKWTAPEAIRSNKFSIKSDVWSFGILLYEIITYGKMPYSGMTGAQVIQMLAQNYRLPQPSNCPQQFYNIMLECWNAEPKERPTFETLRWKLEDYFETDSSYSDANNFIR

SEQ ID NO: 32 - protein, 1743 aa, Artificial Sequence
  Description of Artificial Sequence/note = synthetic construct
MATDSGDPASTEDSEKPDGISFENRVPQVAATLTVEARLKEKNSTFSASGETVERKRFFRKSVEMTEDDKVAESSPKDERIKAAMNIPRVDKLPSNVLRGGQEVKYEQCSKSTSEISKDCFKEKNEKEMEEEAEMKAVATSPSGRFLKFDIELGRGAFKTVYKGLDTETWVEVAWCELQDRKLTKAEQQRFKEEAEMLKGLQHPNIVRFYDSWESILKGKKCIVLVTELMTSGTLKTYLKRFKVMKPKVLRSWCRQILKGLQFLHTRTPPIIHRDLKCDNIFITGPTGSVKIGDLGLATLMRTSFAKSVIGTPEFMAPEMYEEHYDESVDVYAFGMCMLEMATSEYPYSECQNAAQIYRKVTSGIKPASFNKVTDPEVKEIIEGCIRQNKSERLSIRDLLNHAFFAEDTGLRVELAEEDDCSNSSLALRLWVEDPKKLKGKHKDNEAIEFSFNLETDTPEEVAYEMVKSGFFHESDSKAVAKSIRDRVTPIKKTREKKPAGCLEERRDSQCKSMGNVFPQPQNTTLPLAPAQQTGAECEETEVDQHVRQQLLQRKPQQHCSSVTGDNLSEAGAASVIHSDTSSQPSVAYSSNQTMGSQMVSNIPQAEVNVPGQIYSSQQLVGHYQQVSGLQKHSKLTQPQILPLVQGQSTVLPVHVLGPTVVSQPQVSPLTVQKVPQIKPVSQPVGAEQQAALLKPDLVRSLNQDVATTKENVSSPDNPSGNGKQDRIKQRRASCPRPEKGTKFQLTVLQVSTSGDNMVECQLETHNNKMVTFKFDVDGDAPEDIADYMVEDNFVLESEKEKFVEELRAIVGQAQEILHVHFATERATGVDSITVDSNSSQTGSSEQVQINSTSTQTSNESAPQSSPVGRWRFCINQTIRNRETQSPPSLQHSMSAVPGRHPLPSPKNTSNKEISRDTLLTIENNPCHRALFTSKSEHKDVVDGKISECASVETKQPAILYQVEDNRQIMAPVTNSSSYSTTSVRAVPAECEGLTKQASIFIPVYPCHQTASQADALMSHPGESTQTSGNSLTTLAFDQKPQTLSVQQPAMDAEFISQEGETTVNTEASSPKTVIPTQTPGLEPTTLQPTTVLESDGERPPKLEFADNRIKTLDEKLRNLLYQEHSISSIYPESQKDTQSIDSPFSSSAEDTLSCPVTEVIAISHCGIKDSPVQSPNFQQTGSKLLSNVAASQPANISVFKRDLNVITSVPSELCLHEMSSDASLPGDPEAYPAAVSSGGAIHLQTGVETEEMRSAIAPDPIPLTRESTADTRALNRCKAMSGSFQRGRFQVITIPQQQSAKMTSFGIEHISVFSETNHSSEEAFIKTAKSQLVEIEPATQNPKTSFSYEKLQALQETCKENKGVPKQGDNFLSFSAACETDVSSVTPEKEFEETSATGSSMQSGSELLLKEREILTAGKQPSSDSEFSASLAGSGKSVAKTGPESNQCLPHHEEQAYAQTQSSLFYSPSSPMSSDDESEIEDEDLKVELQRLREKHIQEVVNLQTQQNKELQELYERLRSIKDSKTQSTEIPLPPASPRRPRSFKSKLRSRPQSLTHVDNGIVATDPLCVESNAASCQQSPASKKGMFTDDLHKLVDDWTKEAVGNSLIKPSLNQLKQSQHKLETENWNKVSENTPSTMGYTSTWISSLSQIRGAVPTSLPQGLSLPSFPGPLSSYGMPHVCQYNAVAGAGYPVQWVGISGTTQQSVVIPAQSGGPFQPGMNMQAFPTSSVQNPATIPPGPK

SEQ ID NO: 33 - protein, 252 aa, Artificial Sequence
  Description of Artificial Sequence/note = synthetic construct
ITMKHKLGGGQYGEVYEGVWKKYSLTVAVKTLKEDTMEVEEFLKEAAVMKEIKHPNLVQLLGVCTREPPFYIITEFMTYGNLLDYLRECNRQEVNAVVLLYMATQISSAMEYLEKKNFIHRDLAARNCLVGENHLVKVADFGLSRLMTGDTYTAHAGAKFPIKWTAPESLAYNKFSIKSDVWAFGVLLWEIATYGMSPYPGIDLSQVYELLEKDYRMERPEGCPEKVYELMRACWQWNPSDRPSFAEIHQAF

SEQ ID NO: 34 - protein, 260 aa, Artificial Sequence
  Description of Artificial Sequence/note = synthetic construct
LRLLEKLGDGSFGVVRRGEWDAPSGKTVSVAVKCLKPDVLSQPEAMDDFIREVNAMHSLDHRNLIRLYGVVLTPPMKMVTELAPLGSLLDRLRKHQGHFLLGTLSRYAVQVAEGMGYLESKRFIHRDLAARNLLLATRDLVKIGDFGLMRALPQNDDHYVMQEHRKVPFAWCAPESLKTRTFSHASDTWMFGVTLWEMFTYGQEPWIGLNGSQILHKIDKEGERLPRPEDCPQDIYNVMVQCWAHKPEDRPTFVALRDFL

SEQ ID NO: 35 - protein, 259 aa, Artificial Sequence
  Description of Artificial Sequence/note = synthetic construct
LKFDIELGRGSFKTVYKGLDTETWVEVAWCELQDRKLTKLERQRFKEEAEMLKGLQHPNIVRFYDFWESSAKGKRCIVLVTELMTSGTLKTYLKRFKVMKPKVLRSWCRQILKGLLFLHTRTPPIIHRDLKCDNIFITGPTGSVKIGDLGLATLKRASFAKSVIGTPEFMAPEMYEEHYDESVDVYAFGMCMLEMATSEYPYSECQNAAQIYRKVTCGIKPASFEKVHDPEIKEIIGECICKNKEERYEIKDLLSHAFF

SEQ ID NO: 36 - protein, 251 aa, Artificial Sequence
  Description of Artificial Sequence/note = synthetic construct
LRLVRKLGSGQFGEVWMGYYKNNMKVAIKTLKEGTMSPEAFLGEANVMKALQHERLVRLYAVVTKEPIYIVTEYMARGCLLDFLKTDEGSRLSLPRLIDMSAQIAEGMAYIERMNSIHRDLRAANILVSEALCCKIADFGLARIIDSEYTAQEGAKFPIKWTAPEAYHFGVFTIKADVWSFGVLLMEVVTYGRVPYPGMSNPEVIRNLERGYRMPRPDTCPPELYRGVIAECWRSRPEERPTFEFLQSVLE

SEQ ID NO: 37 - protein, 329 aa, Artificial Sequence
  Description of Artificial Sequence/note = synthetic construct
LQFGKTLGAGAFGKVVEATAFGLGKEDAVLKVAVKMLKSTAHADEKEALMSELKIMSHLGQHENIVNLLGACTHGGPVLVITEYCCYGDLLNFLRRKAEAMLGPSLSPGQDPEGGVDYKNIHLEKKYVRRDSGFSSQGVDTYVEMRPVSTSSNDSFSEQDLDKEDGRPLELRDLLHFSSQVAQGMAFLASKNCIHRDVAARNVLLTNGHVAKIGDFGLARDIMNDSNYIVKGNARLPVKWMAPESIFDCVYTVQSDVWSYGILLWEIFSLGLNPYPGILVNSKFYKLVKDGYQMAQPAFAPKNIYSIMQACWALEPTHRPTFQQICSFL

SEQ ID NO: 38 - protein, 246 aa, Artificial Sequence
  Description of Artificial Sequence/note = synthetic construct
LKLLQTIGKGEFGDVMLGDYRGNKVAVKCIKNDATAQAFLAEASVMTQLRHSNLVQLLGVIVEEKGGLYIVTEYMAKGSLVDYLRSRGRSVLGGDCLLKFSLDVCEAMEYLEGNNFVHRDLAARNVLVSEDNVAKVSDFGLTKEASSTQDTGKLPVKWTAPEALREKKFSTKSDVWSFGILLWEIYSFGRVPYPRIPLKDVVPRVEKGYKMDAPDGCPPAVYEVMKNCWHLDAAMRPSFLQLREQL

SEQ ID NO: 39 - protein, 255 aa, Artificial Sequence
  Description of Artificial Sequence/note = synthetic construct
IELGRCIGEGQFGDVHQGIYMSPENPALAVAIKTCKNCTSDSVREKFLQEALTMRQFDHPHIVKLIGVITENPVWIIMELCTLGELRSFLQVRKYSLDLASLILYAYQLSTALAYLESKRFVHRDIAARNVLVSSNDCVKLGDFGLSRYMEDSTYYKASKGKLPIKWMAPESINFRRFTSASDVWMFGVCMWEILMHGVKPFQGVKNNDVIGRIENGERLPMPPNCPPTLYSLMTKCWAYDPSRRPRFTELKAQL

SEQ ID NO: 40 - protein, 277 aa, Artificial Sequence
  Description of Artificial Sequence/note = synthetic construct
LTLGKPLGEGCFGQVVMAEAVGIDKDKPKEAVTVAVKMLKDDATEKDLSDLVSEMEMMKMIGKHKNIINLLGACTQDGPLYVIVEYASKGNLREYLRARRPPGMEYSYDINRVPEEQMTFKDLVSCTYQLARGMEYLASQKCIHRDLAARNVLVTENNVMKIADFGLARDINNIDYYKKTTNGRLPVKWMAPEALFDRVYTHQSDVWSFGVLMWEIFTLGGSPYPGIPVEELFKLLKEGHRMDKPANCTNELYMMMRDCWHAVPSQRPTFKQLVEDL

SEQ ID NO: 41 - protein, 277 aa, Artificial Sequence
  Description of Artificial Sequence/note = synthetic construct
LVLGKPLGEGCFGQVVRAEAFGMDPARPDQASTVAVKMLKDNASDKDLADLVSEMEVMKLIGRHKNIINLLGVCTQEGPLYVIVECAAKGNLREFLRARRPPGPDLSPDGPRSSEGPLSFPVLVSCAYQVARGMQYLESRKCIHRDLAARNVLVTEDNVMKIADFGLARGVHHIDYYKKTSNGRLPVKWMAPEALFDRVYTHQSDVWSFGILLWEIFTLGGSPYPGIPVEELFSLLREGHRMDRPPHCPPELYGLMRECWHAAPSQRPTFKQLVEAL

SEQ ID NO: 42 - protein, 250 aa, Artificial Sequence
  Description of Artificial Sequence/note = synthetic construct
ITLERRLGTGCFGDVWLGTWNGSTKVAVKTLKPGTMSPKAFLEEAQVMKLLRHDKLVQLYAVVSEEPIYIVTEFMCHGSLLDFLKNPEGQDLRLPQLVDMAAQVAEGMAYMERMNYIHRDLRAANILVGERLACKIADFGLARLIKDDEYNPCQGSKFPIKWTAPEAALFGRFTIKSDVWSFGILLTELITKGRIPYPGMNKREVLEQVEQGYHMPCPPGCPASLYEAMEQTWRLDPEERPTFEYLQSFL

SEQ ID NO: 43 - protein, 328 aa, Artificial Sequence
  Description of Artificial Sequence/note = synthetic construct
LKLGKSLGRGAFGKVVQASAFGIKKSPTCRTVAVKMLKEGATASEYKALMTELKILTHIGHHLNVVNLLGACTKQGGPLMVIVEYCKYGNLSNYLKSKRDLFFLNKDAALHMEPKKEKMEPGLEQGKKPRLDSVTSSESFASSGFQEDKSLSDVEEEEDSDGFYKEPITMEDLISYSFQVARGMEFLSSRKCIHRDLAARNILLSENNVVKICDFGLARDIYKNPDYVRKGDTRLPLKWMAPESIFDKIYSTKSDVWSYGVLLWEIFSLGGSPYPGVQMDEDFCSRLREGMRMRAPEYSTPEIYQIMLDCWHRDPKERPRFAELVEKL

SEQ ID NO: 44 - protein, 325 aa, Artificial Sequence
  Description of Artificial Sequence/note = synthetic construct
LHLGRVLGYGAFGKVVEASAFGIHKGSSCDTVAVKMLKEGATASEHRALMSELKILIHIGNHLNVVNLLGACTKPQGPLMVIVEFCKYGNLSNFLRAKRDAFSPCAEKSPEQRGRFRAMVELARLDRRRPGSSDRVLFARFSKTEGGARRASPDQEAEDLWLSPLTMEDLVCYSFQVARGMEFLASRKCIHRDLAARNILLSESDVVKICDFGLARDIYKDPDYVRKGSARLPLKWMAPESIFDKVYTTQSDVWSFGVLLWEIFSLGASPYPGVQINEEFCQRLRDGTRMRAPELATPAIRRIMLNCWSGDPKARPAFSELVEIL

SEQ ID NO: 45 - protein, 250 aa, Artificial Sequence
  Description of Artificial Sequence/note = synthetic construct
LQLIKRLGNGQFGEVWMGTWNGNTKVAIKTLKPGTMSPESFLEEAQIMKKLKHDKLVQLYAVVSEEPIYIVTEYMNKGSLLDFLKDGEGRALKLPNLVDMAAQVAAGMAYIERMNYIHRDLRSANILVGNGLICKIADFGLARLIEDNEYTARQGAKFPIKWTAPEAALYGRFTIKSDVWSFGILLTELVTKGRVPYPGMNNREVLEQVERGYRMPCPQDCPISLHELMIHCWKKDPEERPTFEYLQSFL

SEQ ID NO: 46 - protein, 251 aa, Artificial Sequence
  Description of Artificial Sequence/note = synthetic construct
LKLEKKLGAGQFGEVWMATYNKHTKVAVKTMKPGSMSVEAFLAEANVMKTLQHDKLVKLHAVVTKEPIYIITEFMAKGSLLDFLKSDEGSKQPLPKLIDFSAQIAEGMAFIEQRNYIHRDLRAANILVSASLVCKIADFGLARVIEDNEYTAREGAKFPIKWTAPEAINFGSFTIKSDVWSFGILLMEIVTYGRIPYPGMSNPEVIRALERGYRMPRPENCPEELYNIMMRCWKNRPEERPTFEYIQSVLD

SEQ ID NO: 47 - protein, 258 aa, Artificial Sequence
  Description of Artificial Sequence/note = synthetic construct
LKRVKVLGSGAFGTVYKGIWVPEGETVKIPVAIKILNETTGPKANVEFMDEALIMASMDHPHLVRLLGVCLSPTIQLVTQLMPHGCLLEYVHEHKDNIGSQLLLNWCVQIAKGMMYLEERRLVHRDLAARNVLVKSPNHVKITDFGLARLLEGDEKEYNADGGKMPIKWMALECIHYRKFTHQSDVWSYGVTIWELMTFGGKPYDGIPTREIPDLLEKGERLPQPPICTIDVYMVMVKCWMIDADSRPKFKELAAEFS

SEQ ID NO: 48 - protein, 274 aa, Artificial Sequence
  Description of Artificial Sequence/note = synthetic construct
WEMRERLGTGGFGNVCLYQHRELDLKIAIKSCRLELSTKNRERWCHEIQIMKKLNHANVVKACDVPEELNILIHDVPLLAMEYCSGGDLRKLLNKPENCCGLKESQILSLLSDIGSGIRYLHENKIIHRDLKPENIVLQDVGGKIIHKIIDLGYAKDVDQGSLCTSFVGTLQYLAPELFENKPYTATVDYWSFGTMVFECIAGYRPFLHHLQPFTWHEKIKKKDPKCIFACEEMSGEVRFSSHLPQPNSLCSLIVEPMENWLQLMLNWDPQQRG

SEQ ID NO: 49 - protein, 275 aa, Artificial Sequence
  Description of Artificial Sequence/note = synthetic construct
WEMKERLGTGGFGNVIRWHNQETGEQIAIKQCRQELSPRNRERWCLEIQIMRRLTHPNVVAARDVPEGMQNLAPNDLPLLAMEYCQGGDLRKYLNQFENCCGLREGAILTLLSDIASALRYLHENRIIHRDLKPENIVLQQGEQRLIHKIIDLGYAKELDQGSLCTSFVGTLQYLAPELLEQQKYTVTVDYWSFGTLAFECITGFRPFLPNWQPVQWHSKVRQKSEVDIVVSEDLNGTVKFSSSLPYPNNLNSVLAERLEKWLQLMLMWHPRQRG

SEQ ID NO: 50 - protein, 336 aa, Artificial Sequence
  Description of Artificial Sequence/note = synthetic construct
LSFGKTLGAGAFGKVVEATAYGLIKSDAAMTVAVKMLKPSAHLTEREALMSELKVLSYLGNHMNIVNLLGACTIGGPTLVITEYCCYGDLLNFLRRKRDSFICSKQEDHAEAALYKNLLHSKESSCSDSTNEYMDMKPGVSYVVPTKADKRRSVRIGSYIERDVTPAIMEDDELALDLEDLLSFSYQVAKGMAFLASKNCIHRDLAARNILLTHGRITKICDFGLARDIKNDSNYVVKGNARLPVKWMAPESIFNCVYTFESDVWSYGIFLWELFSLGSSPYPGMPVDSKFYKMIKEGFRMLSPEHAPAEMYDIMKTCWDADPLKRPTFKQIVQLI

SEQ ID NO: 51 - protein, 251 aa, Artificial Sequence
  Description of Artificial Sequence/note = synthetic construct
LKLVERLGAGQFGEVWMGYYNGHTKVAVKSLKQGSMSPDAFLAEANLMKQLQHQRLVRLYAVVTQEPIYIITEYMENGSLVDFLKTPSGIKLTINKLLDMAAQIAEGMAFIEERNYIHRDLRAANILVSDTLSCKIADFGLARLIEDNEYTAREGAKFPIKWTAPEAINYGTFTIKSDVWSFGILLTEIVTHGRIPYPGMTNPEVIQNLERGYRMVRPDNCPEELYQLMRLCWKERPEDRPTFDYLRSVLE

SEQ ID NO: 52 - protein, 252 aa, Artificial Sequence
  Description of Artificial Sequence/note = synthetic construct
IKLVKRLGAGQFGEVWMGYYNNSTKVAVKTLKPGTMSVQAFLEEANLMKTLQHDKLVRLYAVVTREEPIYIITEYMAKGSLLDFLKSDEGGKVLLPKLIDFSAQIAEGMAYIERKNYIHRDLRAANVLVSESLMCKIADFGLARVIEDNEYTAREGAKFPIKWTAPEAINFGCFTIKSDVWSFGILLYEIVTYGKIPYPGRTNADVMTALSQGYRMPRVENCPDELYDIMKMCWKEKAEERPTFDYLQSVLD

SEQ ID NO: 53 - protein, 250 aa, Artificial Sequence
  Description of Artificial Sequence/note = synthetic construct
FQRLSRLGHGSYGEVFKVRSKEDGRLYAVKRSMSPFRGPKDRARKLAEVGSHEKVGQHPCCVRLEQAWEEGGILYLQTELCGPSLQQHCEAWGASLPEAQVWGYLRDTLLALAHLHSQGLVHLDVKPANIFLGPRGRCKLGDFGLLVELGTAGAGEVQEGDPRYMAPELLQGSYGTAADVFSLGLTILEVACNMELPHGGEGWQQLRQGYLPPEFTAGLSSELRSVLVMMLEPDPKLRATAEALLALPVL

SEQ ID NO: 54 - protein, 358 aa, Artificial Sequence
  Description of Artificial Sequence/note = synthetic construct
LVLGRVLGSGAFGKVVEGTAYGLSRSQPVMKVAVKMLKPTARSSEKQALMSELKIMTHLGPHLNIVNLLGACTKSGPIYIITEYCFYGDLVNYLHKNRDSFLSHHPEKPKKELDIFGLNPADESTRSYVILSFENNGDYMDMKQADTTQYVPMLERKEVSKYSDIQRSLYDRPASYKKKSMLDSEVKNLLSDDNSEGLTLLDLLSFTYQVARGMEFLASKNCVHRDLAARNVLLAQGKIVKICDFGLARDIMHDSNYVSKGSTFLPVKWMAPESIFDNLYTTLSDVWSYGILLWEIFSLGGTPYPGMMVDSTFYNKIKSGYRMAKPDHATSEVYEIMVKCWNSEPEKRPSFYHLSEIV

SEQ ID NO: 55 - protein, 359 aa, Artificial Sequence
  Description of Artificial Sequence/note = synthetic construct
LVLGRTLGSGAFGQVVEATAHGLSHSQATMKVAVKMLKSTARSSEKQALMSELKIMSHLGPHLNVVNLLGACTKGGPIYIITEYCRYGDLVDYLHRNKHTFLQHHSDKRRPPSAELYSNALPVGLPLPSHVSLTGESDGGYMDMSKDESVDYVPMLDMKGDVKYADIESSNYMAPYDNYVPSAPERTCRATLINESPVLSYMDLVGFSYQVANGMEFLASKNCVHRDLAARNVLICEGKLVKICDFGLARDIMRDSNYISKGSTFLPLKWMAPESIFNSLYTTLSDVWSFGILLWEIFTLGGTPYPELPMNEQFYNAIKRGYRMAQPAHASDEIYEIMQKCWEEKFEIRPPFSQLVLLL

SEQ ID NO: 56 - protein, 284 aa, Artificial Sequence
  Description of Artificial Sequence/note = synthetic construct
LVLGKTLGEGEFGKVVKATAFHLKGRAGYTTVAVKMLKENASPSELRDLLSEFNVLKQVNHPHVIKLYGACSQDGPLLLIVEYAKYGSLRGFLRESRKVGPGYLGSGGSRNSSSLDHPDERALTMGDLISFAWQISQGMQYLAEMKLVHRDLAARNILVAEGRKMKISDFGLSRDVYEEDSYVKRSQGRIPVKWMAIESLFDHIYTTQSDVWSFGVLLWEIVTLGGNPYPGIPPERLFNLLKTGHRMERPDNCSEEMYRLMLQCWKQEPDKRPVFADISKDLEK

SEQ ID NO: 57 - protein, 267 aa, Artificial Sequence
  Description of Artificial Sequence/note = synthetic construct
LADLRYLSRGASGTVSSARHADWRVQVAVKHLHIHTPLLDSERKDVLREAEILHKARFSYILPILGICNEPEFLGIVTEYMPNGSLNELLHRKTEYPDVAWPLRFRILHEIALGVNYLHNMTPPLLHHDLKTQNILLDNEFHVKIADFGLSKWRMMSLSQSRSSKSAPEGGTIIYMPPENYEPGQKSRASIKHDIYSYAVITWEVLSRKQPFEDVTNPLQIMYSVSQGHRPVINEESLPYDIPHRARMISLIESGWAQNPDERPSFL

SEQ ID NO: 58 - protein, 249 aa, Artificial Sequence
  Description of Artificial Sequence/note = synthetic construct
LRLEVKLGQGCFGEVWMGTWNGTTRVAIKTLKPGTMSPEAFLQEAQVMKKLRHEKLVQLYAVVSEEPIYIVTEYMSKGSLLDFLKGETGKYLRLPQLVDMAAQIASGMAYVERMNYVHRDLRAANILVGENLVCKVADFGLARLIEDNEYTARQGAKFPIKWTAPEAALYGRFTIKSDVWSFGILLTELTTKGRVPYPGMVNREVLDQVERGYRMPCPPECPESLHDLMCQCWRKEPEERPTFEYLQAF

SEQ ID NO: 59 - protein, 249 aa, Artificial Sequence
  Description of Artificial Sequence/note = synthetic construct
TLEDKELGSGNFGTVKKGYYQMKKVVKTVAVKILKNEANDPALKDELLAEANVMQQLDNPYIVRMIGICEAESWMLVMEMAELGPLNKYLQQNRHVKDKNIIELVHQVSMGMKYLEESNFVHRDLAARNVLLVTQHYAKISDFGLSKALRADENYYKAQTHGKWPVKWYAPECINYYKFSSKSDVWSFGVLMWEAFSYGQKPYRGMKGSEVTAMLEKGERMGCPAGCPREMYDLMNLCWTYDVENRPGF

SEQ ID NO: 60 - protein, 250 aa, Artificial Sequence
  Description of Artificial Sequence/note = synthetic construct
LTFMRELGSGLFGVVRLGKWRAQYKVAIKAIREGAMCEEDFIEEAKVMMKLTHPKLVQLYGVCTQQKPIYIVTEFMERGCLLNFLRQRQGHFSRDVLLSMCQDVCEGMEYLERNSFIHRDLAARNCLVSEAGVVKVSDFGMARYFLDDQYTSSSGAKFPVKWCPPEVFNYSRFSSKSDVWSFGVLMWEVFTEGRMPFEKYTNYEVVTMVTRGHRLYQPKLASNYVYEVMLRCWQEKPEGRPSFEDLLRTI

SEQ ID NO: 61 - protein, 250 aa, Artificial Sequence
  Description of Artificial Sequence/note = synthetic construct
LRLEVKLGQGCFGEVWMGTWNGTTKVAIKTLKPGTMMPEAFLQEAQIMKKLRHDKLVPLYAVVSEEPIYIVTEFMSKGSLLDFLKEGDGKYLKLPQLVDMAAQIADGMAYIERMNYIHRDLRAANILVGENLVCKIADFGLARLIEDNEYTARQGAKFPIKWTAPEAALYGRFTIKSDVWSFGILQTELVTKGRVPYPGMVNREVLEQVERGYRMPCPQGCPESLHELMNLCWKKDPDERPTFEYIQSFL

SEQ ID NO: 62 - protein, 252 aa, Artificial Sequence
  Description of Artificial Sequence/note = synthetic construct
ITLLKELGSGQFGVVQLGKWKGQYDVAVKMIKEGSMSEDEFFQEAQTMMKLSHPKLVKFYGVCSKEYPIYIVTEYISNGCLLNYLRSHGKGLEPSQLLEMCYDVCEGMAFLESHQFIHRDLAARNCLVDRDLCVKVSDFGMTRYVLDDQYVSSVGTKFPVKWSAPEVFHYFKYSSKSDVWAFGILMWEVFSLGKQPYDLYDNSQVVLKVSQGHRLYRPHLASDTIYQIMYSCWHELPEKRPTFQQLLSSIEP

SEQ ID NO: 63 - protein, 258 aa, Artificial Sequence
  Description of Artificial Sequence/note = synthetic construct
IQLLKRLGSGQFGEVWEGLWNNTTPVAVKTLKPGSMDPNDFLREAQIMKNLRHPKLIQLYAVCTLEDPIYIITELMRHGSLQEYLQNDTGSKIHLTQQVDMAAQVASGMAYLESRNYIHRDLAARNVLVGEHNIYKVADFGLARVFKVDNEDIYESRHEIKLPVKWTAPEAIRSNKFSIKSDVWSFGILLYEIITYGKMPYSGMTGAQVIQMLAQNYRLPQPSNCPQQFYNIMLECWNAEPKERPTFETLRWKLEDYF

SEQ ID NO: 64 - protein, 259 aa, Artificial Sequence
  Description of Artificial Sequence/note = synthetic construct
LKFDIELGRGAFKTVYKGLDTETWVEVAWCELQDRKLTKAEQQRFKEEAEMLKGLQHPNIVRFYDSWESILKGKKCIVLVTELMTSGTLKTYLKRFKVMKPKVLRSWCRQILKGLQFLHTRTPPIIHRDLKCDNIFITGPTGSVKIGDLGLATLMRTSFAKSVIGTPEFMAPEMYEEHYDESVDVYAFGMCMLEMATSEYPYSECQNAAQIYRKVTSGIKPASFNKVTDPEVKEIIEGCIRQNKSERLSIRDLLNHAFF